(19) United States
(12) Patent Application Publication
(10) Pub. No.: US 2021/0078840 A1
(43) Pub. Date: Mar. 18, 2021

(54) A lifting device

(71) Applicant: Johan F. Andresen, STAVANGER (NO)

(72) Inventor: Johan F. Andresen, STAVANGER (NO)

(21) Appl. No.: 16/499,328

(22) PCT Filed: Mar. 22, 2018
(86) PCT No.: PCT/EP2018/057322

§ 371 Date: Sep. 30, 2019

(30) Foreign Application Priority Data
Mar. 31, 2017 (NO) 20170538
Mar. 31, 2017 (NO) 20170539
Mar. 31, 2017 (NO) 20170540
Mar. 31, 2017 (NO) 20170541
Mar. 31, 2017 (NO) 20170542

(51) Int. Cl. B66C 23/53

(52) U.S. Cl. CPC B66C 23/53

(57) ABSTRACT

A lifting device (14) is disclosed comprising a lift arm (16) and a first support structure (31) which is adapted to be placed on a lifting vessel (61). The lifting device (14) comprises a first attachment unit (33) that comprises a first attachment element (121) which connects the lift arm (16) rotatably to the first support structure (31). The lift arm comprises a load transfer device (19) that is secured to a first end portion (17, 27) of the lift arm (16). The lifting device (14) further comprises a second support structure (44) and a second attachment unit (46) including a second attachment element (123) which connects the lift arm (16) rotatably to the second support structure (44). The first attachment element (121), the second attachment element (123) and the load transfer device (19) all lie substantially in a straight line (L) or substantially in the same plane. There is also defined a lifting vessel carrying said lifting device, as well as the use of the lifting device and of the lifting vessel.

### TECHNICAL FIELD

The present invention is related to a lifting device, a lifting vessel comprising such a lifting device for lifting a lift object offshore.

### BACKGROUND ART

### First Embodiment

In the following section background art relevant to the first embodiment of the invention will be discussed.

The present invention relates to a system and method for lifting a load in an offshore environment. Particularly, the invention relates to a system and method for lifting where any one vessel may act as a master vessel, for controlling a remainder of slave vessels.

During the recent years there has been a growing need for equipment that can perform heavy lifts in offshore and marine environments. Ever increasing complexity of oil and gas installations frequently entail larger and heavier structures, and installation is being pushed ever farther from shore such as for ultra-deep water construction. Simultaneously, many oil and gas installations across the globe are reaching the end of their life span, and will require decommissioning after their facilities are shut down. In the North Sea, rough conditions can further complicate installation and removal operations, often giving a limited window of time for lifting operations to be completed.

Two common techniques for heavy lifting are:
Lifting an object onto a transport vessel using a traditional crane mounted on a vessel.
Ballasting a semi-submersible vessel to a level below the object to be lifted and then de-ballasting the semisubmersible thereby lifting the object and transporting it away.

Both these techniques, and others which are not explained further herein, present many problems regarding stability, transport, energy consumption, safety, long operation time and flexibility regarding what kind of objects they can lift.

To overcome these problems, a system has been proposed comprising two or more independent vessels, the vessels comprising lifting devices arranged athwartships for cooperatively lifting a load. The lifting devices comprise a lever arm operated by ballasting and de-ballasting chambers, as described in U.S. Pat. No. 6,668,747 B2. In this system each lifting device is independently controlled from the bridge of each vessel, while the vessels positioning systems and heave compensation are also independently controlled. A benefit of this system is its flexibility of having lifting devices that can be added and removed on vessels, in a so called plug and play configuration. With up to 6 arms on each vessel, it also has superior lifting capacities with low energy consumption due to the specially balanced lifting arms.

However, with up to 12 lifting devices in total that need to be controlled, and the coordination of vessel positioning systems during lift-off, transit and set-down of a load there are many variables that can affect the lifting operation. Adjusting one lifting device to a certain degree may affect the stability of the rest of the system, though this can be hard to predict and coordinate. With independent operators on the different systems and without having time to calculate how a move of one lifting device will affect the rest of the system, there are many pitfalls that must be avoided. These lifting operations have therefore been found to be time consuming due to the care that must be taken for every action and step of the lifting operation.

Therefore, there is need for a system that can alleviate the shortcomings of the background art.

### Second Embodiment

In the following section background art relevant to the second embodiment of the invention will be discussed.

The present invention is related to a lifting device, a lifting vessel comprising such a lifting device for lifting a lift object offshore.

The invention is particularly applicable in offshore decommissioning and installation operations installing or decommissioning large structures such as platforms, jackets etc.

Conventional methods used in prior art heavy lifting systems have usually been based on the use of offshore crane ships or heavy lift vessels. In a typical operation of this kind, a crane ship is positioned close to a platform and lifts the various sections of the platform in a predetermined sequence. Systems or devices are also known which are designed to lift the entire upper part or deck of a platform in a single operation.

A known twin-barge lifting system is based on two barges which are located at a suitable distance apart on opposite sides of the structure which has to be lifted, and which are interconnected and can be pulled towards each other with great force by means of winch devices. On each barge are placed a number of lifting beams which are tilted inwards and upwards in the direction of the load, and which are brought into engagement with the load. The two barges are then pulled towards each other, thus causing the angles of inclination of the lifting beams to increase as the distance between the barges decreases, thereby causing the load to be lifted up in the area between the barges which then forms a catamaran configuration.

Another known system is disclosed in WO 01/70616 A1, which is related to a load transfer system where each lifting device comprises a lever arm with a first and a second arm projecting in opposite directions from a common mounting point. The first arm is provided with a lifting point at its free end for engaging with the load and comprises a first container which is connected to the first arm at a point near the lifting point. The first container is arranged to receive and discharge a water and to be submerged in the sea. The lever arm further comprises a second container which is suspended at the free end of the second arm and is connected via a pipeline to the first container. A device is provided for fast transfer of water in the first container via the pipeline device to the second container.

### Third Embodiment

In the following section background art relevant to the third embodiment of the invention will be discussed.

The present invention according to the third embodiment relates to a lifting device for lifting a load in an offshore environment. Particularly, the invention relates to a lifting device with a novel ballasting arrangement and a method for lifting a load by ballasting such a device.

During the recent years there has been a growing need for equipment that can perform heavy lifts in offshore environments. Ever increasing complexity of oil and gas installations frequently entail larger and heavier structures, and installation is being pushed ever farther from shore such as for ultra-deep water construction. Simultaneously, many oil and gas installations across the globe are reaching the end of their life span, and will require decommissioning after their facilities are shut down. In the North Sea, rough conditions can further complicate installation and removal operations, often giving a limited window of time for lifting operations to be completed.

Two common techniques for heavy lifting are:
Lifting an object onto a transport vessel using a traditional crane mounted on a vessel.
Ballasting a semi-submersible vessel to a level below the object to be lifted and then deballasting the semisubmersible thereby lifting the object and transporting it away.

These techniques, and others which are not explained further herein, present many problems regarding stability, transport, energy consumption, safety, long operation time and flexibility regarding what kind of objects they can lift. A particular problem with these techniques in the prior art, is their slow lifting speed. A slow lifting speed may entail an inability to lift a load away from a bottom unit, such as a transport vessel, to a safe height during a wave period. Bringing the load to a safe height within a wave period is desirable, as insufficient clearance between the load and the bottom unit can result in the two structures slamming into each other as the next wave period appears. Slow lifting speed exposes the system to further heaving motions resulting in unwanted, unexpected and unevenly distributed forces on the lifting equipment.

To overcome these problems, a lifting device has been proposed comprising a lever arm operated by ballasting and de-ballasting containers, as described in U.S. Pat. No. 6,668,747 B2. This lifting device has improved stability and lifting power, also providing passive heave compensation, allowing safer and more cost-efficient lifting operations. To achieve a fast lift-off, U.S. Pat. No. 6,668,747 B2 describes a device and method for fast transfer of a fluid medium between the containers on each end of its lever arm by means of compressed air, or another suitable pressurized gas. This allows 400 tons of medium to be transferred in a few seconds.

However, using pressurized gas to transfer medium between the opposing containers of the lever arm has many drawbacks. Pressurized gas in itself poses a danger, as it contains a substantial amount of potential energy waiting to be unleashed as kinetic energy. Pressurized gas must be stored in specially constructed pressure tanks, and handled in a system suited for pressurized gas. These pressure systems are inherently prone to failure, and for the case of U.S. Pat. No. 6,668,747 B2, they must be specially constructed to handle an offshore environment where the tanks are exposed to rough environmental conditions and dynamic forces due to vessel motions. Even so, these systems will be unreliable and prone to leaks, ruptures, malfunctions and possibly explosions and a danger to human life. The cost of building and maintaining these systems has accordingly been found to be impractical.

Therefore, there is need for a lifting device which can rapidly perform a lift-off, in a cost efficient and safe manner.

In view of this, it is an object of the invention to provide an improved lifting device and method for heavy lift operations

### Fourth Embodiment

In the following section background art relevant to the fourth embodiment of the invention will be discussed.

The invention relates to a lifting device comprising a load-engaging part comprising a guiding part comprising guiding means for guiding and aligning the lifting arm into lifting position by cooperation with a guide member on the load, and a lifting part adapted to support the load, as well as an assembly comprising a lifting device and a load, and method of lifting a load using the lifting device. The invention is particularly applicable in offshore decommissioning and installation operations installing or decommissioning large structures such as platforms, jackets, salvages etc.

Conventional methods used in prior art heavy lifting systems have usually been based on the use of offshore crane ships or heavy lift vessels. In a typical operation of this kind, a crane ship will be positioned close to a platform and lift the various sections of the platform in a predetermined sequence. Systems or devices are also known which are designed to lift the entire upper part or deck of a platform in a single operation.

In addition, twin-barge lifting systems are known, e.g. the so-called “Versatruss” lifting system, which is based on two barges which are located at a suitable distance apart on opposite sides of the structure which has to be lifted, and which are interconnected and can be pulled towards each other with great force by means of winch devices. It is placed a number of lifting beams on each barge, which are tilted inwards and upwards in the direction of the load, and which are brought into engagement with the load. The two barges are then pulled towards each other, thus causing the angles of inclination of the lifting beams to increase as the distance between the barges decreases, thereby causing the load to be lifted up in the area between the barges which then forms a catamaran configuration.

Other prior art, includes WO0170616 A1 (Applicant: SeaMetric International AS), which relates to a system where each lifting device comprises a lever arm unit with a first and a second arm projecting in opposite directions from a common mounting point. The first arm having a lifting point at its free end for engaging with the load, at least one first container which is connected to the first arm at a point near the said lifting point, and which is arranged to receive and discharge a flowable medium and to be submerged in the volume of water, and at least one second container which is suspended at the free end of the second arm, the interior of the container being connected via a pipeline device. The device is provided for fast transfer of medium in the first container via the pipeline device to the second container.

However, the known systems have drawbacks in relation to provide a proper guiding of the lifting arm into contact with the load. Without such a proper guiding system with precise maneuvering of the lifting arm towards the load, there is always a risk of metal-to-metal impacts between the lifting arm and the load.

Thus, an objective of the present invention is to solve at least some of the drawbacks in relation to the prior art solutions.

More specific, one of the objectives of the invention is to provide a system for lifting heavy loads offshore wherein the load, during the lifting operation, may rotate about at least one axis relative a lifting arm lifting the load.

Another objective of the invention is to perform lifting operations offshore without active or passive operation of e.g. a hydraulics lifting system or other mechanical lifting means.

Another objective is to provide a solution which is flexible with regards to the type of lifting operation, i.e. where different lifting operations, including at least a fork lift mode and a hoisting mode, may be easily interchanged offshore without having to return to dock for extensive change of lifting operation conditions.

### Fifth Embodiment

In the following section background art relevant to the fifth embodiment of the invention will be discussed.

The present invention is related to a lifting device, a lifting vessel comprising such a lifting device and use of the lifting device and the lifting vessel for lifting a lift object offshore.

The invention is especially applicable for use in offshore decommissioning and installation operations installing or decommissioning large structures such as platforms, jackets, harbor structures etc.

Conventional methods used in prior art heavy lifting systems have usually been based on the use of offshore crane ships or heavy lift vessels. In a typical operation of this kind, a crane ship is positioned close to a platform and lifts the various sections of the platform in a predetermined sequence. Systems or devices are al so known which are designed to lift the entire upper part or deck of a platform in a single operation.

A known twin-barge lifting system is based on two barges that are located at a suitable distance apart on opposite sides of the structure which has to be lifted, and which are interconnected and can be pulled towards each other with great force by means of winch devices. On each barge are placed a number of lifting beams which are tilted inwards and upwards in the direction of the load, and which are brought into engagement with the load. The two barges are then pulled towards each other, thus causing the angles of inclination of the lifting beams to increase as the distance between the barges decreases, thereby causing the load to be lifted up in the area between the barges which then forms a catamaran configuration.

Another known system is disclosed in WO 01/70616 A1, which is related to a load transfer system where each lifting device comprises a lever arm with a first and a second arm projecting in opposite directions from a common mounting point. The first arm is provided with a lifting point at its free end for engaging with the load and comprises a first container which is connected to the first arm at a point near the lifting point. The first container is arranged to receive and discharge a water and to be submerged in the sea. The lever arm further comprises a second container which is suspended at the free end of the second arm and is connected via a pipeline to the first container. A device is provided for fast transfer of water in the first container via the pipeline device to the second container.

### SUMMARY OF THE INVENTION

### First Embodiment

In the following section, objectives and achievements of the invention according to the first embodiment will be discussed.

In view of the shortcomings of the background art, it is an object of the invention according to the first embodiment to provide an improved system and method for heavy lift operations, using vessels with lifting devices such as the ones described in the prior art.

More specifically the object of the invention is to provide at least one vessel with a system that has the capability of coordinating and synchronizing the entire lifting operation.

A more specific objective of the invention is to provide a system which can provide data regarding specific conditions of the system.

The present invention provides significant improvements in relation to the prior art, in that a single vessel control system can monitor and control any lifting vessel's control system.

Accordingly, the present invention relates to a system for lifting a load in an offshore environment, the system comprising at least two lifting vessels, the lifting vessels being arranged with at least one lifting device each for cooperatively lifting a load,
wherein each lifting vessel comprises a control system capable of receiving and sending data signals and to process received data signals,
wherein the control system on each lifting vessel is signally connected to a vessel positioning system on board the same lifting vessel, the at least one lifting device on board the same lifting vessel and at least one other control system on board another lifting vessel, and;
   wherein each control system of the at least two lifting vessels is capable of being allocated as at least one of the following:
   slave control system, thereby being controlled and monitored by a master control system, or,
   master control system, thereby controlling and monitoring all slave control systems, or;
   wherein the control system of one lifting vessel is capable of being allocated as master control system, thereby controlling and monitoring all slave control systems, and
   the control systems of the remaining lifting vessels are capable of being allocated as slave control systems, thereby being controlled and monitored by the master control system,

or;
wherein the control system of all lifting vessels are capable of being allocated as slave control system, thereby being controlled and monitored by a master control system.

By enabling the lifting vessels control systems to take the role, or permanently having the role of master or slave, one vessel's control system can control the entire lifting operation. All received data may be synchronized in a common reference system, so that commands given by an operator through a master control system are optimized according to this will affect the lifting operation as a whole. Thus, the lifting operation can be completed faster, give more flexibility in relation to controlling the system, increase safety and give the system better redundancy. Another advantageous aspect of the invention is that it allows the lifting vessels to be equipped so that they may either be master or slave, thus giving the system flexibility and redundancy should it be necessary to switch the roles of master and slave. In other aspects, the invention allows the vessel's control system to be more specialized, with a vessel's control system either having the capability of being a slave or a master, which could be beneficial with respects to costs of equipping more ships with all master/slave capabilities. In yet further aspects of the invention, a master control system may be located at a distant land or air based facility, though at least one vessel's control system will preferentially maintain its capability of being allocated a master control system for redundancy purposes.

In an aspect of the invention, the control system on each vessel may be signally connected to sensor devices on the load.

This advantageously allows the control systems of the vessels to monitor conditions related to the load, and incorporate this data in the decision making process before and during the lifting operation.

In an aspect of the invention, the sensor devices on the load may comprise sensor devices for monitoring physical forces acting on the load, position of the load relative to the vessels, inclination of the load and environmental conditions, the sensor devices being signally connected to at least one control system.

In an aspect of the invention, the vessel positioning system may comprise a dynamic positioning system, ballasting means and a plurality of sensor devices for monitoring the vessels position relative to the load and other vessels, environmental conditions, physical position of the vessel and exertion of positioning machinery.

To keep the lifting vessels in a fixed location, and to have them cooperatively lift and transport the load requires a sophisticated vessel positioning system with state-of-the-art technology.

In an aspect of the invention, the lifting devices may comprise a plurality of sensor devices for monitoring the position of the lifting device's components relative to the load and a reference system, physical forces acting on the lifting device structure and exertion of lifting device machinery. In aspects, the reference system may be vessel-based.

The sensor devices on the lifting device are advantageous for the control system to coordinate actions during the lifting operation.

In an aspect of the invention, each lifting device may comprise a pivotally mounted arm with each end being connected to at least one ballast container, the ballast containers of each end being in fluid communication.

In an aspect of the invention, the system may comprise at least one transport vessel, the at least one transport vessel being arranged for transport of the load.

This advantageously reduces the distance the lifting vessels have to cooperatively lift the load. A transport vessel may also be more efficient and faster in transport, which may also be a benefit if the load is brought to or from a different location than the lifting vessels.

In an aspect of the invention, the at least one transport vessels may comprise a control system capable of receiving and sending data signals and to process received data signals,
wherein the control system on board each of the at least one transport vessel is signally connected to at least one of: a vessel positioning system on board the same transport vessel and at least one other control system on board another vessel, and;
wherein the control system on board each of the at least one transport vessel is capable of being allocated as at least one of the following:
master control system, thereby controlling and monitoring all slave control systems, or
slave control system, thereby being controlled and monitored by a master control system,

or;
wherein the control system on board one transport vessel is capable of being allocated as master control system, thereby controlling and monitoring all slave control systems, and
the control systems of the remaining transport vessels are capable of being allocated as slave control system, or;
wherein the control system of all transport vessels are capable of being allocated as slave control system, thereby being controlled and monitored by a master control system.

This advantageously also allows the transport vessel to become part of the master slave configuration, by being allocated or permanently having the role of either master or slave. As the transport vessel may play an important part during lift or set-down, synchronizing operations through one vessel's control system will also be beneficial when the transport vessel is part of the system. Thereby, the master control system can ensure the transport vessel is also working in synchronization with the lifting vessels.

A beneficial aspect of the invention is that transport vessels may comprise the capability of being either master or slave, providing increased flexibility and redundancy to the system. In an aspect of the invention where the lifting vessels are allocated as slaves, a transport vessel may assume the master role. In another advantageous aspect the transport vessels may only comprise the capability of being either master or slave, which may be advantageous with respect to decreased costs as the vessels can be designed more specialized. In other aspects of the invention, transport vessels may be independently operated.

In an aspect of the invention, the transport vessel's control system may be signally connected to sensor devices on board the load.

In an aspect of the invention, the transport vessel may comprise a vessel positioning system comprising a dynamic positioning system, ballasting means and a plurality of sensor devices for monitoring the vessel's position relative to the load and other vessels, environmental conditions, physical position of the vessel and exertion of positioning machinery.

To keep the transport vessel in a fixed location, especially during lift or set-down when the lifting vessels are lying adjacent requires a sophisticated vessel positioning system with state-of-the-art technology.

Furthermore, the present invention relates to a method for lifting a load in an offshore environment, comprising the steps of:
providing a system according to any of the aforementioned aspects,
allocating one vessel's control system as master control system
allocating the remaining vessels control systems as slave control systems.

In an aspect of the invention, the method may further comprise the steps of:
deploying the lifting vessels to predefined pre-operational positions,
moving the lifting vessels to pre-lift positions adjacent to the load,
moving the lifting devices into lift-off positions, wherein the lifting devices are in contact with predefined lifting points on the load,
lifting the load into a lifting position
moving the lifting vessels to a predefined set-down position
setting down the load.

In an aspect of the invention, master and slave vessel's control systems may be allocated when the lifting vessels and lifting devices are in a lift-off position.

In an aspect of the invention, master and slave vessel's control systems may be allocated at any time between the vessels being in a pre-operational position and a lift-off position.

In an aspect of the invention, master and slave vessel's control systems may be made independent after the load has been set down.

### Second Embodiment

In the following section, objectives and achievements of the invention according to the second embodiment will be discussed.

The objective of the present invention has been to improve the design of known lifting devices on heavy duty lifting vessels.

In particular, it has been an objective to reduce horizontal motions of the lifting arm relative to an interface device on the object to be lifted which connects the lifting device to the object to be lifted during a lifting operation.

It has further been an objective to improve the design of lifting devices on the lifting vessel related to the movement of the lifting devices and the lifting arm of the lifting devices before and during a lifting operation.

It has also been an objective to improve the design of the support of the lifting arm of the lifting device.

These objectives are achieved with a lifting device, lifting vessel and use of the lifting device and the lifting vessel as will be discussed in the following, where further aspects of the invention are also defined.

The main focus of the present invention has been to provide a lifting vessel with sufficient lifting capacity to take on potential removal and installation projects offshore, for example in the North Sea where removing installations that has been used in drilling and production of hydrocarbons can require topside lifting capacity of 10.000 tonnes and more. The lifting vessels with their lifting devices are therefore designed to install and remove topsides, jackets and subsea structures.

The present invention provides various advantages; offshore man-hours are reduced by about 80% which means that HSE exposure is greatly reduced. The present lifting vessels have low energy consumption and therefore low emissions compared with known crane vessels. Typically, the lifting vessel with lifting deices may be designed for operating waves up to about Hs 2.5-3.0 m and operating wind up to about 25 Kn, but may of course be designed for larger or smaller values of operating waves and operating wind.

Other advantages include no active hydraulic systems used for heave compensation; the required lift force is created by air and water only, i.e. by buoyancy and ballasting; the lifted object is part of a balanced system after lift-off; and lift operations are completed within 30 hours. The lift force is created by simultaneously de-ballasting buoyancy tanks and ballasting ballast tanks of the lifting arm of the lifting devices, while the vessel ballasting is unchanged during lift operations.

The basic parts of the system is comprised of two bare deck vessels, each fitted with a versatile lifting arrangement including 2 to 6 lifting devices with inherent motion damping characteristics (=low dynamic forces). Furthermore, a third vessel is usually used for transportation of the object to be lifted. The resulting system has capability of lifting very large objects with no dimensional constraints and with operational flexibility since it can be used for both shallow and deep water operations. Furthermore, low dynamic loads and many lift points results in limited need for strengthening of lifted objects. With a draft of about 11 m, the transport vessel does not require special deepwater facilities for offloading topsides and jackets.

A further advantage of the present lifting system is that it lifts jackets vertically and so can lift every North Sea jacket in no more than two to three lifts. The system is also designed with the ability to perform crane lift operations, for example bridge removals, when that is desirable or necessary. In this configuration also smaller topsides can be installed and removed as well as subsea structures.

The main lift arm of the lifting devices have inherent motion damping characteristics and they may typically be designed so that they are about 80 m long. The length of the main lift arm may be extended if the lift arms are provided with a telescoping arm. The length of the lift arm may then be extended with typically up to 20 meters.

Each lift arm of respective lifting devices may preferably be positioned and loaded individually. The lift arms may by positioned relative to lift points on lifted object in height by using a rack and pinion elevation system with mechanical locking, in width by moving the lifting devices sideways so that a desired spacing between lift point on objects to be lifted is achieved by using rollers on a vessel skid beam system, and in depth, i.e. the distance between the lift object and the lifting vessel, by extracting or retracting the telescope beam until the desired distance from vessel to lift object is obtained.

The present system can lift topsides from underneath cellar-deck or out from main deck level and the lift arms are designed to “absorb” vessel movements to limit dynamic forces onto the lifted object. This is achieved by a buoyancy tank, the second fluid tank, supporting the lift arm of the lifting devices which floats relatively, or nearly independently of the vessel movements. Therefore, requirement for strengthening of lifted object, if any, is minimized.

A lifting device is therefore provided that comprises a lift arm and a first support structure which is adapted to be placed on a lifting vessel, and a first attachment unit that comprises a first attachment element which connects the lift arm rotatably to the first support structure. The lift arm comprises a load transfer device that is secured to a first end portion of the lift arm. The lifting device further comprises a second support structure and a second attachment unit including a second attachment element which connects the lift arm rotatably to the second support structure. The first attachment element, the second attachment element and the load transfer device all lie substantially in a straight line or substantially in the same plane.

When the lift arm rotates during a lifting operation, i.e. the lift arm is elevated relative to the second support structure, extra loads and dynamic tension is created in the elements making up the connection between the lift arm and the second support structure. These extra loads are reduced to a minimum when the lift arm is designed as indicated above, i.e. such that first attachment element, the second attachment element and the load transfer device, i.e. the contact area or point between the transfer device and the interface device, lie in the same plane or along the same straight line L. The horizontal movements of the second attachment element due to the lift arm's rotational movements is therefore reduced to a minimum.

The first support structure may comprise a first support frame which can be mounted on a base structure. The first support frame and the base structure may be designed in any suitable way as long as they are capable of supporting the weight of the lift arm and in addition the weight of the lift object and the ballast water in the ballast tank during a lifting operation. The base structure may be provided with a plurality of roller elements which are preferably adapted to be supported by rails that are mounted on the deck of the lifting vessel. The roller elements enables the first support structure to move or be moved along the rails in the longitudinal direction of the lifting vessel. The movement of the first support structure along the rails may be effected by a conventional gripper jack system or by one or more motors that drive the roller elements. In addition, one or more locking devices may be provided in order to lock the first support structure in a desired position. Since the locking devices may comprise two or more cooperating parts, the locking devices may be mounted on the base structure and/or the rails and/or the deck of the lifting vessel.

The first attachment unit preferably comprises a first connecting element which is connected to the first support structure with a rack and pinion system, a first attachment element, for example a shaft, a first attachment connection that connects the lift arm and the shaft where the first attachment connection preferably is slideably attached to the first connecting element and securely attached to the lift arm, and a first damper device that is attached to the first connecting element and the first attachment connection and restrains the sliding motion of the first attachment connection on the first connecting element.

The first support structure is preferably mounted on the deck of the lifting vessel such that the first attachment element, which is preferably in the form of a shaft, is situated vertically, or at least substantially vertically, above the longitudinal centre axis of the lifting vessel. This will enhance the stability of the lifting vessel with the lifting device arranged on the lifting vessel.

The lift arm is placed partly or preferably completely within the first connecting element. The rack and pinion system preferably comprises a plurality of racks which are securely mounted to the first support frame, at least one rack, but preferably two or more racks arranged on either side of the first support frame. The pinion members are mounted in or to the first connecting element. The toothed shaft parts of the pinion members are designed to engage securely and smoothly with the corresponding toothed parts of the racks. The pinion members preferably each comprise a motor which rotates the toothed shaft parts and thereby elevates the support frame, and thereby the lift arm, up and down relative to the first support frame. The rack and pinion system may therefore be considered to form a first elevation device which is capable of elevating the lift arm substantially vertically up and down relative to the first support frame of the first support structure.

As mentioned above, the first attachment unit further comprises a first attachment element which is connected to the lift arm and to the first support frame with a first attachment connection such that the lift arm is connected to the first support frame rotatably relative to the first support frame. The first attachment connection may comprise a number of support brackets connected to the lift arm and to the top of the first connecting element where the brackets are provided with a through-going hole in which the first attachment element, preferably in the form of a shaft, is arranged allowing the lift arm to rotate relative to the first connecting element.

The support brackets of the first attachment connection are preferably securely attached to the lift arm, but slidably attached to the top of the connecting element in a direction substantially transversal to the longitudinal direction of the vessel. The lift arm is therefore movably attached to the first connecting element in said transversal direction.

To restrain the transversal sliding movement of the support brackets relative to the first connecting element, the first attachment unit further comprise a plurality of first damper devices. The first damper devices may comprise a conventional damping piston and cylinder assembly that is connected to the first connecting element and the slideably mounted support brackets. In aspects the first damper devices may comprise a spring. Advantageously the first damper devices have an adjustable stiffness.

The second support structure may comprise a second support frame which is mounted on top of a first fluid tank. The second support frame may be designed in any suitable way as long as it is capable of supporting the weight of the lift arm and in addition the weight of the lift object during a lifting operation.

The first fluid tank may be provided with at least one dump hatch which can be opened in order to dump water quickly and thereby provide the lift arm relatively quickly with lifting power during a lifting operation. The size of first fluid tank is obviously designed according to the desired lifting power of the lifting device.

Normally the entire first fluid tank, or at least most of the first fluid tank, is kept above the surface of the body water in which the lifting vessel is located.

A second fluid tank which acts as a ballast and buoyancy tank and is arranged below and attached to the first fluid tank.

It should be noted that the first fluid tank and the second fluid tank may be designed as separate compartments of a single fluid tank. It should also be noted that the second support structure may be provided with two or more first fluid tanks, i.e. fluid tanks which are provided with one or more dump hatches for providing lifting power during a lifting operation, and two or more second fluid tanks for adjustment of buoyancy of the second support structure.

There is further attached at least one ballast tank to the lift arm at one end of the lift arm, preferably opposite to the end with the load transfer device. The ballast tank is preferably provided with at least one outlet, for example a hatch, for letting out water from the at least one ballast tank.

The first fluid tank and the second fluid tank are fluidly connected, i.e. a fluid, typically water, may be flowed from the second fluid tank to the first fluid tank by using a fluid pump or any other suitable device capable of moving water from the second fluid tank to the first fluid tank.

The second fluid tank and the ballast tank are fluidly connected, i.e. a fluid, typically water, may be flowed from the second fluid tank to the ballast tank by using a fluid pump or any other suitable device capable of moving water from the second fluid tank to the first fluid tank.

The second attachment unit preferably comprises a second connecting element which is connected to the second support structure with a rack and pinion system, a second attachment element, for example a shaft, and a second attachment connection that connects the shaft to the lift arm and the second connecting element such that the lift arm is capable of rotating about the centre axis of the second attachment element relative to the second connecting element.

The second attachment connection may for example comprise a support bracket securely attached to the lift arm and two support brackets that are securely attached to the second connecting element spaced apart such that the support bracket attached to the lift arm fits between the two support brackets attached to the second connecting element. The brackets may further be provided with through-going holes in which the second attachment element, i.e. normally a shaft, may be mounted such that the lift arm is capable of rotating relative to the second connecting element.

The second attachment connection may alternatively comprise a ball bearing or a universal joint which allows the second support structure to rotate about any rotational axis relative to the lifting arm.

The lift arm is preferably placed within the second connecting element. The rack and pinion system preferably comprises a plurality of racks which are securely mounted to the second support frame, at least one rack on either side of the first support frame. The pinion members are mounted in or to the second connecting element. The toothed shaft parts of the pinion members are designed to engage securely and smoothly with the corresponding toothed parts of the racks. The pinion members preferably each comprise a motor which rotates the toothed shaft parts and thereby elevates the support frame, and thereby the lift arm, up and down relative to the second support frame. The rack and pinion system may therefore be considered to form a second elevation device which is capable of elevating the lift arm substantially vertically up and down relative to the second support frame of the second support structure. In aspects, electric motors for elevating the arm structure may be used, but also electric, hydraulic or pneumatic cylinders may be used.

As mentioned above, the second attachment unit comprises a second attachment element which is connected to the lift arm and to the second support frame with a second attachment connection such that the lift arm is connected to the second support frame rotatably relative to the second support frame. The second attachment connection may comprise a support bracket securely attached to the lift arm and two support brackets securely attached to the second connecting element spaced apart such that the support bracket attached to the lift arm fits between the two support brackets attached to the second support frame. The support brackets may further be provided with through-going openings in which the second attachment element, typically a shaft, may be mounted allowing the lift arm to rotate relative to the second connecting element.

The first connecting element is further preferably provided with at least one lock element comprising a toothed part which faces a rack mounted on the first support frame. The lock element is movably mounted in the first connecting element such that the lock element can be moved between a first position where the lock element is retracted and the first connecting element can be moved up and down on the racks, and a second position where the toothed part of the lock element is in engagement with the rack that it is facing such that the first connecting element, and thereby the lift arm, is locked in a given position relative to the first support frame. It should be noted that there is preferably provided a lock element on both sides of the first connecting element facing respective racks mounted to the first support frame.

Similarly, the second connecting element is preferably provided with at least one lock element comprising a toothed part which faces a rack mounted on the second support frame. The lock element is movably mounted in the second connecting element such that the lock element can be moved between a first position where the lock element is retracted and the second connecting element can be moved up and down on the racks, and a second position where the toothed part of the lock element is in engagement with the rack that it is facing such that the second connecting element, and thereby the lift arm, is locked in a given position relative to the second support frame. It should be noted that there is preferably provided a lock element on both sides of the second connecting element facing respective racks mounted to the second support frame.

The lifting device may further be provided with a damper device connected to the lifting vessel and the second support structure. The damper device may be designed in many different ways, but a preferably comprises a damper in form of a conventional piston/cylinder assembly which at one end is rotatably connected to the second support structure, preferably the second support frame, and at the opposite end rotatably connected to a guide structure. The connections enabling rotation may be formed by any suitable joint devices, for example universal joints or ball joints. In aspects the damper device may comprise a spring. Advantageously the damper device has an adjustable stiffness.

The guide structure preferably comprises an L-shaped attachment member which is supported on deck support rails on the deck of the lifting vessel and on a side support rail on the side of the hull of the lifting vessel such that the guide structure is capable of being moved along said rails in the longitudinal direction of the lifting vessel.

The guide structure may further comprise a first guiding member which is securely attached to the L-shaped attachment member. In the opposite end the first guiding member may be movably connected to a second guiding member such that the second support structure is allowed to move relative to the lifting vessel, for example due to wave motions in the body of water in which the lifting vessel is located.

The first guiding member may be a rod-like element and the second guiding member may be a slit arranged preferably on the side of the first fluid tank and/or the second fluid tank of the second support structure. One end of the rod-like element may, as mentioned above, be securely attached to the L-shaped attachment member, and the other end may be attached to a connecting member which is slideably arranged in the slit.

The load transfer device is preferably adapted to support an externally applied load, a lift object which typically may be a heavy load offshore such as the topside of a floating structure/platform. Typically the load transfer device may be 1.2-1.4 meters in diameter. Preferably, the load transfer device allows the load, i.e. the lift object, to rotate about any rotational axis relative to the lift arm.

The lifting device may comprise a first elevation device for effecting a substantially vertical movement of the lift arm relative to the first support structure.

Preferably, the first elevation device comprises at least one rack member and at least one corresponding pinion member. More preferably, the first elevation device comprises the first attachment unit and the rack and pinion system which is mounted to the first support structure and the first connecting element respectively.

The lifting device may comprise at least one first locking device for locking the first connecting element, and thereby the lift arm, at a desired elevation relative to the first support structure.

The first elevation device may comprise at least one rack member and at least one corresponding pinion member.

The lifting device preferably also comprises a second elevation device for effecting a substantially vertical movement of the lift arm relative to the second support structure.

The second elevation device may comprise at least one rack member and at least one corresponding pinion member.

The lifting device may comprise at least one second locking device for locking the second connecting element, and thereby the lift arm, at a desired elevation relative to the second support structure.

The lift arm may comprise a telescopic arm which is movable relative to the lift arm in a longitudinal direction of the lift arm. The load transfer device is preferably secured to an outer end portion of the telescopic arm.

The lift arm may comprise a rack member and at least one corresponding pinion member mounted to the lift arm and the telescopic arm respectively, or vice versa, for effecting a movement of the telescopic arm relative to the lift arm.

The second attachment device preferably comprises a second attachment connection which allows the second support structure to rotate about any rotational axis relative to the lifting arm.

The lifting device preferably comprises a ballast tank which is attached to a second end portion of the lift arm. The ballast tank can be filled and emptied to any desired level by using adequate pumps and valves.

The second support structure preferably further comprises a first fluid tank and a second fluid tank for buoyancy and/or ballasting of the second support structure.

The ballast tank and the second fluid tank are preferably fluidly connected for transfer of fluid between the ballast tank and the second fluid tank.

The first fluid tank and the second fluid tank are preferably fluidly connected for transfer of fluid between the first fluid tank and the second fluid tank.

The first fluid tank preferably comprises at least one hatch for dumping of fluid from the first buoyancy tank. By making the at least one hatch sufficiently large, the water in the first fluid tank may be dumped rapidly such that lifting power can be provided quickly during a lifting operation.

The lifting device may comprise a first damper device for damping and/or restraining of rotational movement of the lift arm at least about a horizontal axis relative to the first support structure. The first damper device is thus able to utilize parts of the vessel's stiffness/stability into the lift arm system. By restraining movement of the lift arm, so may movement of the lifted object be restrained.

The first damper device may comprise at least one fluid operated cylinder and piston arrangement, where the cylinder is attached to the lift arm and the piston is attached to the first attachment device or to the first support structure, or vice versa. Alternatively, the damping effect of the first damper device may be implemented with magnetically, pneumatically, mechanically, i.e. including one or more springs, operated elements, or a combination of one or more of the above.

There is further provided a lifting vessel for lifting a lift object offshore, where the lifting vessel comprises at least one lifting device as described above.

The load transfer device is preferably adapted for support of the lift object during lifting of the lift object.

The first attachment element is preferably located substantially vertically above the longitudinal centerline of the lifting vessel.

The lifting vessel may further comprise support rails which are mounted on the deck of the vessel and extend in a longitudinal direction of the lifting vessel, wherein the first support structure of the least one lifting device comprises a plurality of roller elements, and wherein the first support structure is supported on the support rails such that first support structure is capable of rolling or being rolled along the support rails.

The lifting vessel may further comprise rail elements which support the first support structure of the at least one lifting device.

The first support structure may comprise a plurality of roller elements, wherein the first support structure is supported on the rail elements such that first support structure is capable of rolling along the rail elements.

Preferably the rail elements extend in a longitudinal direction of the lifting vessel.

The roller elements may be movable between a rolling position where the roller elements are capable of rolling on the rail elements, and a retracted position where the roller elements are retracted into the first support structure such that a base structure of the first support structure is supported on the rail elements.

The lifting vessel may comprise a guide structure which is supported on guide rails mounted on the lifting vessel, movably along the guide rails, and where the guide structure is further attached to the lifting device movable relative to the lifting device.

The guide structure preferably comprise a first guiding member which is movably attached to the second fluid tank and/or the first fluid tank of the lift device.

The lifting vessel may further comprise a second damper device for damping and/or restraining of relative vertical movement between the second support structure and the lifting vessel.

The second damper device will in normal working mode be used for damping of movements, may also be used to increase the stiffness of the lift arm system, and the second damper device may be used for lifting or adjustments when it is necessary. Due to excellent damping and stiffness properties of the lift arm system, the damping device may not be necessary in all operations.

The second damper preferably comprises a piston and cylinder assembly where the piston and the cylinder are rotatably connected to the guide structure and the lifting device respectively or vice versa.

The second damper device preferably comprise at least one fluid operated cylinder and piston arrangement, where the cylinder is attached to the second support structure and the piston is attached to the lifting vessel, or vice versa.

Alternatively, the damping effect of the second damper device may be implemented with magnetically, pneumatically, mechanically, i.e. including one or more springs, operated elements, or a combination of one or more of the above

The lifting vessel preferably comprises a lift arm control system for controlling the movements of the at least one lifting arm. The lift arm control system may also be used to control other operations such as the ballast/buoyancy system.

The control system preferably comprises a plurality of sensor devices which are signally connected to a bridge control unit for monitoring and controlling of input parameters which are necessary and/or desirable at least during a lifting operation.

The lifting device, as described above, may be used, for example for lifting at least a part of an offshore structure for drilling and/or production of hydrocarbons.

The lifting vessel, as described above, may be used, for example for lifting at least a part of an offshore structure for drilling and/or production of hydrocarbons.

### Third Embodiment

In the following section, objectives and achievements of the invention according to the third embodiment will be discussed.

The object of the invention is to provide a lifting device, where a load can be rapidly lifted to a safe height without the need for moving large quantities of water from containers on one side of a pivoting arm to containers on an opposite side.

A more specific objective of the invention is to reduce or eliminate the need for pressurized gas to rapidly transfer ballasting medium.

A more specific objective is to provide a ballasting means and method, where a dump container and a buoyancy container are in fluid communication.

A further objective is to provide a transfer system and container arrangement which can efficiently distribute ballast water to different containers.

The present invention provides significant improvements in relation to known solutions, as a load can be rapidly lifted to a safe height without the need for moving large quantities of water from containers on one side of a pivoting arm to containers on an opposite side.

Accordingly, the present invention relates to a lifting device for lifting a load in an offshore environment, for mounting on a floating unit, wherein the lifting device comprises a pivotally mounted arm with a lifting end and a ballasted end arranged on opposite sides of a pivoting point, wherein the lifting device further comprises:
a buoyancy container and a Dump container connected to the lifting end of the arm,
the buoyancy container and the Dump container being in fluid communication,
a ballast container connected to the ballasted end of the arm, the ballast container being in fluid communication with the buoyancy container.

The buoyancy container provides an upwardly acting buoyant force and the Dump container provides a downwardly acting gravitational force, the product of which is a lifting force acting on the lifting end of the pivotally mounted arm. Ballasting or deballasting the containers to the outside environment will therefore affect the resulting lifting force, but the transfer of water between the containers does not. The need for rapid transfer of water to the ballast container to provide a pivoting force to lift the load is thereby eliminated, instead the lifting force is essentially increased by the rapid release of water from the Dump container to the outside environment.

In an aspect of the invention, the buoyancy container may be arranged below the Dump container. This advantageously allows water to be transferred between the two containers without changing the size or direction of the lifting force.

In an aspect of the invention, the buoyancy container may comprise a closable inlet near a bottom of the container for intake of water from the surrounding environment. This advantageously reduces the risk of clogging the inlet by objects floating near the surface of the water and reduces the power needs for pumping equipment for the intake of water into the buoyancy container.

In an aspect of the invention, a first transfer system may be arranged to transfer water from the buoyancy container to the Dump container.

In an aspect of the invention, the Dump container may be arranged to be fully above the surface of the surrounding water, and the buoyancy container is arranged to be partially submerged. This advantageously allows for easier evacuation of water from the dump container.

In an aspect of the invention, the dump container may comprise an openable outlet near a bottom of the container for releasing water to the surrounding environment.

This advantageously reduces or eliminates the need for any kind of pumping equipment to evacuate the dump container as water will dump out when the outlet is opened. The outlet is preferably of a size to allow complete emptying of the dump container in around 5 seconds, although the emptying process may take a anywhere between 3-15 seconds.

In an aspect of the invention, a second transfer system may be arranged to transfer water from the buoyancy container to the ballast container. This advantageously allows the simultaneous transfer of water from the buoyancy container to respectively the ballast container and the dump container by the second and first transfer systems.

In an aspect of the invention, the ballast container may comprise an openable outlet near a bottom of the container for releasing water to the surrounding environment.

In an aspect of the invention, a pump room may be arranged between the inlet and the first transfer system and the second transfer system.

In an aspect of the invention, a third transfer system may be arranged to transfer water between the pump room and the buoyancy container.

Furthermore, the present invention relates to a method of operating a lifting device for lifting a load in an offshore environment, the lifting device being mounted on a floating unit, wherein the lifting device comprises a pivotally mounted arm with a lifting end and a ballasted end arranged on opposite sides of a pivoting point,

wherein the lifting device further comprises:
a buoyancy container and a dump container connected to the lifting end of the arm,
a ballast container connected to the ballasted end of the arm,
where the buoyancy container is in fluid communication with the dump container and the ballast container,

wherein the method comprises the steps of:
receiving a first amount of water from the outside environment into the buoyancy container thereby tilting the pivoting arm down by a predefined degree,
transferring a second amount of water from the buoyancy container to the dump container,
bringing the floating unit adjacent to the load such that the lifting end of the arm is in a pre-lift position relative to the load,
releasing a third amount of water from the dump container to the environment outside the dump container, thereby bringing the lifting end of the arm into a lift-off position,
transferring a fourth amount of water from the buoyancy container to the dump container,
transferring a fifth amount of water from the buoyancy container to the ballast container,
releasing a sixth amount of water from the dump container to the environment outside the dump container, thereby tilting the pivoting arm up by a predefined degree and lifting the load.

### Fourth Embodiment

In the following section, objectives and achievements of the invention according to the fourth embodiment will be discussed.

The present invention provides significant improvements in relation to known solutions, including a system for lifting heavy loads offshore wherein the load, during the lifting operation, may rotate about at least one axis relative a lifting arm lifting the load. For example, a quick dump container and buoyancy container can be arranged at or close to one end of the lifting arm, and a ballast container can be arranged on an opposite end of the lifting arm. The operation of the lifting arm is performed such that the lift is performed by moving ballast medium between one or more buoyancy containers, ballast containers and/or quick dump containers to or from the sea. A fluid transfer system comprising pump(s) piping may be provided to move fluid between the different containers and also to and from the sea.

The invention relates to an offshore lifting device, the offshore lifting device comprising a lifting arm, the lifting arm having at least a first mode for performing lifting and lowering operations above sea level, wherein the lifting device has a load-engaging part at its free end comprising:
a guiding part comprising guiding means for guiding and aligning the lifting arm into lifting position by cooperation with a guide member on the load, and
a lifting part adapted to support the load, the lifting part comprising a lifting interface for cooperation with a corresponding load interface on the load, wherein, when the load interface is supported by the lifting interface, the load interface is rotatable relative the lifting interface about at least one rotational axis.

In the first mode of operation, for example a fork lift mode of the lifting device, the load engaging part of the lifting arm is intersecting the load, typically from underneath, and lifts the load such that the lifting arm is substantially horizontal during the lifting operation. The lifting device according to the present invention is normally operated by the transfer of water between a quick dump container and a buoyancy container on the load engaging part and a ballast container connected to an opposite end of the lifting arm, the ballasting principle behind the lever arm is known from U.S. Pat. No. 6,668,747 B2 which is hereby incorporated through reference.

In an aspect, the quick dump container and the buoyancy container are arranged substantially vertically relative to each other connected to the load engaging part of the lifting device, where the quick dump container is arranged at a higher elevation than the buoyancy container. The quick dump container can be rapidly emptied of water, thereby also rapidly increasing the buoyancy force acting on the load engaging part of the arm which provides the lifting force to the load. This reduces or eliminates the need for use of pressurized gas to rapidly transfer water to the ballasted end of the arm.

A feature of the invention is that load-engaging part at its free end comprises two separate parts, including a guiding part and a lifting part. Thus, the guiding part is only for guiding and the lifting part is for lifting.

The guide member on the load may be any naturally occurring guides such as jacket leg or similar or, may be a guide member in the form of for example a guide post which is mounted on the load prior to the lifting operation.

The lifting interface may comprise a recess which is conical, circular, spherical, etc. Alternatively, the lifting interface may comprise a protruding member which is conical, circular, spherical etc. The main objective of the lifting interface is to cooperate with the load interface such that the lifting is performed at the correct relative position between the lifting part and the load.

The corresponding load interface on the load may be any naturally occurring members complementary shaped to the load interface on the load-engaging part on the lifting arm or, it may be an interface in the form of for example a downwards facing triangle or a cone with the tip directed downwards, complementary shaped with the lifting interface rendering possible rotation of the lifting interface about at least one rotational axis relative the load interface. Many other shapes of the lifting interface and complementary load interface is possible, such as circular, spherical, conical etc. as long as they provide for the possibility of rotational movement about at least one axis.

The invention can thus also be defined as a ship comprising the offshore lifting device with all features stated herein, or as an offshore lifting device mountable on a vessel and configured to perform heavy lifts.

According to an aspect, the lifting interface may comprise a bearing. The bearing may be a main bearing transferring the loads for the lifted load into the lifting arm.

The bearing may be a ball bearing or any other bearing allowing rotational movement between the load and the lifting arm. The bearing may coincide with the recess of the lifting interface.

According to an aspect, the guiding part comprises a coarse adjustment part terminating in a fine adjustment part. The coarse adjustment part may according to one aspect comprise a V-shaped fork terminating in the fine adjustment part. Other shapes than V-shaped fork is also possible, such as U-shape etc. The fine adjustment part may have an inner cross section which is equal to or somewhat larger than a guide member on the load interface provided that fine adjustment is achieved.

According to an aspect, the guiding part comprises internal damping devices. The internal damping devices serves to limit transversal shocks or impact due to translational movement between the load and the lifting arm and to prevent metal to metal impacts. The internal damping devices may for example comprise an elastomer damper system at the free end of the lift arm to avoid mechanical shocks during mating with the lift object, i.e. the load.

According to an aspect, the guiding part may comprise position securing devices. The position securing devices secures the load inside the guiding part preventing the load to displace relative the guiding part. The position securing devices may comprise hydraulically or mechanically operated arms or elements which secures the load inside the guiding part, and may be one or more claws in the front of the lifting arm in the free end—inside the guiding part—locking and/or securing the lifting arm to a guide member on the load. The position securing devices may thus be considered as claws. According to DNV standards, such claws should have sufficient holding force to maintain the floating vessel in position also in blackout and dead ship condition. The minimum holding force may then be for example 400 metric tons.

According to an aspect, the guiding part further comprises at least one substantially vertical damping/spring device for damping shocks or impacts on the guiding device. The vertical damper/spring system may be arranged on the tip of the lifting arm near lifting interface recess and is adapted to damp mechanical shocks during lifting arm mating with the load (lift object). The vertical damper/spring system may be operated either magnetically, pneumatically, mechanically and hydraulically in combination with a compressed gas.

According to an aspect, the lifting arm comprises a telescopic arm and a main lift arm, wherein the telescopic arm is telescopically arranged inside the main lift arm. The telescopic arm and main lift arm may comprise a drive system in the form of a rack and pinion assembly or similar for extending the telescopic arm relative the main lift arm. The rack and pinion may comprise a damping device for limiting or reducing impacts.

According to an aspect, the lifting arm may comprise a second mode, also called hoisting mode, for performing lifting and lowering operations above and/or below sea level, wherein the second mode comprises a detachable lifting element mountable on the lifting arm for performing, by longitudinal flexible transferring element, a hoisting operation using e.g. a hook. This flexibility solves drawbacks of prior art where the ship and vessel had to return to dock to change the lifting mode. The second mode may comprise a detachable hoisting arm tip JIB for hoisting mode. The arm tip JIB, or any other suitable detachable lifting element, may be secured to the load-engaging part by use of mechanical, pneumatic, hydraulic, magnetically system, or a combination of. Operation of the hoisting mode may comprise operating a longitudinal flexible transferring element such as a wire, chain or fiber rope, connected to a hoisting element in one end and with a hook or other type of lifting link in the other end. A shark jaw may be provided for locking and securing the hoisting element during lifting operations. The hoisting element may be a winch drum or other suitable hoisting elements for reeling the longitudinal flexible hoisting element.

The lifting principle in the second mode, e.g. hoisting mode, once the load has been connected to e.g. the fork and the wire, chain or fiber rope has been tightened using the hoisting element, is similar to the first mode, e.g. fork lift mode. Thus, the quick dump container and the buoyancy container are arranged substantially vertically relative to each other connected to the load engaging part of the lifting device, where the quick dump container is arranged at a higher elevation than the buoyancy container. The quick dump container can be rapidly emptied of water, thereby also rapidly increasing the buoyancy force acting on the load engaging part of the arm which provides the lifting force to the load. This reduces or eliminates the need for use of pressurized gas to rapidly transfer water to the ballasted end of the arm.

In an aspect, the guiding part may be displaced in a deflection angle relative the lifting part. When the lifting part is arranged in an end portion of the telescopic arm, the deflection angle is relative the telescopic arm of the lifting device. The angular deflection is normally between 6-8 degrees, i.e. the guiding part may preferably decline 6-8 degrees in a downward direction relative the angle of the telescopic arm. This allows the guiding part to be substantially horizontal relative the load when the lifting arm is in its maximum inclination (e.g. 8 degrees) relative the load. Such an arrangement prevents possible impact with the load if the lifting arm oscillates to its maximum deflection in direction of the load. Thus, in order to ensure that the lifting interface of the lifting part, positioned in an end portion of the telescopic arm, is always equal to or at an higher elevation than an outermost portion of the coarse adjustment part, the coarse adjustment part declines e.g. 6-8 degrees relative the end portion of the telescopic arm. Consequently, the risk of load forces be taken up at unwanted locations on the lifting device is reduced.

The invention further relates to an assembly comprising an offshore lifting device as described above and a load, the load comprises:
a detachable element comprising a load interface having a protruding member with complementary shape relative the lifting interface, and
a guide member for guiding and aligning the guiding means of the guiding part on the load-engaging part,

wherein, when the load interface is supported by the lifting interface, the load interface is rotatable relative the lifting interface about at least one rotational axis.

The different parts making up the assembly may have similar features as described in relation to the lifting device above, and thus, because the lifting device in the assembly refers to the lifting device described in connection with the lifting device alone, any features of the lifting device are also possible to include in the assembly.

The invention further relates to system comprising at least one seaborne vessel comprising at least one offshore lifting device as stated above. The seaborne vessel may thus comprise a lifting arm having all of the above mentioned features.

The invention is thus particularly suitable for offshore lifting operations, such as being mounted on a floating vessel, a barge, a ship etc. Typically, at least two vessels, each vessel being provided with a number of lifting devices according to the invention, may be cooperating in lifting or lowering a load from above or below the sea level. In operation using two vessels, the vessels are positioned on opposite sides of the load, and the lifting devices are configured to be in the first mode, e.g. fork lift mode, or the second mode, e.g. hoisting mode. The switching between the modes can be easily performed on site offshore, providing a large flexibility for different operations at reduced time as the vessels do not have to return to dock for changing between the modes of lifting. Furthermore, the different lifting devices may all be configured to be in the same mode, i.e. the first mode (e.g. fork lift mode) or the second mode (e.g. hoisting mode), or in different modes. Furthermore, the lifting arms on one vessel may be operated simultaneously from a control system on the same vessel, or all lifting arms on all vessels may be operated simultaneously from a master control system. The latter providing advantages in that all of the lifting devices, and thus the lift itself, can be controlled by one person reducing the risk of human error in that all lifting devices are instructed to lift at the same time.

However, it shall be understood that it is possible to use more or less vessels, for example 1, 3, 4, 5, 6, 7, 8, 9, 10 vessels etc., dependent on different parameters such as the weight of the load, size of the load, position and depth of the load, and complexity of the operation. Thus, it is not necessary using two vessels to perform a lifting operation. For example during:
a) subsea lifting, i.e. lifting up or lowering of tubular elements such as long cables, pipelines or hoses, one or more vessels may be arranged side-by-side such that the one or more vessels are able to handle for example spools of e.g. 350 meters length,
b) one may install parts of a quay plant from the vessels, which parts thus being elements in the quay plant on land if the water depth allows access,
c) removal of short or long gangways offshore (from offshore installations such as windmills, floating platforms etc).

In addition, the number of lifting devices on each vessel may vary dependent on the same parameters.

The invention further relates to a method of lifting a heavy load offshore using at least one lifting device, the method comprising the steps of:
providing the load with at least one detachable element comprising a load interface having a protruding member and a guide member,
positioning the lifting arm in position relative the load by guiding and aligning the guiding part of the load-engaging part relative the guide member on the load,
when the guiding part is in position relative the guide member, engaging the lifting interface with the load interface on the load,
perform a lifting operation, and wherein, when the load interface is supported by the lifting interface, the load interface is rotatable relative the lifting interface about at least one rotational axis.

According to an aspect of the method, the method may further comprise switching to a second mode for performing lifting operations above and/or below sea level, by the following steps:
mounting a detachable lifting element on the lifting arm,
guiding a longitudinal flexible transferring element from a hoisting element via the detachable lifting element,
connecting the longitudinal flexible transferring element to the load for performing a hoisting operation.

In an aspect of the method may comprise switching between the first mode, e.g. the fork lift mode, and the second mode, e.g. the hoisting mode, of the lifting device by mounting or demounting the detachable lifting element.

It is obvious to the skilled person that the lifting interface may have a protruding member and the load interface may have the recess as long as they have complementary shapes.

Throughout the description and claims different wordings has been used for the complementary shapes on the lifting interface and the load interface, however, these wordings are meant to be the same, such as corresponding, cooperative shape, complementary shapes etc.

Similarly, throughout the description and claims it is referred to lifting device comprising a lifting arm. It is clear that the lifting arm forms part of the lifting device, and shall be understood as the part of the lifting device intersecting with the load either directly in the first mode of operation or via the longitudinal flexible transferring element in the second mode. Thus, the lifting arm is the part of the lifting device extending in a mainly transverse direction relative the longitudinal direction of the floating vessel. Furthermore, in some instances the lifting device is the lifting arm and vice versa.

### Fifth Embodiment

In the following section, objectives and achievements of the invention according to the fifth embodiment will be discussed.

The objective of the present invention has been to improve the design of known lifting devices on heavy duty lifting vessels.

In particular, it has been and objective of the present invention to provide a lifting device with increased positional adaptability.

The objective has further been to improve the design of lifting devices on the lifting vessel related to relative movement between various parts of the lifting devices.

In particularly, it has been an objective to improve the movement between the lifting arm of the lifting devices before and during a lifting operation.

It has also been an objective to improve the design of the support of the lifting arm of the lifting device.

These objectives are achieved with a lifting device, a lifting vessel, and uses of the lifting device and the lifting vessel as defined in the following aspects of the invention.

The main focus of the present invention has been to provide a lifting vessel with sufficient lifting capacity to take on potential removal and installation projects offshore, for example in the North Sea where removing installations that has been used in drilling and production of hydrocarbons can require topside lifting capacity of 10.000 tonnes and more. The lifting vessels with their lifting devices are therefore designed to install and remove topsides, jackets and subsea structures.

The present invention provides various advantages; offshore man-hours are reduced by about 80% which means that HSE exposure is greatly reduced. The present lifting vessels have low energy consumption and therefore low emissions compared with known crane vessels. Typically, the lifting vessel with lifting deices may be designed for operating waves up to about Hs 2.5-3.0 m and operating wind up to about 25 Kn, but may of course be designed for larger or smaller values of operating waves and operating wind.

Other advantages include no active hydraulic systems used for heave compensation; the required lift force is created by air and water only, i.e. by buoyancy and ballasting; the lifted object is part of a balanced system after lift-off; and lift operations are completed within 30 hours. The lift force is created by simultaneously de-ballasting buoyancy tanks and ballasting ballast tanks of the lifting arm of the lifting devices, while the vessel ballasting is unchanged during lift operations.

The basic parts of the system is comprised of two bare deck vessels, each fitted with a versatile lifting arrangement including 2 to 6 lifting devices with inherent motion damping characteristics (=low dynamic forces). Furthermore, a third vessel is usually used for transportation of the object to be lifted. The resulting system has capability of lifting very large objects with no dimensional constraints and with operational flexibility since it can be used for both shallow and deep water operations. Furthermore, low dynamic loads and many lift points results in limited need for strengthening of lifted objects. With a draft of about 11 m, the transport vessel does not require special deep-water facilities for offloading topsides and jackets.

A further advantage of the present lifting system is that it lifts jackets vertically and so can lift every North Sea jacket in no more than two lifts. The system is also designed with the ability to perform crane lift operations, for example bridge removals, when that is desirable or necessary.

The main lift arm of the lifting devices have inherent motion damping characteristics and they may typically be designed so that they are about 80 m long. The length of the main lift arm may be extended if the lift arms are provided with a telescoping arm. The length of the lift arm may then be extended with typically up to 20 meters.

Each lift arm of respective lifting devices may preferably be positioned and loaded individually. The lift arms may by positioned relative to lift points on lifted object in height by using a rack and pinion elevation system with mechanical locking, in width by moving the lifting devices sideways so that a desired spacing between lift point on objects to be lifted is achieved by using rollers on a vessel skid beam system, and in depth, i.e. the distance between the lift object and the lifting vessel, by extracting or retracting the telescope beam until the desired distance from vessel to lift object is obtained.

The present system can lift topsides from underneath cellar-deck or out from main deck level and the lift arms are designed to “absorb” vessel movements to limit dynamic forces onto the lifted object. This is achieved by a buoyancy tank, the second fluid tank, supporting the lift arm of the lifting devices which floats relatively, or nearly independently of the vessel movements. Therefore, requirement for strengthening of lifted object, if any, is minimized.

A lifting device is therefore provided that comprises a first support structure and a second support structure which are adapted to be placed on a lifting vessel. The lifting device further comprises a lift arm which is connected to the first support structure with a first elevation device and to the second support structure with a second elevation device. The first elevation device comprises a first connecting element which is connected to the lift arm and movably connected to the first support structure, and the second elevation device comprises second connecting element which is connected to the lift arm and movably connected to the second support structure.

Thus, the lift arm is thereby movable in a preferably substantially vertical direction within the lifting device. The lift arm can be elevated, i.e. raised and lowered, preferably over the full height of the first and second support structures, in order to accommodate the various distances from sea-level to underneath the offshore installations that the lift system will meet under operation. During elevation of the lift arm the load transfer device will see no external loads, i.e. the elevation process is a pre lifting operation.

Below, an aspect elevation system comprising a rack and pinion system will be described in detail. The elevation principle will, however, be the same for other elevation systems which can be employed to elevate the lift arm to a desired elevation and lock the lift arm at that desired elevation for operation, i.e. lifting of a lift object. Rather than using a rack and pinion arrangement for elevation of the lift arm, for example a winch system or a jacking and locking system may be used.

The lift arm is preferably rotatably connected to the first connecting element and the lift arm is preferably rotatably connected to the second connecting element. The first connecting element thereby connects the lift arm rotatably to the first support structure and the second connecting element thereby connects the lift arm rotatably to the second support structure. The lift arm may further comprise a load transfer device that is secured to a first end portion of the lift arm. Furthermore, the first connecting element, the second connecting element and the load transfer device all preferably lie substantially in a straight line or substantially in the same plane.

When the lift arm rotates during a lifting operation, i.e. the lift arm is elevated relative to the second support structure, extra loads and dynamic tension is created in the elements making up the connection between the lift arm and the second support structure. These extra loads are reduced to a minimum when the lift arm is designed as indicated above, i.e. such that first attachment element, the second attachment element and the load transfer device, i.e. the contact area or point between the transfer device and the interface device, lie in the same plane or along the same straight line L. The horizontal movements of the second attachment element due to the lift arm's rotational movements is therefore reduced to a minimum.

The first support structure preferably comprises a first support frame and the second support structure comprises a second support frame. The first support frame is further preferably mounted on a base structure. The first support frame and the base structure may be designed in any suitable way as long as they are capable of supporting the weight of the lift arm and in addition the weight of the lift object during a lifting operation. The base structure may be provided with a plurality of roller elements which are preferably adapted to be supported by rails that are mounted on the deck of the lifting vessel. The roller elements enables the first support structure to move or be moved along the rails in the longitudinal direction of the lifting vessel. The movement of the first support structure along the rails may be effected by a conventional gripper jack system or by one or more motors that drive the roller elements. In addition, one or more locking devices may be provided in order to lock the first support structure in a desired position. Since the locking devices may comprise two or more cooperating parts, the locking devices may be mounted on the base structure and/or the rails and/or the deck of the lifting vessel.

The first support structure is preferably mounted on the deck of the lifting vessel such that the first attachment element, which is preferably in the form of a shaft, is situated vertically, or at least substantially vertically, above the longitudinal centre axis of the lifting vessel. This will enhance the stability of the lifting vessel with the lifting device arranged on the lifting vessel.

The first elevation device preferably comprises at least one rack member and at least one pinion member which are mounted to the first support frame and the first connecting element respectively or vice versa, and the second elevation device preferably comprises at least one rack member and at least one pinion member which are mounted to the second support frame and the second connecting element respectively or vice versa.

The first connecting element may be formed as a U-shaped frame element, and the lift arm is preferably placed partly or preferably completely within the first connecting element. The rack and pinion system preferably comprises a plurality of racks which are securely mounted to the first support frame, preferably two or more racks arranged on either side of the first support frame. The pinion members are preferably mounted in or to the first connecting element. The toothed shaft parts of the pinion members are designed to engage securely and smoothly with the corresponding toothed parts of the racks. The pinion members preferably each comprise a motor which rotates the toothed shaft parts and thereby elevates the support frame, and thereby the lift arm, up and down relative to the first support frame. The rack and pinion system may therefore be considered to form a first elevation device which is capable of elevating the lift arm substantially vertically up and down relative to the first support frame of the first support structure.

The lift arm is preferably connected to the first connecting element with a first attachment unit comprising a first attachment element, preferably in the form of a shaft as mentioned above, and at least two first support elements which are connected to the first connecting element, preferably on either side of the lift arm transversely relative to the longitudinal direction of the lift arm, where the at least two support elements support the first attachment element. The first attachment unit further preferably further comprises at least one second support element which is attached to the lift arm and connected to the first attachment element. The first attachment element is preferably rotatably connected to the first support elements and/or to the second support elements. The first support elements and the at least one second support element are preferably provided with through-going holes through which the first attachment element, preferably in the form of a shaft, is arranged allowing the lift arm to rotate relative to the first connecting element. The lift arm is thereby rotatably connected to the first support frame.

The first support elements are preferably connected to the first connecting element with slide bearings such that the first support elements are movable in a transverse direction relative to the longitudinal direction of the first attachment element or relative to a direction substantially transversal to the longitudinal direction of the vessel. The lift arm is thereby movably attached to the first connecting element in said transversal direction.

The lifting device preferably comprises at least two first damper devices for damping and/or restraining of the sliding movements of the first support elements. The at least two first damper devices are preferably connected to each of the at least two first support elements respectively and to the first connecting element. The rotational movement of the lift arm, at least about a horizontal axis relative to the first support structure, can thereby also be dampened and/or restrained.

The first damper devices may comprise a conventional damping piston and cylinder assembly which are connected to the first connecting element and the slidably mounted first support elements.

The second support frame which is preferably mounted on top of a first fluid tank. The second support frame may be designed in any suitable way as long as it is capable of supporting the weight of the lift arm and in addition the weight of the lift object during a lifting operation.

The first fluid tank may be provided with at least one dump hatch which can be opened in order to dump water quickly and thereby provide the lift arm relatively quickly with lifting power during a lifting operation. The size of first fluid tank is designed according to the desired lifting power of the lifting device. Normally the entire first fluid tank is kept above the surface of the body water in which the lifting vessel is located.

A second fluid tank which acts as a ballast and buoyancy tank is preferably arranged below and attached to the first fluid tank.

It should be noted that the first fluid tank and the second fluid tank may also be designed as separate compartments of a single fluid tank. It should also be noted that the second support structure may be provided with two or more first fluid tanks, i.e. fluid tanks which are provided with one or more dump hatches for providing lifting power during a lifting operation, and two or more second fluid tanks for adjustment of buoyancy of the second support structure.

There is further attached at least one ballast tank to the lift arm at one end of the lift arm, preferably opposite to the end of the lift arm comprising the load transfer device. The ballast tank is preferably provided with at least one outlet, for example a hatch, for letting out water from the at least one ballast tank.

The first fluid tank and the second fluid tank are preferably fluidly connected, i.e. a fluid, typically water, may be flowed from the second fluid tank to the first fluid tank by using a fluid pump or any other suitable device capable of moving water from the second fluid tank to the first fluid tank.

The second fluid tank and the ballast tank are fluidly connected, i.e. a fluid, typically water, may be flowed from the second fluid tank to the ballast tank by using a fluid pump or any other suitable device capable of moving water from the second fluid tank to the first fluid tank.

The second attachment unit preferably comprises a second connecting element which is connected to the second support structure with a rack and pinion system, a second attachment element, for example a shaft, and a second attachment connection that connects the shaft to the lift arm and the second connecting element such that the lift arm is capable of rotating about the centre axis of the second attachment element relative to the second connecting element.

The lift arm is preferably connected to the second connecting element with an attachment connection comprising at least two upper support brackets attached to the second connecting element, at least one lower support bracket attached to the lift arm and arranged at least partly between the two upper support brackets, and a second attachment element which are connected to the upper support brackets and the lower support brackets such that the at least one lower support bracket is rotatable relative to the at least two upper support brackets.

The at least two upper support brackets and the at least one lower support bracket are preferably provided with through-going holes through which the second attachment element, preferably in form of a shaft or a bolt, is passing. The lift arm is thereby hanging from below an upper part of the second connecting element, rotatable relative to the second connecting element.

The second attachment connection may alternatively comprise a ball bearing or a universal joint which allows the second support structure to rotate about any rotational axis relative to the lifting arm.

The lift arm is preferably placed within the second connecting element which may have a rectangular shape. The rack and pinion system preferably comprises a plurality of racks which are securely mounted to the second support frame, at least one rack on either side of the first support frame. The pinion members are mounted in or to the second connecting element. The toothed shaft parts of the pinion members are designed to engage securely and smoothly with the corresponding toothed parts of the racks. The pinion members preferably each comprise a motor which rotates the toothed shaft parts and thereby elevates the support frame, and thereby the lift arm, up and down relative to the second support frame. The rack and pinion system may therefore be considered to form part of a second elevation device which is capable of elevating the lift arm substantially vertically up and down relative to the second support frame of the second support structure.

The first connecting element is further preferably provided with at least one lock element comprising a toothed part which faces a rack mounted on the first support frame. The lock element is movably mounted in the first connecting element such that the lock element can be moved between a first position where the lock element is retracted and the first connecting element can be moved up and down on the racks, and a second position where the toothed part of the lock element is in engagement with the rack that it is facing such that the first connecting element, and thereby the lift arm, is locked in a given position relative to the first support frame.

It should be noted that there is preferably provided a lock element on both sides of the first connecting element facing respective racks mounted to the first support frame.

Similarly, the second connecting element is preferably provided with at least one lock element comprising a toothed part which faces a rack mounted on the second support frame. The lock element is movably mounted in the second connecting element such that the lock element can be moved between a first position where the lock element is retracted and the second connecting element can be moved up and down on the racks, and a second position where the toothed part of the lock element is in engagement with the rack that it is facing such that the second connecting element, and thereby the lift arm, is locked in a given position relative to the second support frame. It should be noted that there is preferably provided a lock element on both sides of the second connecting element facing respective racks mounted to the second support frame.

As a consequence, the first support structure and second support structure are preferably provided with at least one lock element each which can be moved into and out of engagement with the at least one rack member of the first support structure and the at least one rack member of the second support structure respectively such that the first connecting element and the second connecting element can be locked at a desired vertical position within the first support structure and within the second support structure respectively.

There is further provided a lifting vessel for lifting an offshore lift object where the lifting vessel comprises at least one lifting device as outlined above.

As mentioned above, the first attachment element is preferably located substantially vertically above the longitudinal centerline of the lifting vessel.

The lifting vessel preferably comprises a guide structure which is supported on guide rails mounted on the lifting vessel, movably along the guide rails, where the guide structure further preferably is connected to the second support structure such that the second support structure is movable relative to the guide structure.

The guide structure preferably comprises a first guiding member which is movably attached to a second fluid tank or a first fluid tank of the second support structure.

The guide structure preferably comprises an L-shaped attachment member which is supported on deck support rails on the deck of the lifting vessel and on a side support rail on the side of the hull of the lifting vessel such that the guide structure is capable of being moved along said rails in the longitudinal direction of the lifting vessel.

The guide structure may further comprise a first guiding member which is securely attached to the L-shaped attachment member. In the opposite end the first guiding member may be movably connected to a second guiding member such that the second support structure is allowed to move relative to the lifting vessel, for example due to wave motions in the body of water in which the lifting vessel is located.

The first guiding member may be a rod-like element and the second guiding member may be a slit arranged preferably on the side of the first fluid tank and/or the second fluid tank of the second support structure. One end of the rod-like element may, as mentioned above, be securely attached to the L-shaped attachment member, and the other end may be attached to a connecting member which is slidably arranged in the slit.

The lifting vessel may further be provided with a damper device connected to the lifting vessel and the second support structure. The damper device may be designed in many different ways, but a preferably comprises a damper in form of a conventional piston/cylinder assembly which at one end is rotatably connected to the second support structure, preferably the second support frame, and at the opposite end rotatably connected to the guide structure. The connections enabling rotation may be formed by any suitable joint devices, for example universal joints or ball joints.

The load transfer device is preferably adapted to support an externally applied load, a lift object which typically may be a heavy load offshore such as the topside of a floating structure/platform. Typically the load transfer device may be 1.2-1.4 meters in diameter. Preferably, the load transfer device allows the load, i.e. the lift object, to rotate about any rotational axis relative to the lift arm.

The lift arm may comprise a telescopic arm which is movable relative to the lift arm in a longitudinal direction of the lift arm. The load transfer device is preferably secured to an outer end portion of the telescopic arm.

The lift arm may comprise a rack member and at least one corresponding pinion member mounted to the lift arm and the telescopic arm respectively, or vice versa, for effecting a movement of the telescopic arm relative to the lift arm.

The second support structure preferably further comprises a first fluid tank and a second fluid tank for buoyancy and/or ballasting of the second support structure.

The ballast tank and the second fluid tank are preferably fluidly connected for transfer of fluid between the ballast tank and the second fluid tank.

The first fluid tank and the second fluid tank are preferably fluidly connected for transfer of fluid between the first fluid tank and the second fluid tank.

The first fluid tank preferably comprises at least one hatch for dumping of fluid from the first buoyancy tank. By making the at least one hatch sufficiently large, the water in the first fluid tank may be dumped rapidly such that lifting power can be provided quickly during a lifting operation.

The first damper device may comprise at least one fluid operated cylinder and piston arrangement, where the cylinder is attached to the lift arm and the piston is attached to the first attachment device or to the first support structure, or vice versa. Alternatively, the damping effect of the first damper device may be implemented with magnetically, pneumatically, mechanically, i.e. including one or more springs, operated elements, or a combination of one or more of the above.

The load transfer device is preferably adapted for support of the lift object during lifting of the lift object.

The lifting vessel may further comprise support rails which are mounted on the deck of the vessel and extend in a longitudinal direction of the lifting vessel, wherein the first support structure of the least one lifting device comprises a plurality of roller elements, and wherein the first support structure is supported on the support rails such that first support structure is capable of rolling or being rolled along the support rails.

The lifting vessel may further comprise rail elements which support the first support structure of the at least one lifting device.

The first support structure may comprise a plurality of roller elements, wherein the first support structure is supported on the rail elements such that first support structure is capable of rolling along the rail elements.

Preferably the rail elements extend in a longitudinal direction of the lifting vessel.

The roller elements may be movable between a rolling position where the roller elements are capable of rolling on the rail elements, and a retracted position where the roller elements are retracted into the first support structure such that a base structure of the first support structure is supported on the rail elements.

The lifting vessel may comprise a guide structure which is supported on guide rails mounted on the lifting vessel, movably along the guide rails, and where the guide structure is further attached to the lifting device movable relative to the lifting device.

The guide structure preferably comprise a first guiding member which is movably attached to the second fluid tank and/or the first fluid tank of the lift device.

The lifting vessel may further comprise a second damper device for damping and/or restraining of relative vertical movement between the second support structure and the lifting vessel.

The second damper device will in normal working mode be used for damping of movements only, but second damper device may be used for lifting when it is necessary.

The second damper device preferably comprises a piston and cylinder assembly where the piston and the cylinder are rotatably connected to the guide structure and the lifting device respectively or vice versa.

The second damper device preferably comprise at least one fluid operated cylinder and piston arrangement, where the cylinder is attached to the second support structure and the piston is attached to the lifting vessel, or vice versa.

Alternatively, the damping effect of the second damper device may be implemented with magnetically, pneumatically, mechanically, i.e. including one or more springs, operated elements, or a combination of one or more of the above

The lifting vessel preferably comprises a lift arm control system for controlling the movements of the at least one lifting arm. The lift arm control system may also be used to control other operations such as the ballast/buoyancy system.

The control system preferably comprises a plurality of sensor devices which are signally connected to a bridge control unit for monitoring and controlling of input parameters which are necessary and/or desirable at least during a lifting operation.

The lifting device, as described above, may be used, for example for lifting at least a part of an offshore structure for drilling and/or production of hydrocarbons.

The lifting vessel, as described above, may be used, for example for lifting at least a part of an offshore structure for drilling and/or production of hydrocarbons.

The figures relating to each embodiment are grouped accordingly. The words, terms and references for each embodiment pertain to that particular embodiment, although the different embodiments comprise many similar features. Throughout the description and claims different words and terms are used, the definitions of these and other characteristics of the invention will be clear from the following description of the different embodiments, given as a non-restrictive examples with reference to the attached drawings wherein;

### BRIEF DESCRIPTION OF DRAWINGS

### First Embodiment

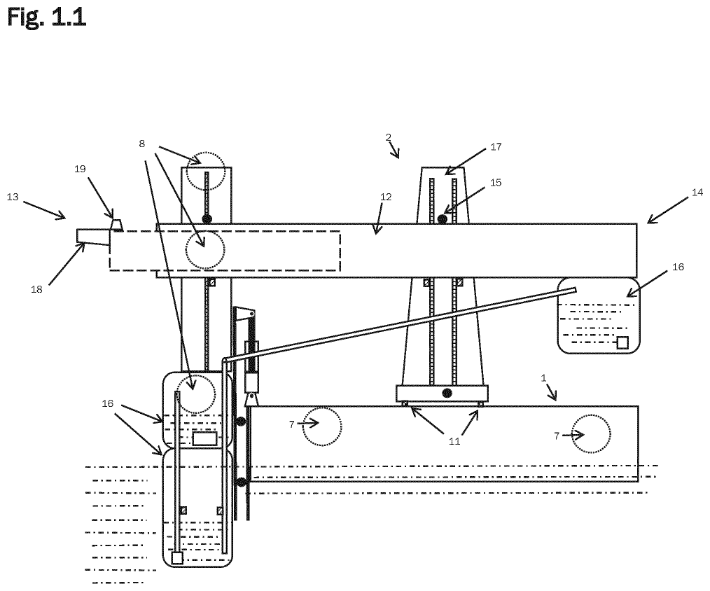

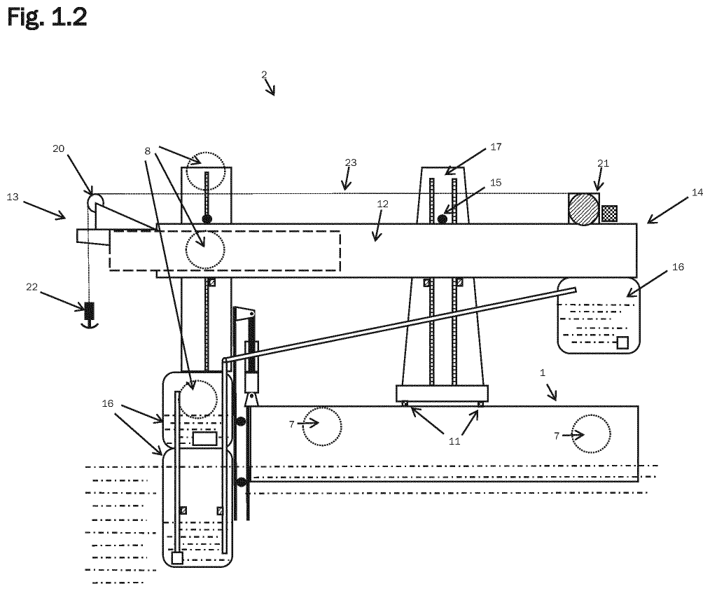

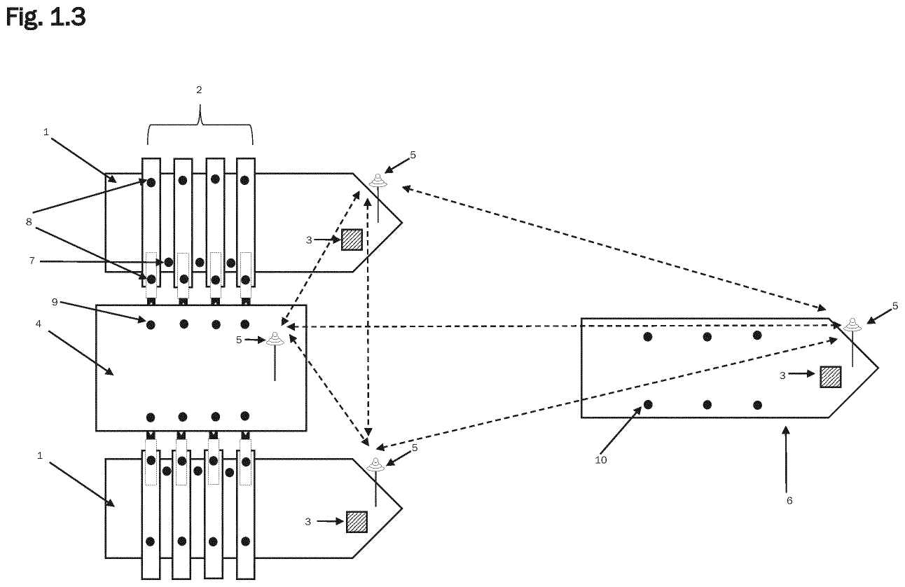

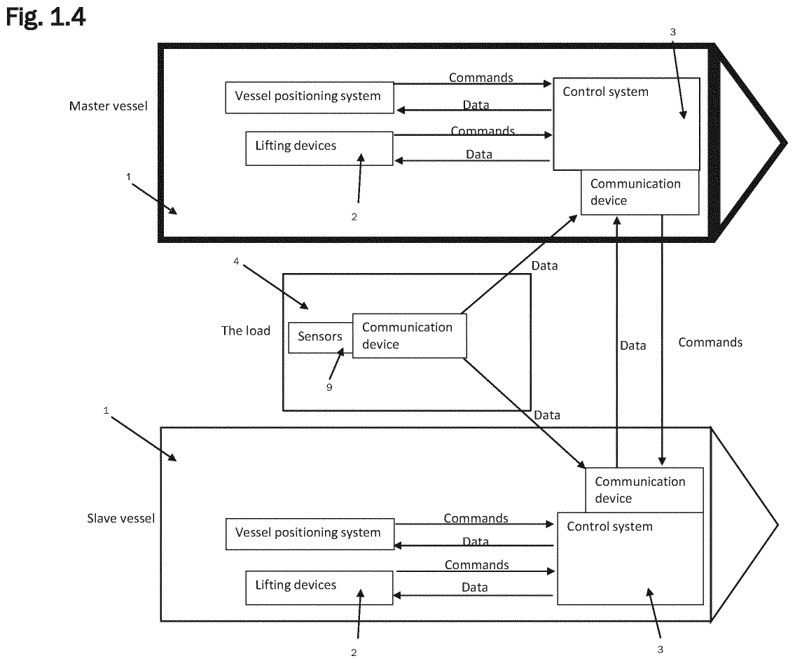

FIG. 1.1 shows an aspect of the invention where the lifting device is in forklift mode, with examples of where sensor devices can be located

FIG. 1.2 shows an aspect of the invention where the lifting device is in hoisting mode, with examples of where sensor devices can be located

FIG. 1.3 shows an aspect of the invention with two lifting vessels and a transport vessel

FIG. 1.4 shows a flow diagram of data between different parts of the system, with a master and slave vessel configuration activated.

### Second Embodiment

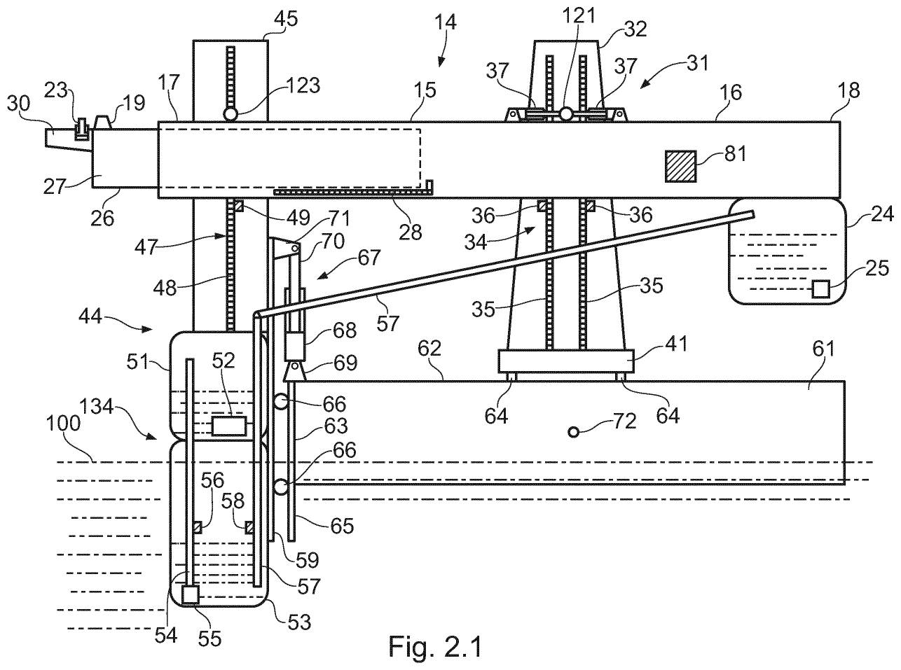

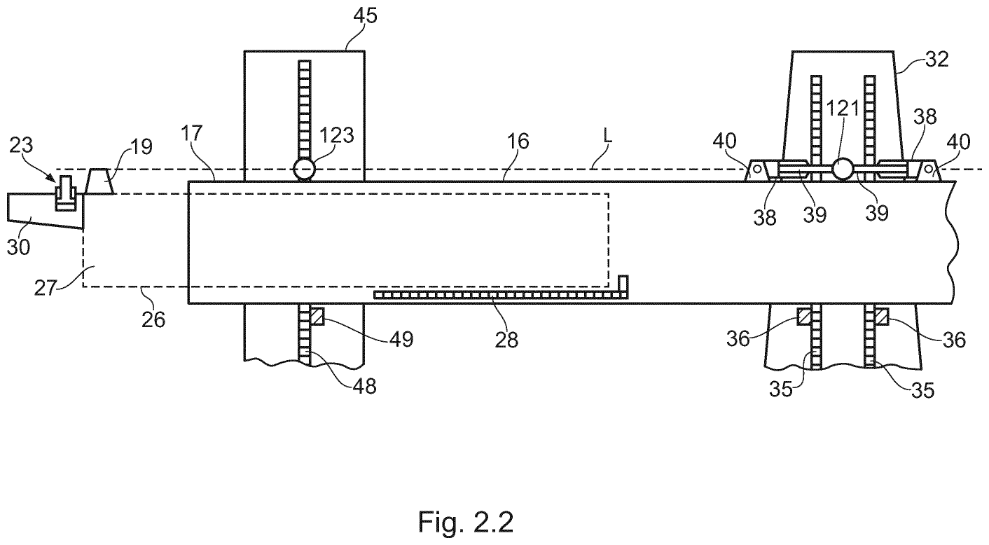

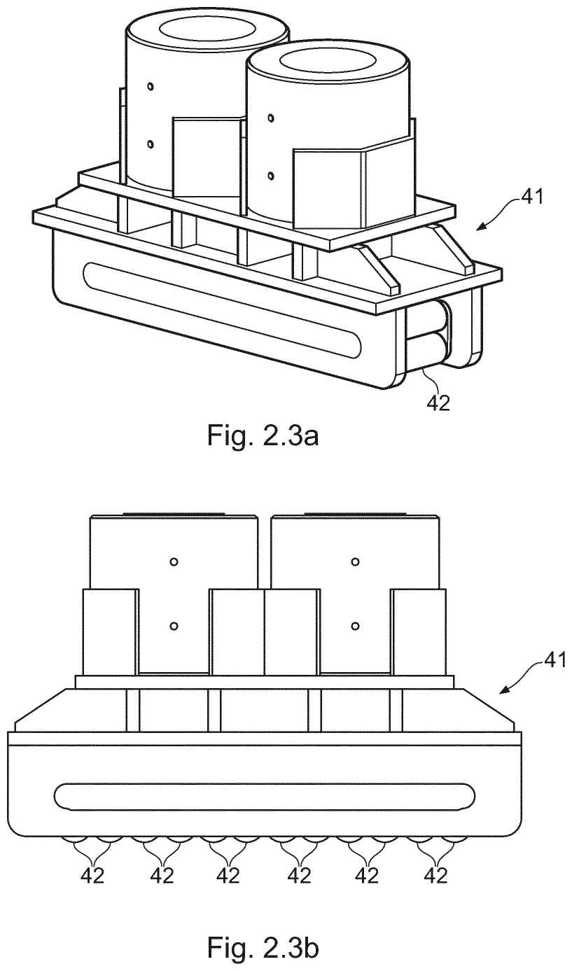

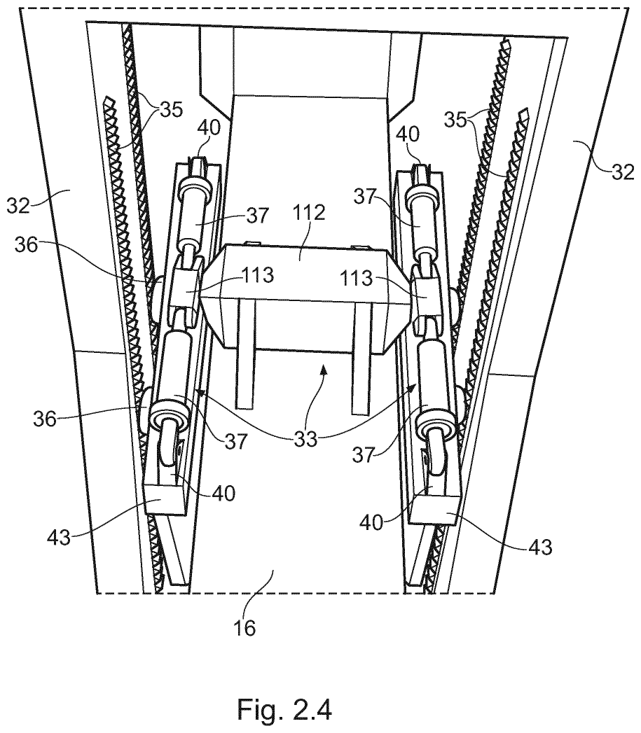

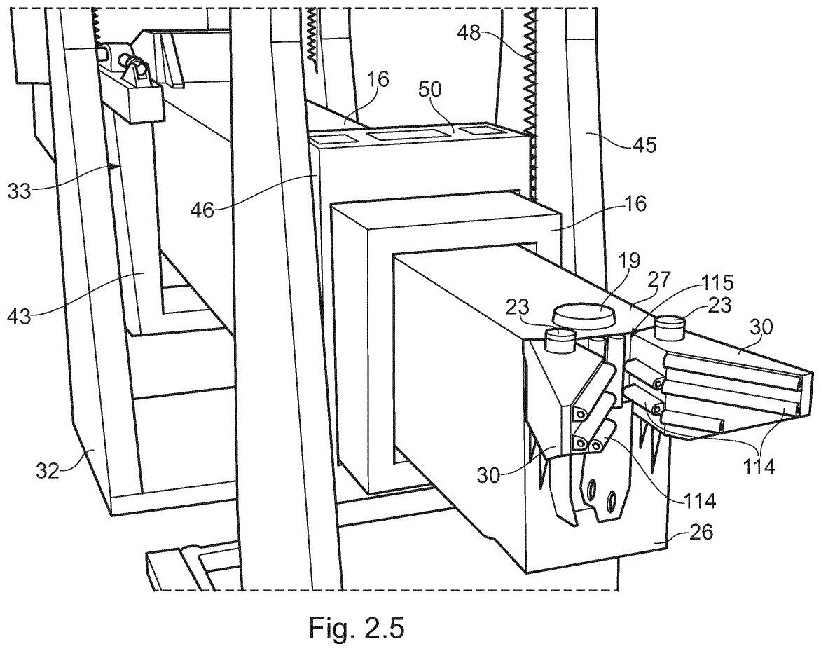

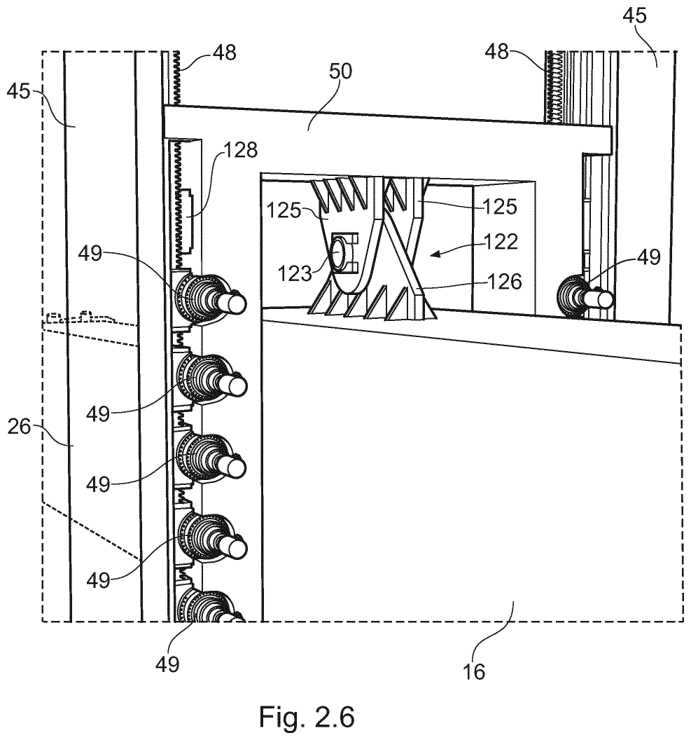

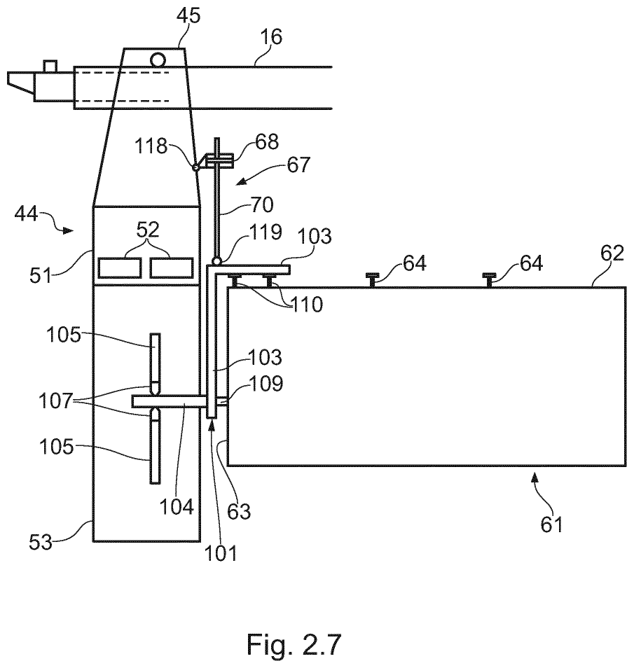

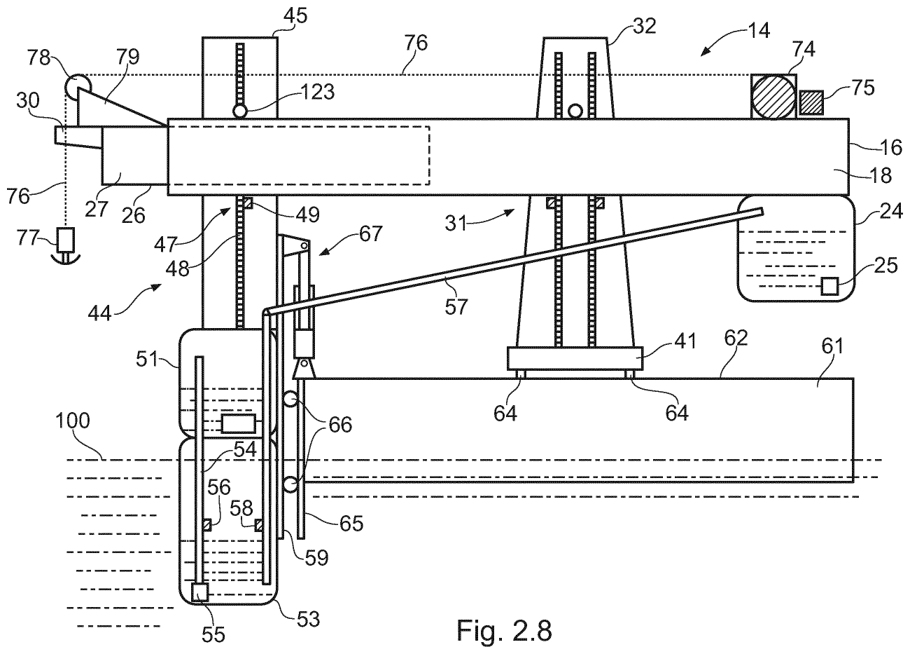

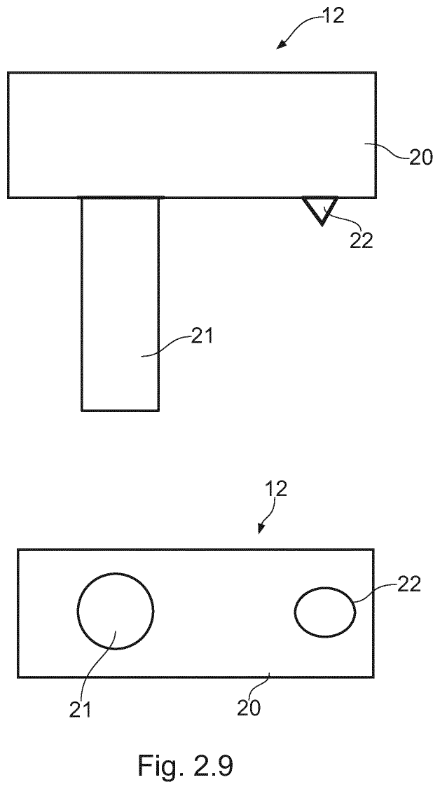

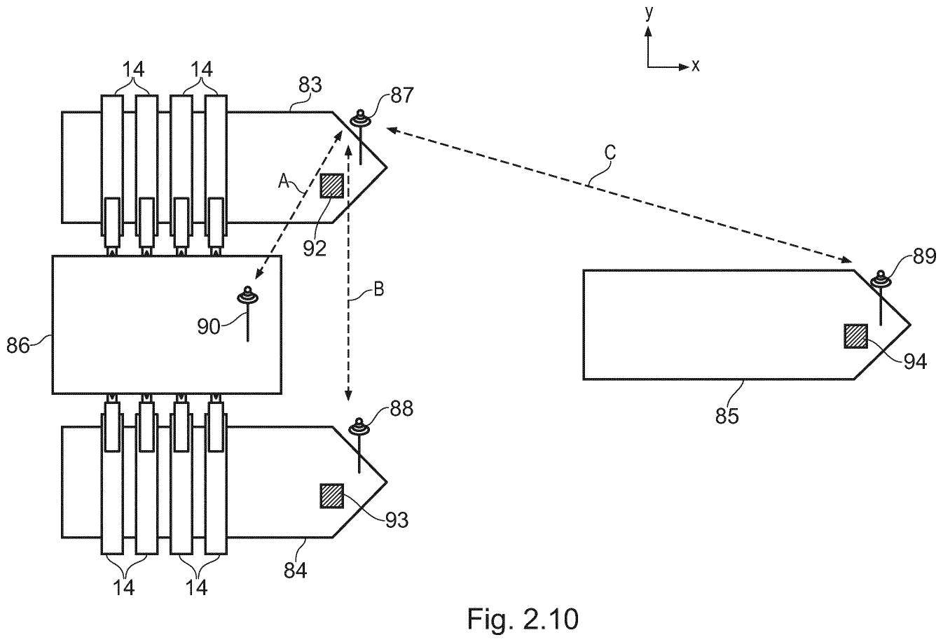

FIG. 2.1 illustrates schematically a lifting device arranged on a lifting vessel.

FIG. 2.2 shows an enlarged view of the lifting arm of the lifting device shown in FIG. 2.1.

FIGS. 2.3a and 2.3b schematically illustrates the base structure of a lifting device including a plurality of roller elements adapted for rolling on support rails on the deck of the lifting vessel.

FIG. 2.4 shows a portion of the lifting device illustrating in more detail the lift arm being supported by the first support frame.

FIG. 2.5 shows a portion of the lifting device illustrating in more detail the lift arm being supported by the second support frame.

FIG. 2.6 illustrates in more detail how the lift arm is connected to the second support structure.

FIG. 2.7 illustrates schematically an enlarged view of the ballast/buoyancy tanks with a preferred solution for connecting the ballast/buoyancy tanks to the lifting arm on the side of the lifting vessel facing the lift object.

FIG. 2.8 illustrates schematically the lifting device shown in figure in FIGS. 2.1-2.7 including equipment for hoisting.

FIG. 2.9 illustrates schematically an interface device which attachment to a lift object to be lifted by the lifting vessel.

FIG. 2.10 illustrates schematically an offshore lifting system lifting a lift object.

### Third Embodiment

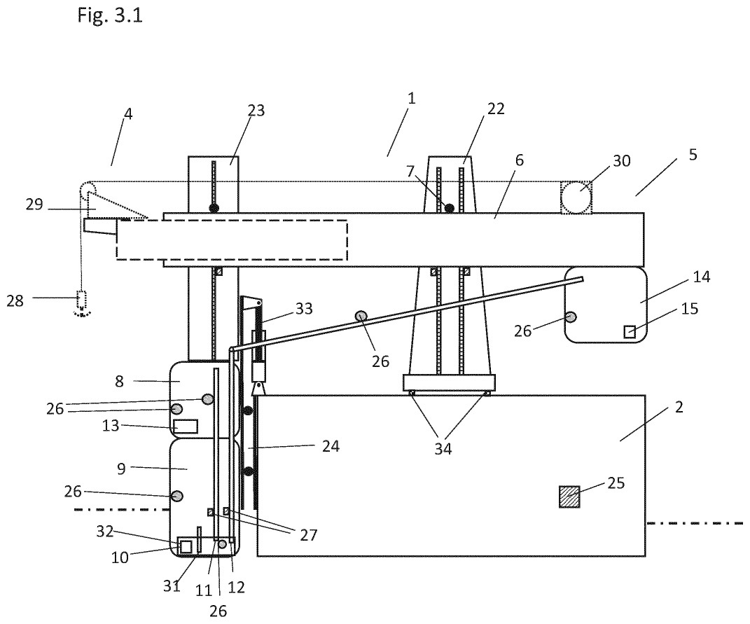

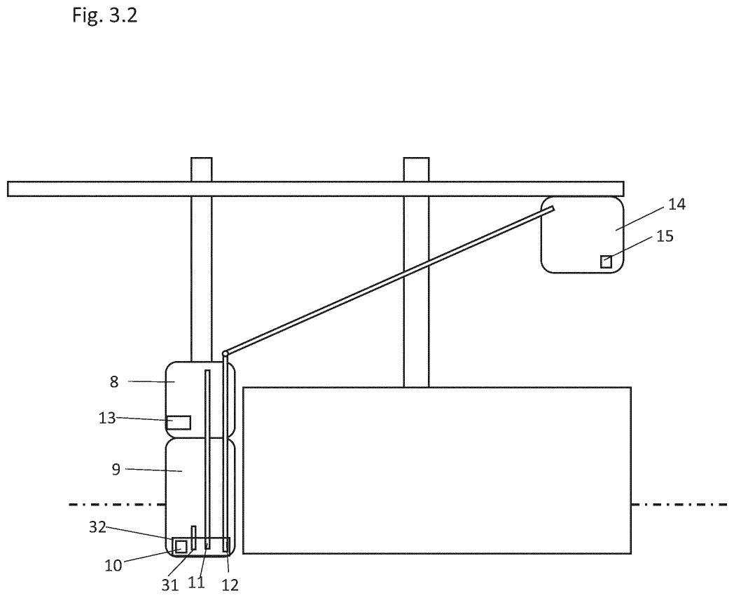

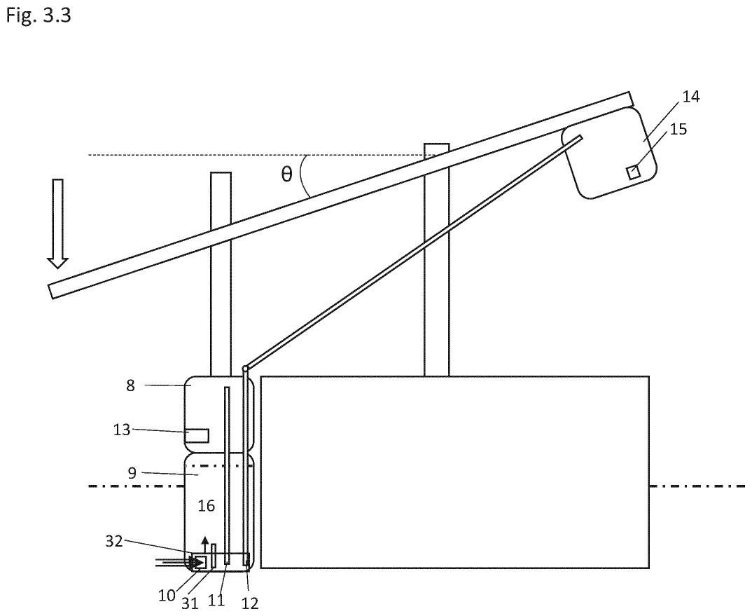

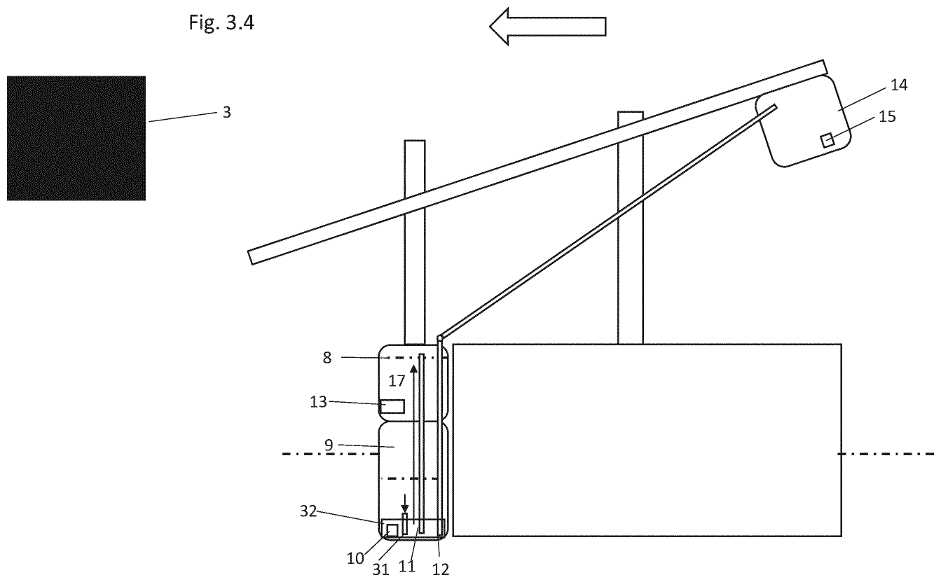

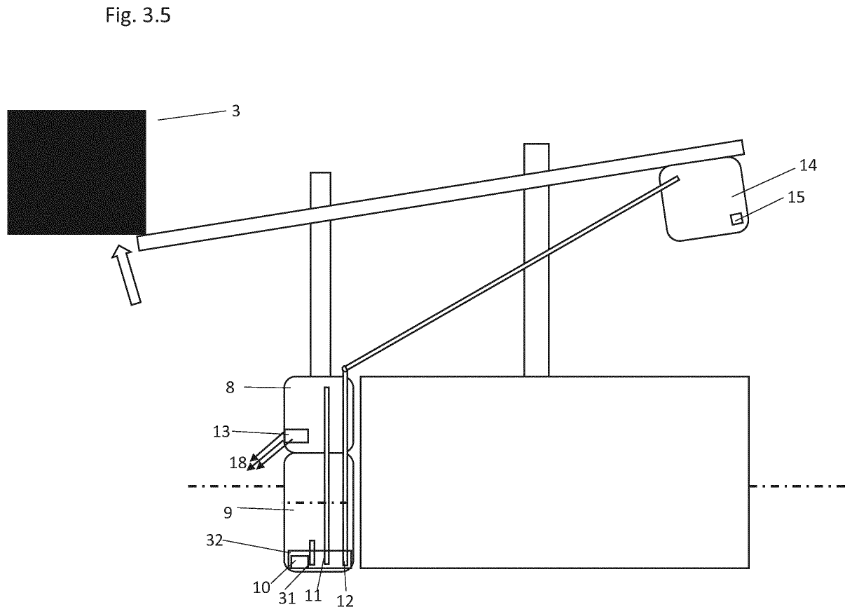

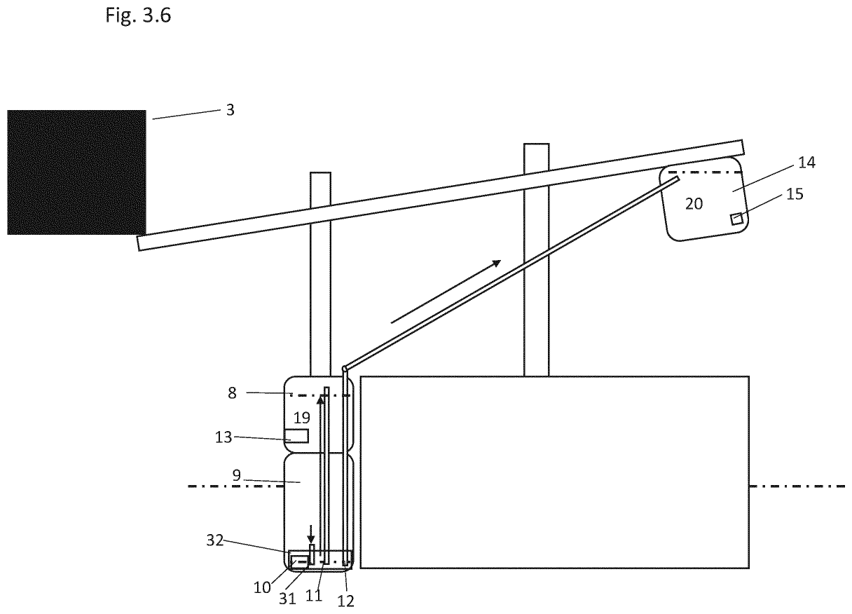

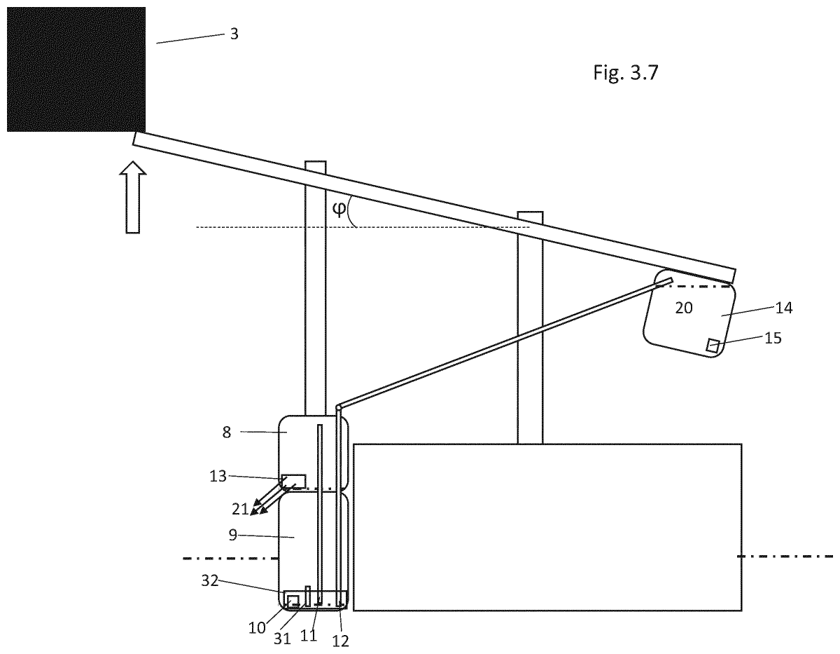

FIG. 3.1 schematically illustrates the different components of the lifting device mounted on a floating unit.

FIG. 3.2 schematically illustrates the lifting device and floating unit in a pre-operational position.

FIG. 3.3 schematically illustrates the buoyancy container being ballasted to lower the lifting end of the pivoting arm.

FIG. 3.4 schematically illustrates the transfer of water to the dump container and moving the floating unit towards a pre-lift position adjacent to a load.

FIG. 3.5 schematically illustrates the dumping of water from the dump container to bring the lifting end of the pivoting arm into a lift-off position, where it is in contact with a lifting point on the load.

FIG. 3.6 schematically illustrates the transfer of water from the buoyancy container to the dump container, and to the ballast container to transfer the weight of the load to the lifting device

FIG. 3.7 schematically illustrates the release of water from the dump container, thereby lifting the load to a predefined height.

### Fourth Embodiment

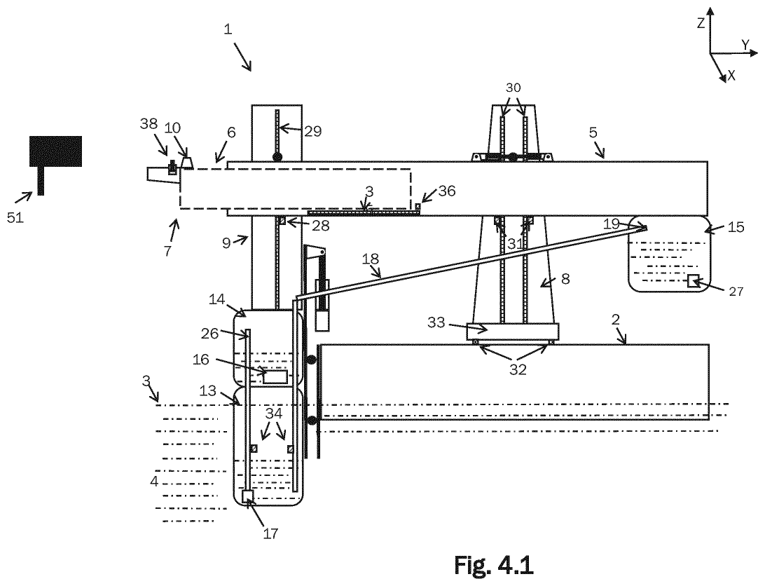

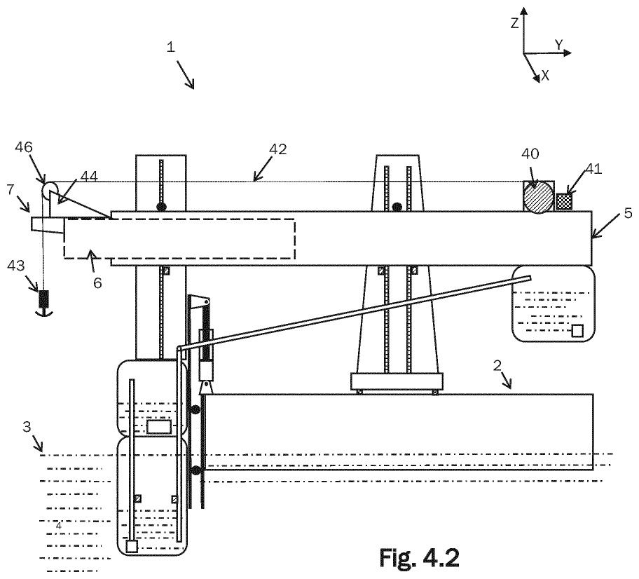

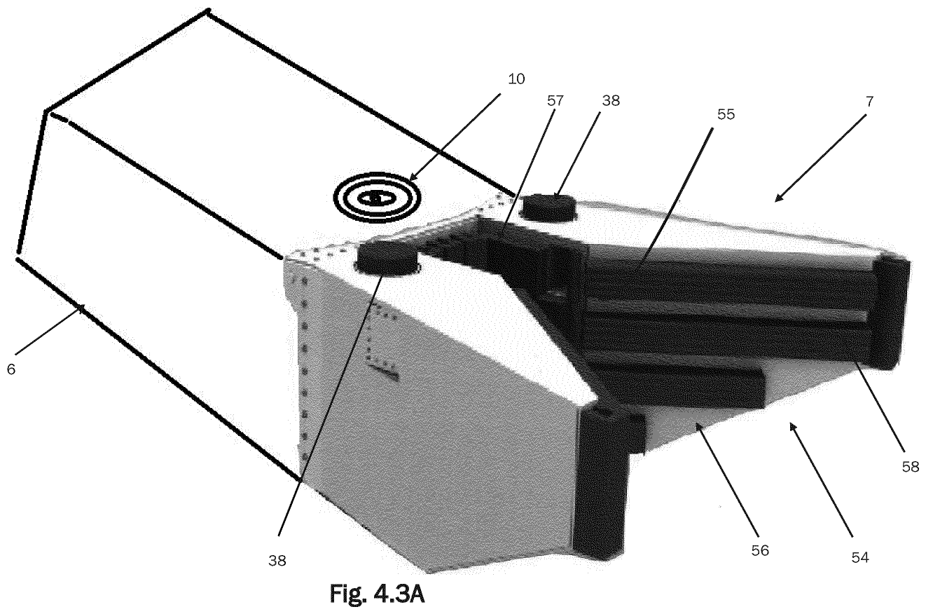

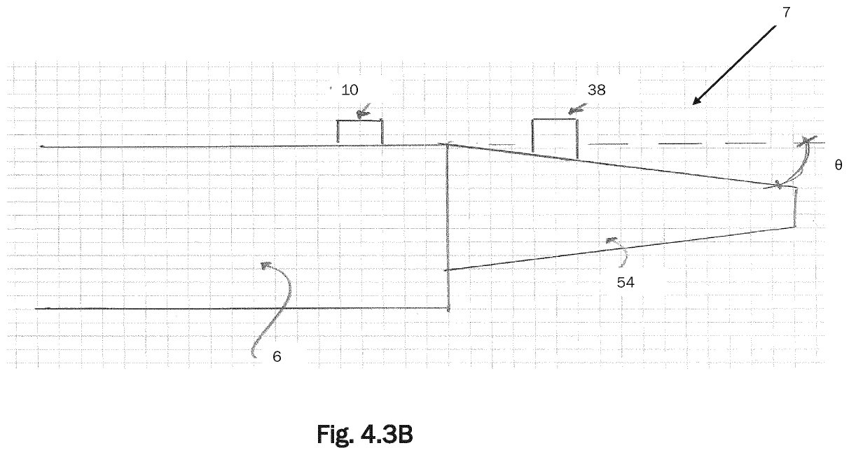

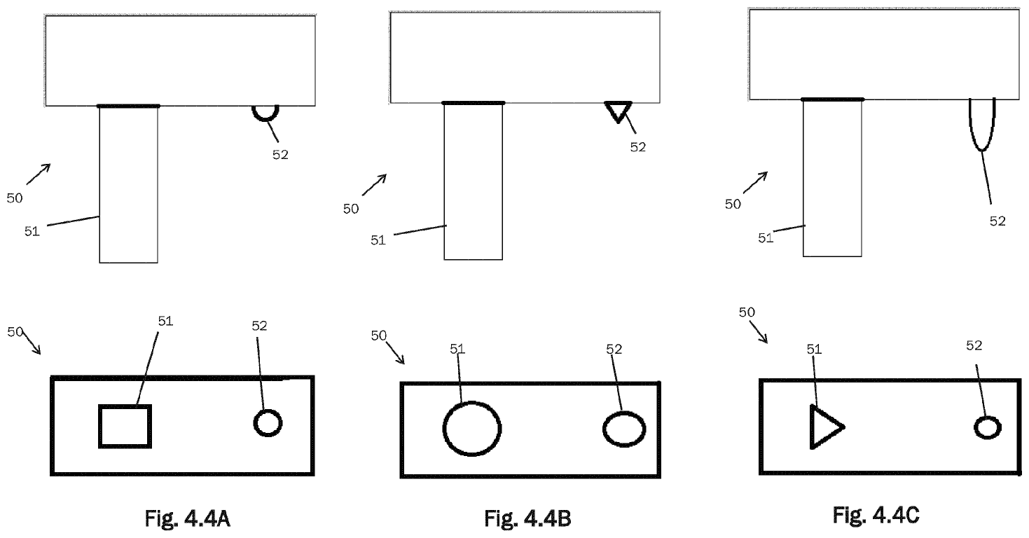

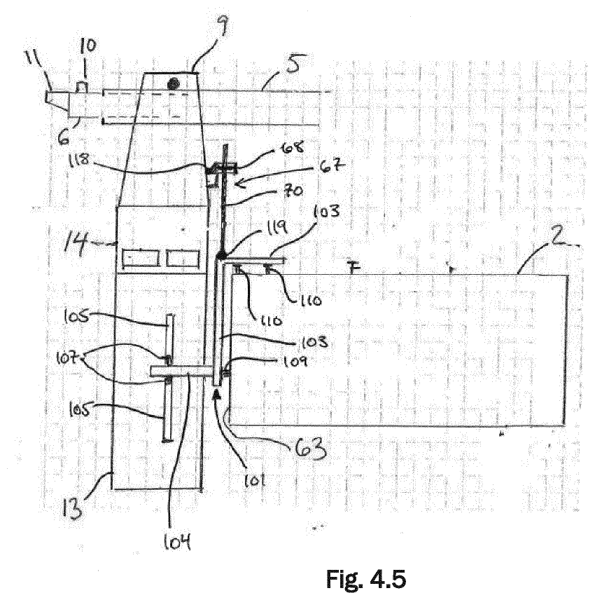

FIG. 4.1 shows an overview of a lifting device in accordance with the present invention in a first mode of lifting and lowering operations, the lifting device is mounted on the deck of a vessel;

FIG. 4.2 shows details of a second mode for lifting and lowering operations of the lifting device 1 according to the present invention;

FIG. 4.3A shows details of a guiding part and a lifting interface on the load-engaging part of the lifting device;

FIG. 4.3B shows details of an example of angular displacement of the coarse adjustment part and the telescopic arm of the lifting device;

FIGS. 4.4A-4.4C shows details of different load interfaces for cooperation with the lifting interface;

FIG. 4.5 shows details of a buoyancy lift structure;

### Fifth Embodiment

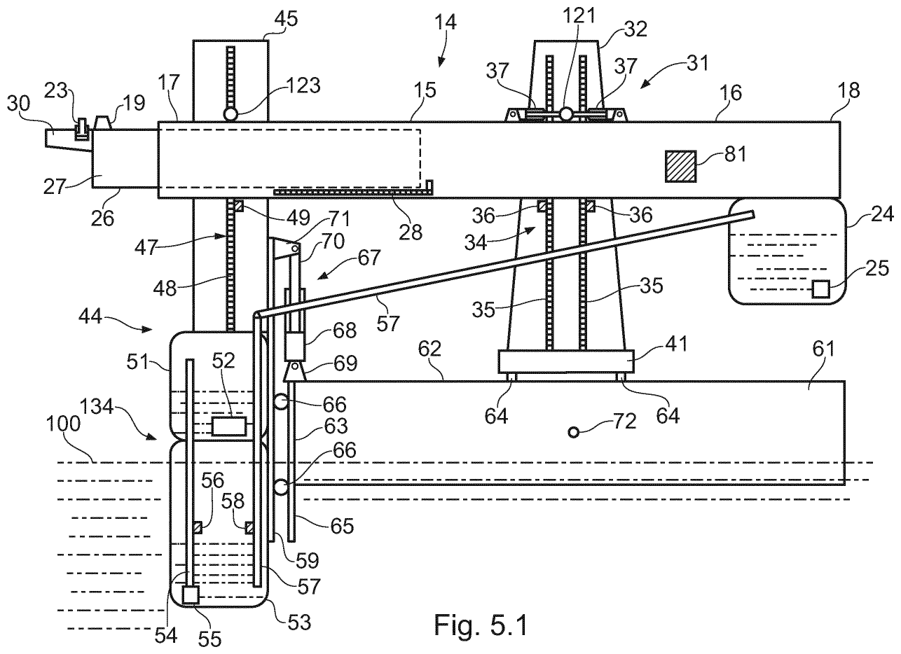

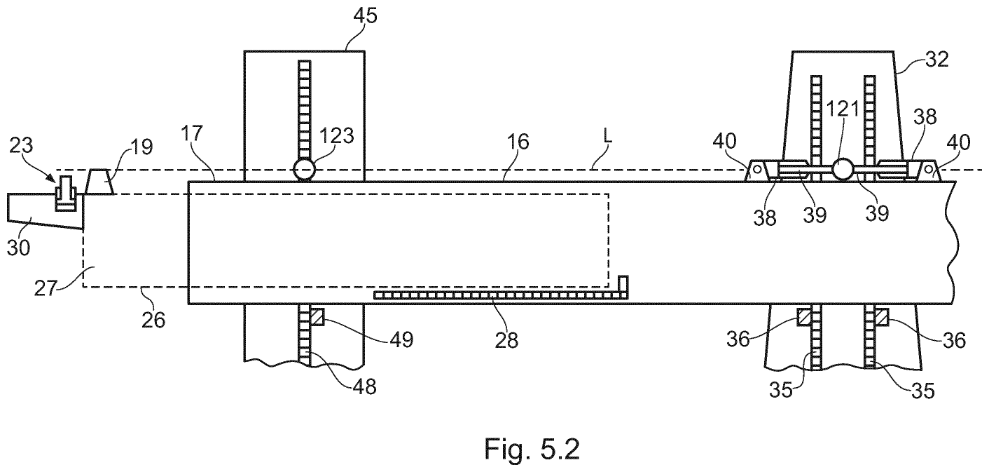

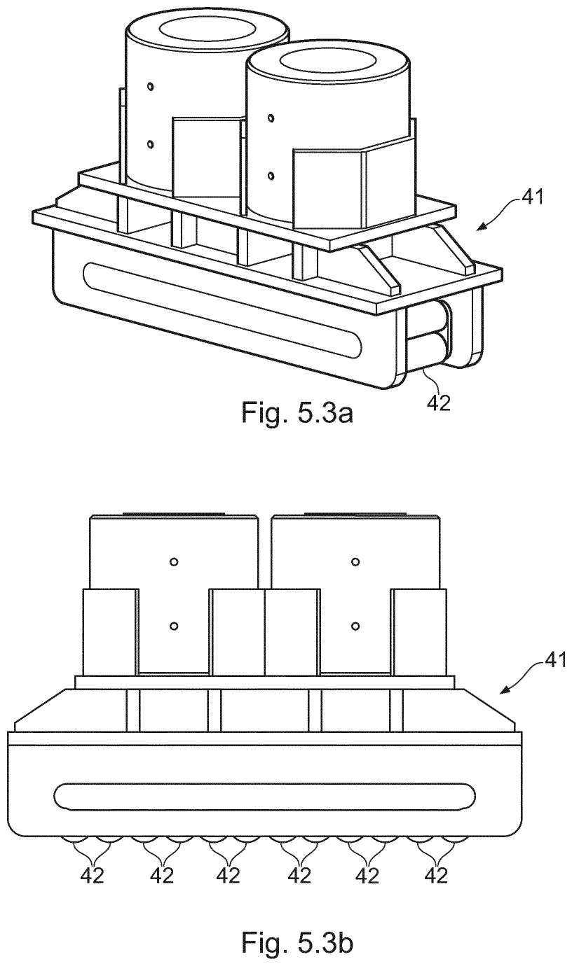

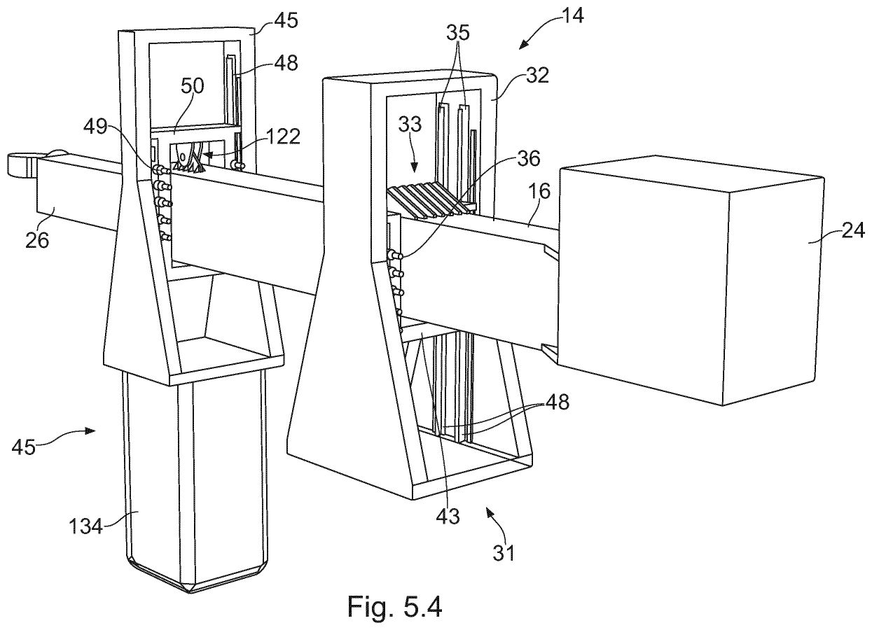

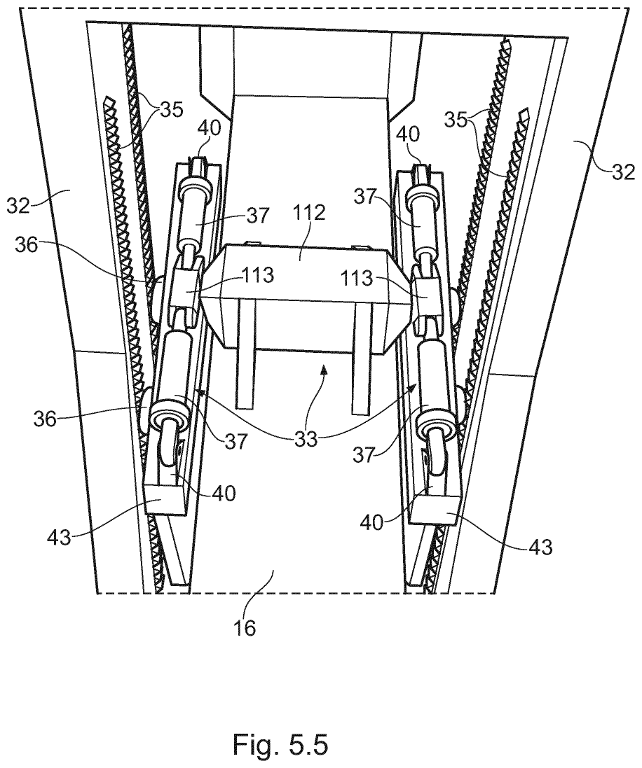

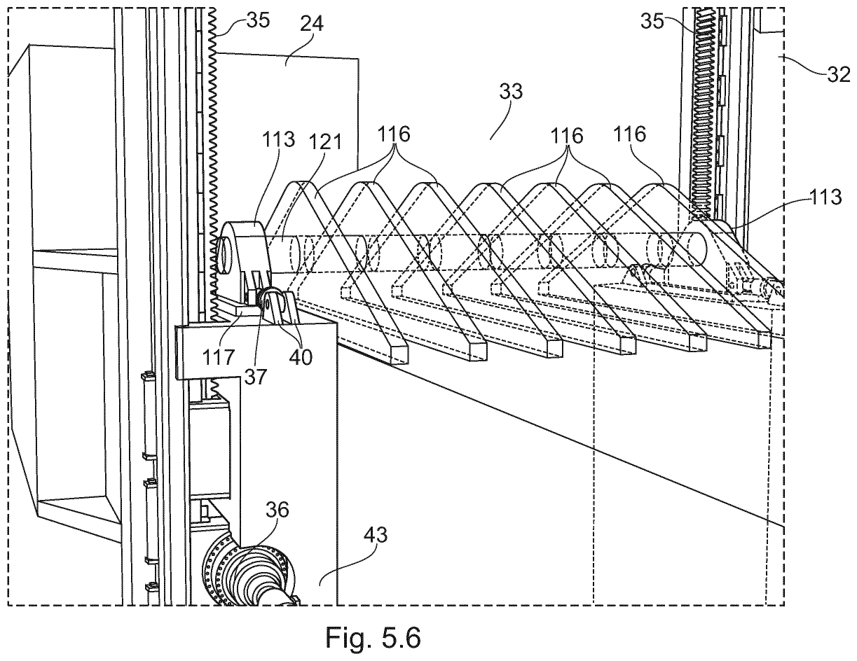

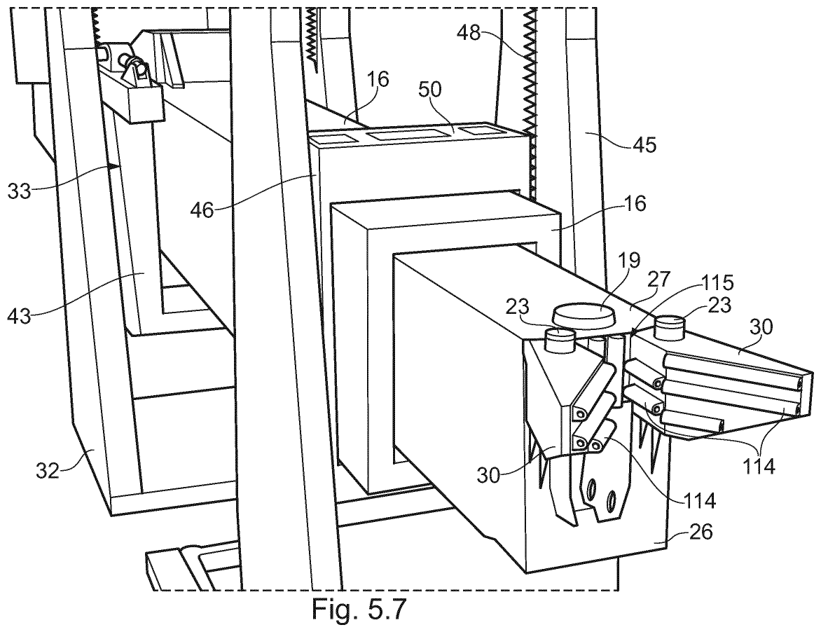

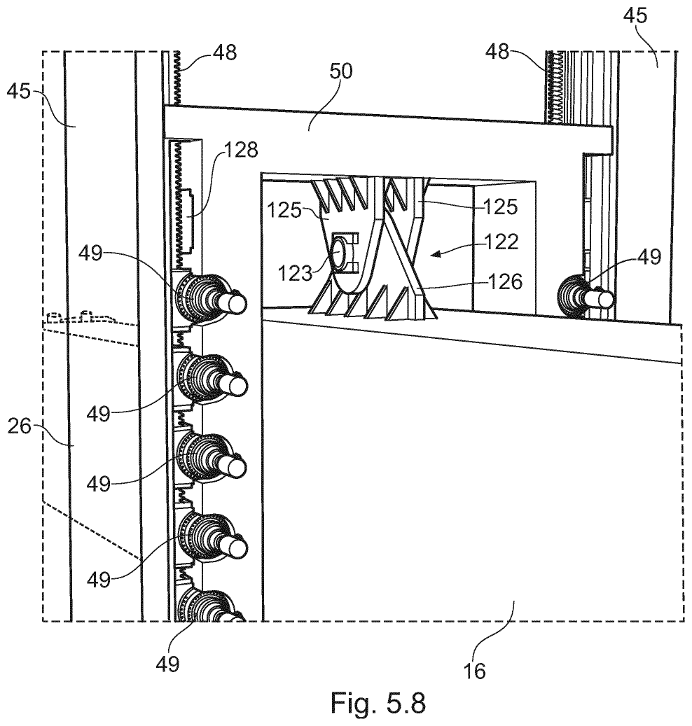

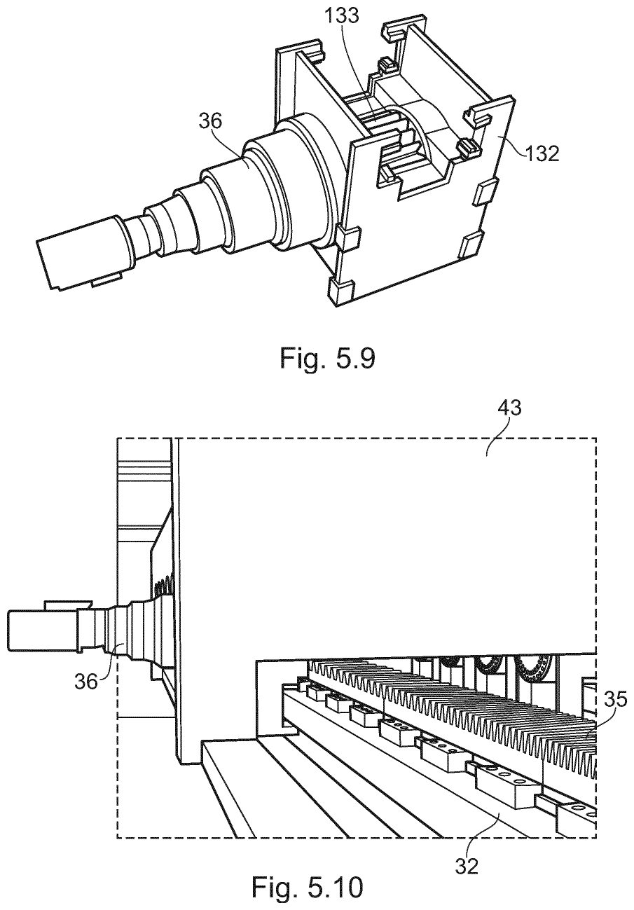

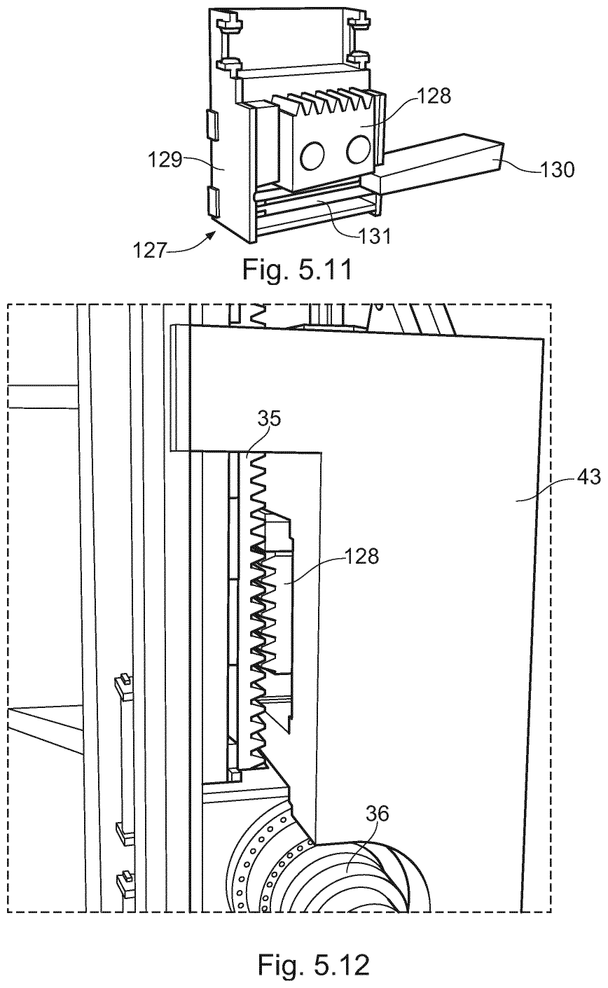

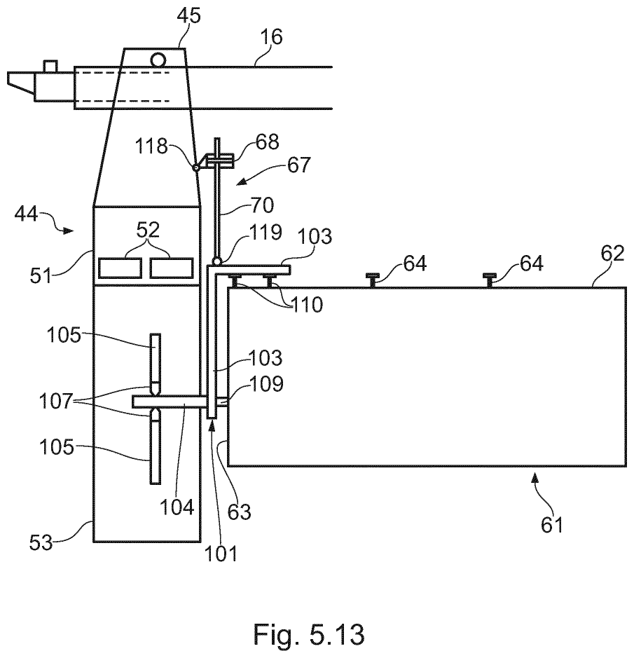

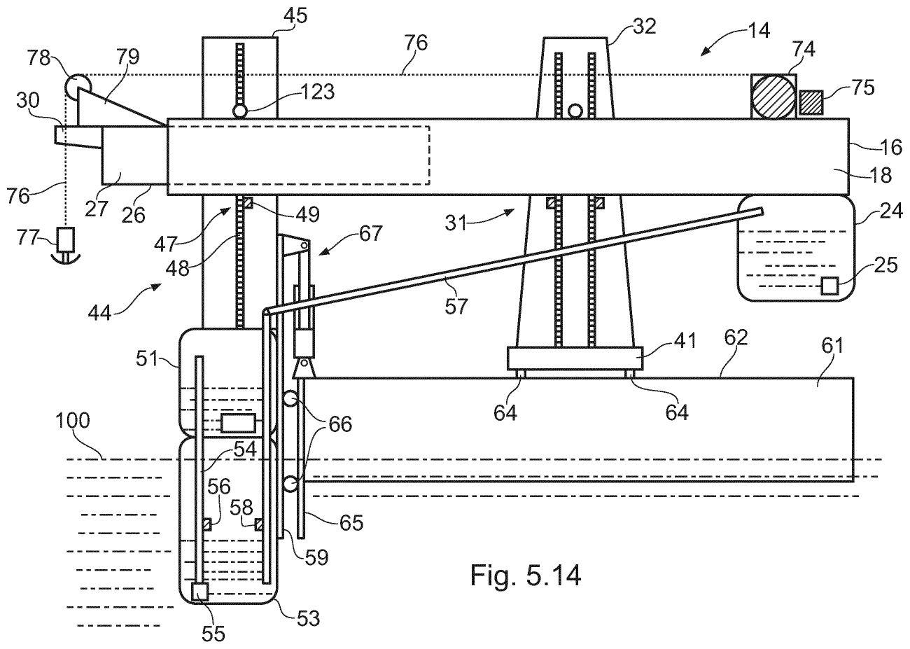

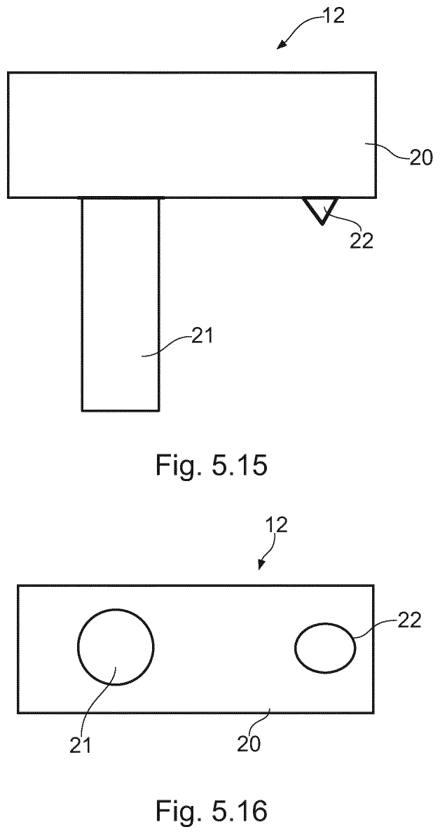

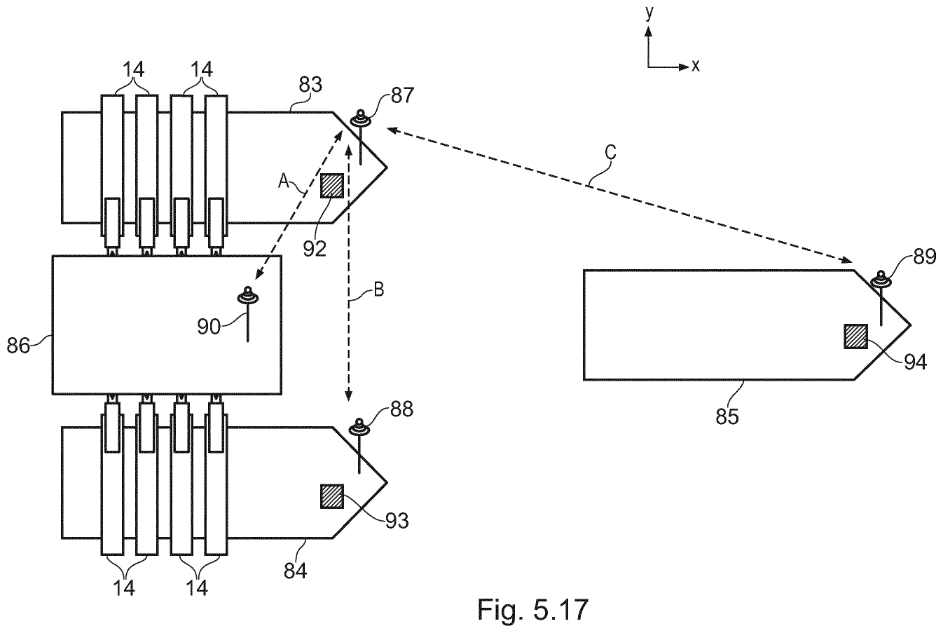

FIG. 5.1 illustrates schematically a lifting device arranged on a lifting vessel.

FIG. 5.2 shows an enlarged view of the lifting arm of the lifting device shown in FIG. 5.1.

FIGS. 5.3a and 5.3b schematically illustrates the base structure of a lifting device including a plurality of roller elements adapted for rolling on support rails on the deck of the lifting vessel.

FIG. 5.4 shows a perspective view of a lifting device including the first support structure, the second support structure and the lift arm.

FIG. 5.5 shows a portion of the lifting device illustrating in more detail the lift arm being supported by the first support frame.

FIG. 5.6 shows a view of the connection of the lift arm and the first support structure in more detail, including the first attachment connection.

FIG. 5.7 shows a portion of the lifting device illustrating in more detail the lift arm being supported by the second support frame.

FIG. 5.8 illustrates in more detail how the lift arm is connected to the second support structure.

FIG. 5.9 shows a pinion member used with the lifting device.

FIG. 5.10 shows a rack member and a pinion member mounted in an connecting element.

FIG. 5.11 shows a lock element in more detail.

FIG. 5.12 shows a lock element mounted in an connecting element and a rack member with which the lock member can be engaged to lock the connecting element, and thereby the lift arm, in a desired position.

FIG. 5.13 illustrates schematically an enlarged view of the ballast/buoyancy tanks with a preferred solution for connecting the ballast/buoyancy tanks to the lifting arm on the side of the lifting vessel facing the lift object.

FIG. 5.14 illustrates schematically the lifting device shown in figure in FIGS. 5.1-5.7 including equipment for hoisting.

FIGS. 5.15 and 5.16 illustrate schematically an interface device which attachment to a lift object to be lifted by the lifting vessel.

FIG. 5.17 illustrates schematically an offshore lifting system lifting a lift object.

### DETAILED DESCRIPTION OF THE INVENTION

The inventive concept will now be described more fully hereinafter with reference to the accompanying drawings.

### First Embodiment

FIG. 1.1 and FIG. 1.2 illustrate two aspects of a lifting vessel 1 arranged with a lifting device 2 mounted on skid rails 11, respectively in a forklift mode and a hoist mode. The lifting device 2 comprises a pivotally mounted lifting arm 12 with a lifting end 13 and a ballasted end 14 arranged on opposite sides of a pivoting point 15, with each end being connected to at least one container 16. In both aspects the arm 12 is telescopically extendable. The pivoting point 15 is mounted in a support tower 17, which is advantageously located in the centre of the vessel's 1 deck, preferably such that the pivoting point's axis 15 of rotation is located in the vertical plane through the vessel's 1 longitudinal centre line. The weight of the load 4 and lifting device 2 will thereby be directed down in the centre of the vessel 1, giving advantageous effects with respect to rolling motions of the vessel 1.

The lifting device 2 is operated by the transfer of water between the containers 16 connected to the arm 12 on each end, the ballasting principle behind the lever arm 12 is known from U.S. Pat. No. 6,668,747 B2 which is hereby incorporated through reference. However, as illustrated in FIG. 1.1 and FIG. 1.2, two containers 16 are arranged vertically adjacent to each other connected to the lifting end 13 of the arm. The upper container can be rapidly emptied of water, thereby also rapidly increasing the buoyancy force acting on the lifting end 13 of the arm which provides the lifting force to the load 4. This reduces or eliminates the need for use of pressurized gas to rapidly transfer water to the ballasted end 14 of the arm.

In the forklift mode shown in FIG. 1.1 the lifting end 13 of the arm 12 is fitted with a guiding device 18 to guide a load engaging part 19 to a lifting point on the load 4.

In the hoisting mode, shown in FIG. 1.2, a sheave module 20 is placed on the lifting end 13 of the arm 12, with a winching mechanism 21 placed in a distance away from the sheave module 20 on the arm 12. In the hoisting mode the load engaging part comprises a hook 22 or similar device on the end of a wire 23. The hoisting mode is especially suited for installation of structures on a sea bottom, but may also be used for other installation or decommissioning projects.

One lifting vessel 1 can be arranged with 1, 2, 3, 4, 5 or 6 lifting devices 2, arranged side by side along the length of the vessel 1 as shown in FIG. 1.3. As illustrated lifting vessels 1 work in pairs, with their respective lifting devices 2 facing toward a load 4 situated between the vessels 1. Advantageously, at least one transport vessel 6 may be deployed for transporting a load 4 so that the lifting vessels 1 only need to lift the load 4 for a short distance. The lifting operation typically comprises lifting a load 4 from a transport vessel 6, moving the load 4 to a set down location, and setting down the load 4. Several different variants are also possible, which will be explained in further detail.

The lifting devices 2 are remotely controlled by an operator from a control system 3. For operation, the lifting devices 2 are provided with pumps for ballasting, valves, hydraulics, winches and further machinery which will be apparent to the person skilled in the art based on the disclosure herein.

To effectively control the lifting devices 2, a plurality of sensor devices 8 are arranged on the lifting devices 2 as exemplified in FIG. 1.1 and FIG. 1.2 to monitor the system. The points 8 represent some examples of the possible locations sensor devices can be arranged on a lifting device 2. Each lifting device may comprise up to 500 sensor devices, including sensors for redundancy.

The sensor devices 8 may comprise cameras arranged so that an operator can visually monitor areas that are critical for the lifting operation, for example ensuring that the guiding 18 and load engaging parts 19 of the lifting device 2 are moved into engagement with the lifting points on the load 4. All cameras are advantageously arranged with tilt and focus, controllable by the control system 3. The sensor devices 8 preferably also comprise load cells and similar devices for monitoring physical forces acting on the lifting device 2. Further sensor devices 8 may monitor physical exertion of machinery such as pumps for ballasting, status of valves or torque on hoisting machinery 20,21. Sensor devices 8 can preferably also be provided to measure levels of ballasting, amount of wire spooled onto drums, angle of lifting arm tilt and comparable operational conditions. Sensor devices 8 can further include distance sensors, such as laser based or similar devices, to measure the distance between parts of the lifting device and the load, motion sensors such as gyrometers and accelerometers to measure the influence of sea motions on the lifting device. The distance sensors can also be arranged to measure the distance between different the lifting devices 1 and fixed points on the vessel, to be incorporated into a vessel based reference system.

The sensor devices 8 and machinery on the lifting devices are signally connected to a control system 3, preferably by a cable network located in shafts and tunnels in the vessels structure but a wireless network can also be used.

All critical control and sensor devices 8 are preferably made to be redundant, such that in the case of a malfunctioning device, the control system 3 is alerted and a redundant device is activated thereby restoring full functionality.

The control system 3 allows an operator to monitor all lifting devices 2 on board a lifting vessel and their position relative to the load 4, and independently control each lifting device 2. To avoid the task of coordinating all lifting devices 2 with respect to each other and the load 4, the control system 3 is arranged to process data from all the lifting devices 2 on board the vessel 1. The control system 3 integrates the received data into a common vessel based reference system, thereby allowing optimization and synchronization of commands sent by the operator. The operator thereby controls all lifting devices 2 either independently or synchronously.

The vessel positioning system preferably fulfills Dynamic Positioning Class 3 as defined by DNV-GL according to the current standard of January 2017. To monitor the vessel's 1 position and distance to the load 4 and other vessels 1 in a fleet, each vessel positioning system is equipped with at least one of: camera, laser, radar, acoustic and GPS based sensor devices 7. The vessel positioning system preferably also comprises environmental sensor devices 7, sensor devices monitoring physical position of the vessel and exertion of positioning machinery, in order to have the vessel at a desired location at all times. Advantageously, the vessel positioning system also comprises means for ballasting of the vessel 1. Preferably a network placed in cable shaft and tunnels along the vessel, connects the vessel positioning system with the control system 3, but a wireless network can also be used.

The vessel positioning system can be controlled and monitored independently by an operator. However the vessel's control system also allows for integration of data from the vessel positioning system with the lifting devices 2, thereby further optimizing and synchronizing commands with regard to the lifting operation.

The load 4 is preferably also arranged with a plurality of sensor devices 9. The sensor devices 9 typically monitor the lifting points, and the loads' 4 structure proximate to the lifting points. The sensor devices 9 on the load 4 may comprise many of the same monitoring functions as the sensor devices 8 on board the lifting vessels 1. In particular, the load preferably has cameras for monitoring critical areas of the lifting operation, e.g. the lifting points on the load 4 and load engaging parts 19 of the lifting devices 2. The load 4 may also comprise sensor devices 9 that can monitor the distance to different parts of the lifting devices 2 and lifting vessels 1, such as laser based sensor devices. The load 4 could also be arranged with sensor devices 9 to monitor forces on the load's 4 structure during lifting operations, such as load cells or similar. Sensor devices 9 to monitor movement such as accelerometers and inclination may also be arranged on the load 4, and environmental sensor devices to monitor weather conditions. The sensor devices 9 on the load 4 may be signally connected to a communication device, which relays data to the control systems 3 of vessels 1 in the fleet.

In an aspect of the invention, a transport vessel 6 is provided to transport the load 4, thus minimizing the distance required for the lifting vessels 1 to lift the load 4. The transport vessel 6 typically comprises skid rails 11 to mount a support platform on, the support platform providing support for the load 4 to be transported. In one alternative the lifting vessels 1 are identical with the transport vessel 6, whereby the transport vessel 6 comprises a vessel positioning system and control system 3 similar to the lifting vessels 1. This provides flexibility and redundancy in that a vessel may be arranged to be either a transport vessel 6 or a lifting vessel 1, and each vessel may be outfitted accordingly at a dock. In another alternative, transport vessel 6 has a substantially similar structure and systems as the lifting vessels 1, but the bow shape and ballasting means are optimized for efficient, stable and safe transport of the load 4. In yet another alternative the transport vessel 6 is any barge or floating unit suitable for carrying the load 4. In the alternatives where the transport vessel 6 is not similar to the lifting vessels 1, the transport vessel 6 will preferentially still comprise a vessel positioning system and control system 3 capable of similar functions as the lifting vessels 1.

The control systems 3 on board all vessels may be signally connected to a black box which continuously stores all data, received, sent and processed.

It should be noted that the invention is not restricted to comprising a transport vessel 6, for example lifting operations close to shore, for removal or installation of structures and where distances are short. Alternatively, the lifting vessels 1 can transport the load 4 all the way from a dock location to a set-down location located offshore, if the weather conditions allow for such an operation.

In a preferred aspect of the invention, illustrated schematically in FIG. 1.3, the lifting operation is exemplified by a fleet consisting of two lifting vessels 1 and a load 4. In one alternative, the load 4 is mounted on a floating unit such as a transport vessel 6 in which case the floating unit can be equipped with a vessel positioning system and control system 3. In another alternative, the load 4 is mounted on a stationary structure such as platform jacket. As an example, the lifting vessels 1 are firstly moved to a pre-operational position on each side of the load 4, the pre-operational position being located a distance from the load 4. The pre-operational positions are located at a distance parallel to the load 4, the distance being dependent on a variety of factors such as environmental conditions and the ability of the communication devices to send and receive signals between the vessels and load. The distance will advantageously not exceed what is practically possible for the lifting vessels 1 to maneuver by using thrusters and taking into account wind, wave and currents in the area. During the deployment of the fleet, positional sensors on the vessels 1,6 and load 4 can constantly feed other vessels control systems 3 with data concerning their at least any one of: relative positions, environmental conditions and distances to each other.

In the pre-operational position, the lifting devices 2 are ballasted to tilt and or elevate the lifting arms 12 to a position where they are ready to lift the load 4. The lifting vessels 1 are then moved towards the load 4 by the positioning systems until they reach a pre-lift position alongside the load 4. In forklift mode the pre-lift position is defined by the guiding device 18 having guided the lifting device 2 so that a load engaging part 19 is located substantially vertically underneath a lifting point on the load 4. In the hoisting mode the pre-lift position is defined by the sheave module 20 being located substantially vertically above a lifting point on the load 4. Once the vessels 1 approach the pre-lift position, the sensor devices 8 measuring distance and cameras become increasingly important to monitor to ensure the guiding parts meet their respective lifting points on the load 4. The vessels positioning system, and sensors on the load 9 are also important to keep the vessels on a steady trajectory and position. Environmental sensors will aid in anticipating how the vessels are affected by outside factors including gusts of wind, wave height and direction of the current.

In forklift mode the lifting devices 2 are ballasted once the lifting vessels 1 are in the pre-lift position, so that the load engaging part 19 of each lifting arm is tilted upwards and comes into contact with a respective lifting point on the load 4 without lifting the load 4. When all the load engaging parts 19 are engaged, the lifting vessels 1 are in a lift-off position. Some of the load's 4 weight is transferred to the lifting devices 2 at this point to ensure that the load 4 and lifting devices 2 are coupled, but the lifting devices 2 will be configured to evenly distribute the weight of the load 4 among all the lifting devices 2 without lifting the load 4.

In hoisting mode the winching mechanism 21 lets out a length of wire 23 so that the hook 22 drops to a level near a lifting point on the load 4, the lifting point being a point that where the hook 22 can be attached. The hook 22 may also be attached to a wire loop connected at a lifting point on the load 4. Once the hook 22 is attached to the load 4, the winching mechanism draws in wire 23 until it is tight. When the wire 23 is tight, this is the lift-off position for the hoist mode. In the lift-off position some weight may also gradually be transferred to the wire 23 by ballasting the lifting devices 2, and evenly distributing the weight amongst the lifting devices 2.

As the lifting vessels 1 move from the pre-lift position to the lift-off position, the sensor devices 7,8,9 monitoring physical forces on the load, lifting devices and vessels, and the sensor devices monitoring physical exertions become increasingly important to monitor. Once the lift-off position is achieved it is also increasingly important that the vessels' 1,6 positioning systems are working synchronously. The lift-off position is defined as when all the lifting devices 2 are in engagement with the load 4, and the lifting devices 2 together will be carrying a given percentage of the load's 4 weight, for example between 5-15% enabling the sensor devices 8 on the lifting devices to measure the forces acting on each arm 12.

Once the amount of the load's 4 weight that has been transferred to the lifting devices 2 reaches a given percentage, for example between 80-95%, the upper containers 16 on the lifting end 13 of the lifting vessels 1 dump water, thereby giving a rapid increase in buoyancy which lifts the load 4 up a predetermined distance into a lift position.

Once the load 4 is lifted into the lift position, the lifting vessels 1 cooperatively move the load 4 to a set-down location. This part of the operation requires continuous monitoring and synchronization of all sensor devices 7,8,9 and commands to the lifting devices 1 and vessel positioning systems.

For forklift mode operations, the set down position can for example be on a stationary installation such as a jacket, or a floating unit, such as a transport vessel 6. In the case of a stationary installation the lifting vessels 1 need to transport the load 4 directly above its position to set down the load 4. In the case of a floating unit, the lifting vessels 1 can be stationary whilst the floating unit is brought underneath the load 4. Once the load is above its designated set-down unit, the lifting devices 2 are ballasted to slowly set down the load 4. Once the load has 4 been successfully set down, the lifting vessels 1 are moved away from the load 4.

In hoisting mode, the set-down position is usually at a sea bottom. The lifting devices 2 are therefore not ballasted, but the winching mechanisms 21 on the lifting devices lower the load 4 down to the sea bottom, whereupon the hooks 22 are released and winched back up. The lifting vessels 1 can then sail away from the set-down location.

A lifting operation therefore requires coordination of at least two lifting vessels 1, with up to six lifting devices 2 on each vessel, and preferably a third floating or stationary unit for set-down and lift-off. In order to ensure that actions are coordinated between lifting vessels 1 with their respective lifting devices 2, the control system 3 of any one lifting vessel 1 is adapted to take over the control of all the other vessels control systems 3. Likewise, all vessels control systems 3 are adapted to be taken over by another vessel's control system 3.

The most delicate part of the lifting operation begins with the lifting devices 2 in lift-off position, when the lifting devices are being ballasted and weight is transferred to the lifting devices 2, and continues until the load 4 has been successfully set down. Once part of the weight of the load 4 has been transferred to the lifting devices 2, it is crucial that the lifting vessels 1 keep a steady position, and the weight of the load 4 is distributed evenly and slowly to the lifting devices 2. To alleviate the coordinating difficulties, the latest point in time during the lifting operation to activate the master/slave configuration is therefore when the lifting devices 2 have been ballasted to the lift-off position.

In a preferred aspect of the invention, one vessel's control system 3 is allocated as master and takes control over all other control systems in the fleet when all lifting devices 2 are engaged with lifting points on the load 4. In the case that the transport vessel 6 comprises a control system 3 capable of being master or slave, it can also be allocated as master or slave at this same point in time during the operation. The master vessel's control system 3 stays in control until the load 4 has been successfully set down, as the lifting vessels 1 are then uncoupled from the load 4 and are not required to act cooperatively any longer.

In alternative aspects of the invention, the master vessel can be allocated at an earlier point in time during the lifting operation, typically from the pre-operational position and further out into the lifting operation.

Before the master vessel is allocated, the control system 3 on board each vessel can control the lifting devices 2 independently, together, or in combination with the vessel positioning system as explained earlier.

In an aspect of the invention, all vessel control systems 3 are adapted to be either master or slave. In another aspect of the invention, only one vessel in the fleet can be allocated as master vessel, thereby reducing the need to equip all vessels with a control system 3 that can function as both master and slave, instead each control system comprises a specific ability to be either master or slave. For example, the lifting vessels 1 may comprise the ability to take on both master or slave role, this gives the system increased flexibility and redundancy. In another example, one lifting vessel 1 only comprises the capability of being master, whilst the rest of the lifting vessels 1 and any possible transport vessels 6 only comprise the capability be allocated as slaves, as this could prove to be a cheaper option which reduces the need for equipping all lifting vessels with dual master/slave capabilities. In a further example, the lifting vessels 1 only comprise the capability of being slaves as a transport vessel has the capability of being master. Yet further examples are possible within the scope of the claims, the advantage of the invention being that any vessel's control system, with the right capabilities, in the fleet may assume control of the lifting operation and the remaining slave control systems 3. In yet another aspect of the invention, the roles of master or slave are permanent features of a vessel, which preferentially requires a fleet of ships to be put together so that a master vessel is present to control the slave vessels.

Should an emergency situation arise after the load 4 has been brought to the lift position, where a first of the lifting vessels 1 experiences an intentional or unintentional loss of propelling power, the propulsion system of the second lifting vessel 1 will preferably be sufficiently powerful to move the load 4 with the first vessel 1 to a set down position.

FIG. 1.4 schematically illustrates a preferred aspect of the invention exemplifying the flow of signals between two lifting vessels, where one vessel's 1 control system 3 is allocated as master and thereby sends commands to the control system 3 of the slave vessel. The slave vessel's control system 3 still receives signals from the sensor devices 7 affiliated with its positioning system, lifting devices 8 and sensor devices located on the load 9, however these signals are relayed to the master vessel's control system.

The master vessel's control system is arranged to receive data from every sensor device in the fleet and on the load. This allows the master control system to optimize and synchronize all actions during the lifting operation. For example, the forces acting on each lifting device 2 can be calculated as weight is transferred to the lifting devices 2 when they are in lift-off position, this data is then processed in the control system, which calculates the three dimensional position of the centre of gravity of the load based on this data, which is then incorporated in the control systems of the vessels. All positioning, movement and environmental data can be fed into a common reference system, thereby allowing anticipation of how actions will affect other parts of the system, this also allows one operator full control of all vessels positioning systems and lifting devices 2. The setup of a control system 3 that can process and integrate of the data will be evident to the person skilled in the art based on the invention described herein. All commands by the operator to the lifting or positioning system will thereby be synchronized and adapted to the condition of the vessels, lifting devices and environment.

In one aspect the system for lifting heavy loads comprises installing an offshore installation such as a topside on a fixed jacket structure or semisubmersible hull. In this aspect the transport vessel 6 is loaded with the offshore installation 4 at a dock or other upstream location or at a shipyard located anywhere in the world. The topside 4 is then transported to an installation site, where a jacket structure, semisubmersible hull or other bottom part which the topside 4 is to be installed upon is already in place. The lifting vessels 1 will also be present at the installation site, with lifting devices 2 adjusted to fit with designated lifting points on the load 4. The lifting vessels 1 deploy to a pre-operational position, after which they move in towards the sides of the transport vessel 6 carrying the load 4. Meanwhile, the transport vessel 6 can ballast to an appropriate draught for the lifting devices 2 to lift the topside. When the lifting devices 2 are in a lift-off position, the master slave configuration is activated. The lifting devices 2 then lift the topside 4 into a lifting position, and the transport vessel 6 moves away from under the load. The lifting vessels 1 then move the load 4 to above the set-down structure, such as a jacket or semisubmersible hull, and the lifting devices 2 lower the topside 4 down. When the topside 4 has been successfully set down, the master slave configuration is deactivated and the lifting vessels 1 sail away. For these lifting operations the bottom structure can also be fitted with sensor devices that can communicate with control systems 3 on board the vessels.

In another aspect of the invention, this process is reversed for decommissioning a topside or similar structure 4. In this aspect the lifting vessels 1 are firstly moved to a topside structure 4, which is cut from a bottom structure such as a jacket, the decommissioned object 4 lifted and moved on to a transport vessel 6.

In other aspects of the invention, the installation operations are carried out in the hoisting mode.

### Second Embodiment

Referring to FIGS. 2.1-2.7, a lifting device 14 is shown arranged on a lifting vessel 61 in a body of water 100. The lifting vessel comprises a deck 62 and a hull side 63 which is facing the lift object 86 (see FIG. 2.10) during a lifting operation.

The lifting device 14 comprises a lift arm 16 which is supported by a first support structure 31 and a second support structure 44. The first support structure 31 and the lift arm 16 are provided with a first elevation device 34 while the second support structure 44 and the lift arm 14 are provided with a second elevation device 47 where the first elevation device 34 and the second elevation device 47 are used to move the lift arm 16 vertically relative to the first support structure 31 and the second support structure 44. The first elevation device 34 preferably comprises a rack and pinion system as will be further explained below, but any other type of elevation device may be used as long as it is suitable for moving the lift arm 16 vertically. The second elevation device 34 preferably also comprises a rack and pinion system as will be further explained below, but any other type of elevation device may be used as long as it is suitable for moving the lift arm 16 vertically.

The first support structure 31 is supported on the deck 62 of the lifting vessel 61 while the second support structure 44 comprises a fluid tank assembly 134 which, as shown in FIGS. 2.1 and 2.14 includes at least a first fluid tank 51 and a second tank 53 of which at least one is arranged in the body of water 100, next to the hull side 63 of the lifting vessel 61. The fluid tank assembly 134 may be formed as a fluid tank with separate compartments forming the at least one fluid tank 51 and the at least one fluid tank The fluid tanks 51, 53 are buoyancy/ballast tanks which provide sufficient buoyancy to support the second support structure 44 and the lift arm 16 and to provide sufficient lifting power to lift the lift object 86 during a lifting operation. The fluid used for ballasting the fluid tanks 51, 53 is preferably water and the amount of fluid contained in each fluid tank 51, 53 can be independently varied as will be explained in further detail below.

The first support structure 31 comprises a first support frame 32 mounted on a base structure 41. The base structure 41 comprises a plurality of roller devices mounted in or to the underside of the base structure 41. Each roller device is provided with at least one roller element 42 which are capable of resting on a support rail 64 on the deck of the lifting vessel 61 and rolling along the support rails 64.

The roller elements 42 of the roller devices may be arranged in a fixed position where the roller elements 42 rest on their respective support rails 64 on the deck of the lifting vessel 61 such that the first support structure 31 can be moved on the rails 64 in a longitudinal direction of the lifting vessel 61. Alternatively, the roller elements 42 may be arranged movable between a lower position and an upper position by a suitable motor, typically an electric motor. When a roller elements are in their lower positions, the roller elements rest on their respective support rails 64 on the deck of the lifting vessel 61 and the first support structure 31 can be moved on the rails 64 in a longitudinal direction of the lifting vessel 61. When a roller element is in its upper position, the base structure 41 rests on the support rails 64 and the first support structure 31 is incapable of being moved.

To effect the movement of the first support structure 31 along the rails 64, a conventional gripper jack system may be used. Alternatively, the roller devices and/or the base structure 41 may be provided with a motor, typically an electric motor, for rotation of the roller elements in the desired direction. The base structure 41 and the support rails 64 and/or the deck 62 may further be provided with a locking device or one or more cooperating locking devices (not shown on the figures) to secure the first support structure 31 in its position on the support rails 64 when the lifting device 14 is located in its desired position in the longitudinal direction of the lifting vessel 61.

The number of roller devices that a support structure 31 is provided with will be determined in part by the weight of the lifting device 14 and to a larger extent by the desired lifting power of the lifting vessel 61 and the number of lifting devices 14 that the lifting vessel is provided with to which the weight of the lift object 86 is distributed, and by the weight each roller element and/or the support rails 64 are capable of supporting without getting damaged.

The first support structure 31 further comprises a first attachment unit 33 that connects the lift arm 16 to the first support frame 32 and allows the lift arm 16 to be moved vertically and to be rotated about a substantially horizontal axis relative to the support frame 32 as will be explained in more detail below.

The lift arm 16 comprises beam element 15 which is mounted to and supported by the first support structure 31 and the second support structure 44. The beam element has a first end portion 17 and a second end portion 18. The lift arm 16 preferably, but not necessarily, further comprises a telescopic arm 26 which is telescopically arranged in the in the beam element 15. A rack and pinion system including a rack member 28 mounted to the inside of the beam element 15 and a pinion member (not shown in the figures) mounted to the telescopic arm such that the pinion member engages the rack member 28, can be used to move the telescopic arm 26 in and out of the beam element 15.

The telescopic arm 26 has an outer end portion 27 which is located outside the beam element 15. As can be more clearly seen in FIG. 2.5, a guide element is mounted to the end portion 27 of the telescopic arm 26. The guide element comprises a V-shaped outer part and an inner part 115 which has a substantially rectangular or square shape seen in a horizontal cross section. The guide element 30 is used to help guide an interface device 12 (see FIG. 2.9) which is securely mounted to the lift object 86 (see FIG. 2.10) to be lifted. The interface device 12 comprises a guide member 21 which fits into the inner part 115 of the guide element 30. The V-shaped outer part guide element 30 serves to guide the guide member 21 of the interface device 21 towards the inner part 115 during a lifting operation.

The V-shaped outer part and the inner part 115 of the guide element 30 can be provided with a desired number of the damper elements 114 to reduce the effect of impacts from the guide member 21 during a lifting operation. The damper elements 114 are preferably passive and may simply be elements made of rubber or any other suitable material that can absorb shocks from an impact.

The interface device 12 further comprises a connecting member 22 securely attached to a support base 20. The connecting member 22 is designed to mate with a load transfer device 19 which is mounted on the outer end portion 27 of the telescopic arm 26, or alternatively to the first end portion 17 of the beam element 15 if the lift arm 16 is not provided with a telescopic arm 26. The V-shaped guide element 30 is preferably provided with damper elements 23 which help to reduce the effect of the impact when the lift arm engages the interface device 12 and lifts the lift object 86.

When the lifting device 14 is carrying at least a part of the weight of the lift object 86 during a lifting operation, the loads are transferred through the connecting member 22 of the interface device 12 to the load transfer device 19 and further to the lifting device 14 and the lifting vessel 61.

At the second end portion 18 of the lift arm 16 there is provided at least one ballast tank 24 for a fluid, preferably water. The ballast tank is mounted to the lift arm 16 and is provided with an outlet 25 with a hatch that can be controllably opened and closed so that a desired amount of water can be emptied from the ballast tank 24 when that is necessary during a lifting operation. The ballast tank 24 is in fluid communication with a first fluid tank 51 and/or a second fluid tank 53 as will be explained in more detail below.

The lifting device is preferably provided with a control unit 81 which is arranged in the lift arm 16. The control unit 81 receives signals from various sensors and cameras arranged on the lifting device 14 and the lifting vessel 61, and controls various parts of the lifting device 16 and the lifting vessel 61, such as dampers, grippers, pumps, engines, sensors/cameras, flow instruments, in cooperation with the ship operational bridge, before, during and after a lifting operation.

The first attachment unit 33 mentioned above is shown in more detail in FIG. 2.4. The first attachment unit 33 comprises a first attachment frame 43 which is substantially U-shaped. The lift arm 16 is arranged within the U-shaped first attachment frame 43 as indicated in FIG. 2.4.

A first attachment element 121, preferably in the form of a shaft with a longitudinal centre axis, is at each end of the shaft, rotatably or securely mounted to two shaft support elements 113 which are slidably mounted on top of the cradle-like, U-shaped first attachment frame 43. The shaft is preferably mounted substantially vertically above the longitudinal centre axis 72 of the lifting vessel. The slidably mounted shaft support elements 113 are preferably capable of sliding up to about 300 mm in either direction away from centre-position vertically above the centre axis 72. The lift arm 16 is attached to the shaft, which is arranged within a shaft housing 112, either rotatably, if the shaft is securely mounted to the two shaft support elements 113, or securely or possibly rotatably if the shaft is rotatable mounted to the two shaft support elements 113. Thereby the lift arm 16 is rotatably attached to and supported on the first attachment frame 43.

The shaft and the bearings supporting the shaft support elements 113 are all designed to be capable of supporting a portion of the weight of the lifting device 14 including the weight of a lift object 86 during a lifting operation. It should also be noted that the rotational axis of the shaft is preferably located vertically above the centre axis 72 of the lifting vessel 61 as mentioned above.

In order to restrain translational movements of the lift arm 16 and to restrain the rotation of the lift arm 16 to about ±3 degrees about a vertical axis, there is provided at least one, but preferably a plurality of first damper devices 37 as indicated in FIG. 2.4. The first damper devices 37 comprises piston/cylinder assemblies where the pistons are mounted to a damper support 40 on the first attachment frame 43 and the cylinders are mounted to the shaft support assemblies 113 or vice versa. The first damper devices 37 and/or the shaft support assemblies 113 may further be provided with spring devices for damping of the movements of the lift arm 16 relative to the first attachment frame 43. The first damper devices 37 enhances the stiffness of the shaft support assemblies 113 and controls the movement of the lift arm 16 about the vessel's vertical z-axis.

The first attachment unit 33 further comprises at least two set of pinion members 36 where each set is mounted to the first attachment frame 43 on either side of the first attachment frame 43 facing the first support frame 32. There is preferably provided two rack members 35 mounted on the inside of the first support frame 32 on either side of the first support frame 32 relative to the lift arm 16. The pinion members 36 are in engagement with respective rack members 35. The first attachment unit 33 also comprises motors that are capable of driving the pinion members 36 which will cause the first attachment frame 43 and the lift arm 16 to move upwards or downwards within the first support frame 32.

The second support structure 44 comprises at least one first fluid tank 51 and at least one second fluid tank 53, as indicated above, and a second support frame 45. The first fluid tank 51 is attached to the second support frame 45, preferably to the underside of the second support frame 45, but may also be attached to the side of second support frame 45. The at least one first fluid tank 51 is a ballast tank that is mostly or completely located above the surface of the body of water 100. At a lower portion of the first fluid tank 51 there is provided at least one, but preferably a plurality of dump hatches 52. When the dump hatches 52 are opened, fluid, i.e. normally water, will flow out of the fluid tank 51 and into the body of water 100, thereby providing lifting power during a lifting operation due to the reduced total weight of the second support structure 44 as water flows out of the first fluid tank 51. The first fluid tank 51 is, as mentioned, preferably provided with a plurality of dump hatches 52 so that water can be quickly removed from the first fluid tank and thereby quickly provide lifting power during a lifting operation, i.e. the at least one fluid tank 51 may be categorized as a quick dump tank. The dump hatches 52 can be partially or fully opened and each of the dump hatches 52 are preferably controlled independently of the others, whereby a desired rate of flow of fluid out the fluid tank 51 can be achieved and a desired rate of increase in lifting power and thereby lifting speed, is achieved.

The at least one second fluid tank 53 is arranged below the at least one first fluid tank 51 and preferably attached to the underside of the at least one second fluid tank 53. Optionally, the at least one first fluid tank 51 and at least one fluid tank 53 may be separate compartments 51, 53 in a tank structure as indicated in FIG. 2.7 where the first compartment 51.

The at least one second fluid tank 53 is fluidly connected to the at least one first fluid tank 51 so that fluid can be flowed from the at least one second fluid tank 53 to the at least one first fluid tank 51. As indicated in the figures, a fluid pipe 54 fluidly connects the at least one first fluid tank 51 and the at least one second fluid tank 53 and a fluid pump 56 pumps fluid from the second fluid tank 53 to the first fluid tank 51. A fluid inlet 55 is provided at a lower part of the second fluid tank 53 which allows water to flow into the fluid tank 53. The fluid inlet 55 is preferably provided with a hatch that is remotely controlled so that the fluid inlet can be opened and closed as desired.

The second fluid tank 53 and/or the first fluid tank 51 is further fluidly connected to the ballast tank 24 which is attached to the second end portion 18 of the lift arm 16. As indicated in the figures, at least one fluid pipe 57 is fluidly connected to the second fluid tank 53 and/or the first fluid tank 51 at one end of the fluid pipe 57 and the ballast tank 24 at the other end of the fluid pipe 57. A fluid pump 58 is provided for transfer, i.e. pumping, of fluid from the second fluid tank 53 and/or the first fluid tank 51 to the ballast tank 24. The fluid pump 58 may be arranged in the second fluid tank 53, as indicated for example in FIGS. 2.1 and 2.8, or in any other convenient position as long as the fluid pump 58 is capable of pumping fluid from the second and/or first fluid pump 53, 51 to the ballast tank 24.

The second support structure 44 further comprises a second attachment unit 46 that connects the lift arm 16 to the second support frame 45 and allows the lift arm 16 to be moved vertically and to be rotated at least a few degrees in all directions relative to the second support frame 45. The free rotation of the lift arm 16 relative to the second frame structure 45 allows the frame structure 45 and the at least one first fluid tank 51 and the at least one fluid tank 53 to follow the motion of the water in the body of water 100 while the lift arm 16 is kept in a relatively stable position.

The second attachment unit 46 is shown in more detail in FIGS. 2.5 and 2.6, and comprises a second attachment frame 50 which preferably has a rectangular shape, encircling the lift arm 16. The lift arm 16 is supported in the second attachment frame 50 with a second attachment connection 122 as indicated in FIG. 2.6. The second attachment connection 122 is arranged between the lift arm 16 and the second attachment frame 50 such that the lift arm 16 is hanging in the second attachment connection 122 from the upper part of the second attachment frame 50, rotatable relative to the second attachment frame 50. To that end, the second attachment connection 122 shown in FIG. 2.6 comprises a lower support bracket 126 which is securely attached to the top of the lift arm 16, and two upper support brackets 125 which are securely attached to the second attachment frame 50 spaced apart a distance that allows the lower support bracket 126 to fit in between the two upper support brackets 125 as indicated in FIG. 2.6. A second attachment element 123, preferably in the form of a shaft or a bolt as indicated in FIG. 2.6, is mounted in suitable bearings in openings in the lower bracket 126 and upper brackets 125 such that the lift arm 16 can rotate relative to the second attachment frame 50 about the rotational axis of the shaft 123, i.e. its longitudinal centre axis. The rotational axis of the shaft 123 is substantially parallel to the rotational axis of the first attachment element 121. The lift arm 16 is thereby allowed to rotate a few degrees, typically less than 5-10 degrees, relative to the second attachment frame 50.

Alternatively, the second attachment connection 122 may comprise other types of designs than shown in FIG. 2.6 as long as the lift arm 16 is rotatable, at least about a rotational axis parallel to the longitudinal centre axis of the shaft 122 shown in FIG. 2.6, relative to the second attachment frame 50. The second attachment connection may, for example, comprise a ball bearing, which is securely attached on top of the lift arm 16, between the lift arm 16 and the second attachment frame 50 in a similar manner as described above, such that the lift arm is hanging in the second attachment element 123 from the upper part of the second attachment frame 50, or alternatively below the lift arm 16, between the lift arm and the second attachment frame 50, such that the lift arm 16 rests on the second attachment element 123.

The second attachment unit 46 further comprises a plurality of pinion members 49 which are mounted in the second attachment frame 50 on either side facing the second support frame 45. The toothed part of the pinion members 49 are in engagement with rack members 48 which are mounted to the inside of the second support frame 45, on either side of the second support frame 45 relative to the lift arm 16 as indicated in FIGS. 2.5 and 2.6. The second attachment unit 46 also comprises motors that are capable of driving the pinion members which will cause the second attachment frame 50 and the lift arm 16 to move upwards or downwards within the second support frame 45. The motors may be an integral part of the pinion members 49 or mounted in the second attachment frame 50 such that motors are capable of driving the pinion members 49. The motors driving the pinion members can further be disconnected such that the lift arm can move freely up and down within the second support frame 45, for example during a lift arm elevation operation when the lift arm 16 is lifted, i.e. rotated about the rotational axis of the first attachment element 121 of the first attachment unit 33, by altering the buoyancy of the second support structure 44 to provide the desired lifting forces to the lift object 86 and thereby raising or lowering the lift object 86 relative to the surface of the body of water 100.

There is further provided at least one, but preferably two or more lock elements 128 which are movably mounted in the second attachment frame 50. Preferably, an equal number of lock elements 128 are mounted on either side of the second attachment frame 50 and they all comprise a toothed part as indicated in FIG. 2.6.

The lock elements 128 are movably mounted such that they can be moved out of the second attachment frame 50 to engage with the corresponding rack members 48 and thereby locking the second attachment frame 50 for vertical motion relative to the second support frame 45, and such that they can be moved out of engagement with the rack members 48 and partly or completely into the second attachment frame 50 when the lift arm 16 is to be moved up or down relative to the second support frame 45.

The second support structure 44 is attached with a guide structure 101 to the lifting vessel 61 such that the second support structure is movable relative to the lifting vessel 61. In FIG. 2.7 there is shown a preferred way of attaching the second support structure 44 to the lifting vessel 61, while in FIGS. 2.1 and 2.8 an alternative way of attaching the second support structure 44 to the lifting vessel 61 is shown.

As described above, the lift arm 14 is rotatably attached to the first support structure 31 and supported by the first support structure 31 with the first attachment element 121, which is preferably in the form of a shaft, and to the second support structure 44 at a pivot point in the form of the second attachment element 123. Furthermore, the load of the lift object 86 is transferred to the lifting vessel through the load transfer device 19 of the lifting device 14. During a lifting operation, the lifting arm 16 will be rotated about the rotational axis of the first attachment element 121 such that the first end portion 17 of the lift arm and the load transfer device 19 are moved vertically through a curved path which has a circular shape. In such a lifting operation, the lift arm will be rotated from about −2 degrees to about +2 degrees relative to a horizontal plane. The second attachment element 123 is, however, is attached to the second attachment frame 50. The attachment frame 50 moves in a substantially vertical direction due to the rack and pinion system described above, causing little room for horizontal movements of the second attachment element 123.

When the lift arm 16 rotates during a lifting operation, extra loads and dynamic tension is therefore created in the elements making up the connection between the lift arm 16 and the second support structure 44. It would clearly be desirable to reduce such extra loads as much as possible, and the lifting device 14 is therefore designed such that first attachment element 121, the second attachment element 123 and the load transfer device 19, the contact area or point between the transfer device 19 and the interface device 12, lie in the same plane or along the same straight line L as indicated in FIG. 2.2. This will reduce the horizontal movements of the lift arm 16, and hence the second attachment element 123, to a minimum. The impact of horizontal movements of the lift arm 16, caused by the rotational lifting movement of the lift arm 16, will therefore also be reduced to a minimum.

As shown in FIG. 2.7, the guide structure 101 comprises an L-shaped attachment member 103 which is movably connected to deck support rails 110 which are mounted to the deck 62 of the lifting vessel 61, and to the side support rail 109 which is mounted on the side 63 of the hull of the lifting vessel 61 such that the attachment member 103 can be moved in the longitudinal direction of the lifting vessel 61. The attachment member 103 may be slidingly connected to the side support rail 109 and/or the deck support rails 110, or may be provided with roller elements (not shown in the figure) such that the attachment member 103 is capable of rolling along the side support rail 109 and/or the deck support rails 110. A combination of the two is possible, for example the attachment member 103 may be slidingly connected to the side support rail 109 and provided with roller elements rolling on the deck support rails 110.

At least one first guiding member 104 is securely attached to the attachment member 103 at one end of the attachment member. In the opposite end, the first guiding member 104 is connected to at least one connecting member 107. The at least one connecting member 107 is further movably mounted to or in a second guiding member 105 on the second support structure 44, preferably to the first fluid tank and/or the second fluid tank 53 as indicated in FIG. 2.7. The second guiding member 105 extends in a substantially vertical direction such that the second support structure 44 is guided in a substantially vertical movement relative to the guide structure 101 and the lifting vessel 61 when water movements in the body of water 100 cause relative movements between the second support structure 44 and the lifting vessel 61.

The second guiding member 105 is preferably a slit design, i.e. the second guiding member 105 comprises an element with a cavity. The second guiding member 105 may be mounted to the first fluid tank 51 and/or the second fluid tank 53 or may be formed as an integral part of the first fluid tank 51 and/or the second fluid tank 53.

The slit shaped cavity may be of any desired shape that provides sufficient guiding of the second support structure 44. For example, a slit-shaped element may be mounted to the first fluid tank 51 and/or the second fluid tank 53 at the frontside and at the backside of the first fluid tank 51 and/or the second fluid tank 53 in the longitudinal direction of the vessel such that the slits of both elements extend in a substantially vertical direction. The slits may be provided with a substantially rectangularly shape. The connecting member 107 has a shape that correspond to the shape of the second guide member 105, i.e. if the second guiding member 105 is a rectangularly shaped slit, the connecting member 107 will comprise a corresponding protruding element that fits in the rectangularly shaped slit such that the protruding element is capable of moving vertically in the slit. The second support structure 44 is thereby connected to the lifting vessel 61 and guided in a substantially vertical motion relative to the lifting vessel when wave motions in the body of water 100 causes relative motion between the second support structure 44 and the lifting vessel 61. In some instances, the size of the protruding element of the at least one connecting member 107 may be chosen to be a little smaller than the size of the slit of the guiding member 105 so that there is a little slack.

The slit-shaped cavity may also be T-shaped or have any other suitable shape. The connecting member 107 will then be provided with a protruding element that has a shape that corresponds to the T-shape slit of the second guide member 105.

It should also be noted that the general “slackness” in the bearing system of the connecting members 107 allows the second support structure 44 to vertically move in or out—pivoting around the connecting members 107 and the second attachment element 123—and thus taking the movement, typically ±300 mm, that the main bearing with the first damper devices 37 allows for.

With the attachment member 103 being capable of moving in the longitudinal direction of the lifting vessel 61 and with the corresponding first guiding member 104, which is attached to the attachment member 103, being slidingly connected to the second guiding member 105 in a substantially vertical direction, the second support structure 44 is movably attached to the lifting vessel 61 in the longitudinal direction of the lifting vessel and in a substantially vertical direction.

The lifting device is further provided with a damper device 67 which comprises a cylinder 68 and a piston 70. As indicated in FIG. 2.7, the piston can be connected to the attachment member 103 while the cylinder 68 is attached to the second support structure 44 as indicated in FIG. 2.7. Furthermore, as indicated in FIG. 2.7, the cylinder is rotatably connected to the second support structure 44, for example with a universal joint 118, and the piston is rotatably connected to the attachment member 103, for example with a universal joint 119. The damper device 67 preferably further includes a spring device (not shown in the figure) creating stiffness enhancement. The damper device 67 provides damping of the motions of the second support structure 44 relative to the lifting vessel 61, and in some instances may be used to lift the second support structure 44 and the lift arm 16 if that is desired or needed.

In FIGS. 2.1 and 2.8 there is shown an alternative system for guiding the vertical movements of the first fluid tank 51 and the second fluid tank 53 wherein at least one, but preferably a plurality of first guide rails are mounted to the side 63 of the hull of the lifting vessel 61 and at least one, but preferably a plurality of second guide rails 59 are mounted on the first fluid tank 51 and/or the second fluid tank 53. Between the first guide rails 65 and the second guide rails 59, which are mounted to the vessel 65 and the second support structure 44 respectively, there is provided bearings 66 which are connected to the first guide rails 65 and the second guide rails 59 such that the first fluid tank 51 and the second fluid tank 53 can move slidably at least up and down relative to the lifting vessel 61.

A damper device 67 is shown comprising a piston 70 and cylinder 68 assembly. The piston 70 is mounted to the second guide rail, for example with a universal joint 71, and the cylinder is mounted, preferably slidably, to the deck 62 of the lifting vessel 61, for example with a universal joint 69. It should be noted that although two different damper devices 67 have been shown in the figures, the damper device 67 may be given many different designs and be of other types than shown in the figures.

In FIG. 2.8 the lifting device 14 is further provided with hoisting equipment which can be mounted on the lifting device 14 as shown in FIG. 2.1. The hoisting equipment can later be removed when this equipment is not needed. The hoisting equipment comprises a winch 74 which is driven by a winch motor 75. The winch motor 75 may be a separate unit as indicated in FIG. 2.8, or may alternatively be part of the winch itself. The winch 74 is detachably mounted on the lift arm 16.

The hoisting equipment further comprises a pulley 78 and a support unit 79 detachably attached to the outer end portion 27 of the telescopic arm 26. If the case that the lift arm 16 does not include a telescopic arm 26, the support unit 79 including the support unit 79 with the pulley 78, may be detachably attached to the first end portion 17 of the lift arm 16. As can be seen in FIG. 2.8, a winch line 76 made of a suitable material, such as steel or a synthetic material, extends from the winch 74, over the pulley 78 and down to a hoisting element 77 which is attached to the end of the winch line 76. The hoisting element 77 may comprise a hook element as indicated in FIG. 2.8, or any other element which is suitable for connecting the hoisting element to a lift object 86 to be lifted.

As mentioned, the hoisting equipment, comprising the winch 74, the winch motor 75, the pulley 78 and the support unit 79 for the pulley and the winch line 76 with the hoisting element 77, is detachably attached to the lifting device 14, preferably on the lift arm 16, whereby the hoisting equipment can be attached to the lifting device 14 when there is need for the hoisting equipment, and later be removed when there is no more need for the hoisting equipment.

In FIG. 2.10 there is shown a lifting system 10 with a possible configuration of vessels during a lifting operation. There are two lifting vessels 83, 84 which are positioned on either side of a lift object 86, for example the top side of an offshore platform for drilling or production of hydrocarbons. Each lifting vessel 83, 84 is provided with a plurality of lifting devices 14 as described above. In FIG. 2.10 it is shown that the load transfer devices 19 are in engagement with interface device 12 which is mounted on the lift object 86. A third transport vessel 85 is positioned near the lifting vessel so that the transport vessel 85 can be maneuvered in under the lift object 86 when the lifting vessels 83, 84 has lifted the lift object 86 whereafter the lift object can be lowered down onto the deck of the transport vessel 85.

The lifting vessels 83, 84 and the transport vessel 85 are provided with bridge control systems 92, 93, 94 respectively and communication devices 87, 88, 89 respectively. The lift object is also provided with a communication device 90. During the whole operation, the bridge control system of one of the vessels, for example the lifting vessel 83, is allocated as a master control system making the lifting vessel 83 the master vessel controlling the other vessels 84, 85 which will act as slave vessels. All communication therefore takes place between the master vessel 83 and the slave vessels 84, 85 and the lift object 86. It can also be mentioned that preferably all the lifting vessels 83, 84 are provided with a bridge control system 87, 88 that are capable of being allocated as the master control system. It would also be possible to provide the transport vessel 85 with a bridge control system 94 that could be allocated as the master control system.

It should be understood that it is obviously possible to use more or fewer lifting vessels during a lifting operation than the two lifting vessel shown in FIG. 2.17, for example one, three, four, five, six, seven, eight, nine, ten lifting vessels etc., depending on different parameters such as the weight of the lift object, size of the lift object, position and depth of the lift object, and complexity of the operation. Thus, the present invention is not restricted to and does not necessary use two vessels only to perform a lifting operation. For example during:
a) subsea lifting, i.e. lifting up or lowering of tubular elements such as long cables, pipelines or hoses, one or more vessels may be arranged side-by-side such that the one or more vessels are able to handle for example spools comprising a tubular element of e.g. 350 meters length,
b) one may install parts of a quay plant from the vessels, which parts thus being elements in the quay plant on land if the water depth allows access,
c) removal of short or long gangways offshore (from offshore installations such as windmills, floating platforms etc).

### Third Embodiment

FIG. 3.1 schematically illustrates an aspect of the invention, where a lifting device 1 is mounted on a floating unit 2. The lifting device 1 comprises a pivotally mounted arm 6 with a lifting end 4 and a ballasted end 5 arranged on opposite sides of a pivoting point 7. The arm 6 is mounted in a support tower 22, which is advantageously located in the centre of the floating unit's 2 deck, preferably such that the arm's 6 axis of rotation is located in the vertical plane through the floating unit's 2 longitudinal centre line. The support tower is mounted on rails 34, or similar devices allowing the lifting device to be moved along the longitudinal length of the floating unit. The weight of the load 3 and lifting device 1 will thereby be directed down in the centre of the floating unit 2, giving advantageous effects with respect to rolling motions of the floating unit 2.

The lifting device 1 further comprises a buoyancy container 9 arranged vertically below a Dump container 8, the containers 8,9 are rigidly connected to a lifting tower 23 which is hingedly connected to the lifting end 4 of the arm 6. The buoyancy container 9 and Dump 8 container are in fluid communication. On the ballast end 5 of the arm 6 a ballast container 14 is arranged, the ballast container 14 being in fluid communication with the buoyancy container 9.

Along the ships side of the containers a rail 24, or similar device allowing vertical movement, is mounted with a corresponding rail device 24 on the floating unit 2, such that the containers 8,9 and tower 23 can move vertically relative to the floating unit's hull as the containers 8,9 are ballasted or deballasted. A damper device 33 is also provided, for example comprising a cylinder and piston as illustrated, and can further include a spring device (not shown in the figure) creating stiffness enhancement. The damper device 33 provides damping of the motions of the containers 8,9 and tower 23 relative to the floating unit 2, and in some instances may be used to lift the containers 8,9 and tower 23 if that is desired or needed. The damper device 33 and rail device 24 are arranged so that they may be moved with the lifting device in the longitudinal direction of the floating unit.

Though not illustrated herein, there are typically more than one lifting devices 1 mounted on one floating unit 2, with two floating units 2 working in pair to lift a load 3. In one aspect a lifting operation can comprise lifting a load 3 from a transport vessel for installation at a predefined location or structure. In another aspect a lifting operation can comprise lifting a load 3 from a structure and placing it onto a transport vessel.

In another aspect of the invention, the lifting device may be employed in a hoisting mode as illustrated by the components in dotted lines in FIG. 3.1. The lifting device 1 is then outfitted with hoisting equipment, a sheave module 29 is placed on the lifting end 4 of the pivoting arm 6, with a winching mechanism 30 placed in a distance away from the sheave module on the arm. At the end of the wire, a hook 28 or similar load engaging part is fitted to lift the load 3. The hoisting mode is especially suited for installation of structures on a sea bottom, but may also be used for other installation or decommissioning projects.

The buoyancy container 9 is partially submerged, with the result that it provides a buoyant force. The buoyancy container 9 has an internal volume for receiving a first amount of water 16, and is accordingly provided with a closable inlet 10. The inlet 10 may comprise a sea chest, or similar water intake known in the art which filters out unwanted particles and can be selectively opened and closed. The inlet is advantageously arranged near the bottom of the buoyancy container 9, to avoid problems related to clogging due to materials lying in the water surface.

The inlet 10 leads to a pump room 32 arranged in the bottom of the buoyancy container 9, the pump room 32 being further connected to a first 11, second 12 and third transfer system 31, schematically illustrated in FIG. 3.1. The first transfer system 11 is arranged to lead water from the pump room 32 to the dump container 8. The second transfer system 12 is arranged to lead water from the pump room 32 to the ballast container 14. The third transfer system 31 is arranged to lead water between the pump room 32 and the buoyancy container 9, so that water may be transferred from the buoyancy container 9 to the dump container 8 or back through the inlet 10 to the outside environment.

The pump room 32 is arranged with valves, pumps and other fluid transferring means necessary to distribute water to the different containers or back to the environment, all of which will be evident to the skilled person based on the disclosure of the invention herein. The pump room 32 is furthermore arranged with sensors 26 for measuring the flow and pressure of water. The fluid transferring and sensor means being signally connected to a control system 25, which is located on the floating unit 2 and controls and monitors all ballasting operations.

These different transfer systems allow water to be simultaneously transferred between the pump room 32 and the buoyancy container 9, dump container 8 and ballast container 14 or back outside through the inlet 10, allowing for faster and more controlled ballasting operations. Each of the transfer systems also comprise downstream transfer 27 and sensor means 26 also signally connected to the control system 25, these transferring and sensor means are illustrated in FIG. 3.1, but their locations will vary depending on the layout of the specific transfer system.

The opening system of the inlet 10 is fully redundant as the consequences of the inlet 10 taking in an undesirable amount of water or opening at an undesired time could be severe. Likewise, the fluid transferring equipment in the pump room 32 and on the respective transferring systems is redundant, ensuring the ballasting operations have high reliability.

The dump container 8 has an internal volume for receiving a second 17 and fourth 19 amount of water, and comprises an openable outlet 13, advantageously located near the bottom of the container 8, for releasing water to the outside environment. In an advantageous aspect of the invention, the bottom of the Dump container 8 is arranged to always be located above the outside sea surface, such that the release of water to the environment is accomplished by gravity. The outlet 13 may comprise a sliding hatch, or similar openable device. Advantageously the size of the outlet 13 relative to the dump container 8 is such that the container 8 is emptied in around 5 seconds, though this will also depend on the amount of water in the container and may take up to 15 seconds.

The ballast container 14 has an internal volume for receiving a fifth amount 20 of water, and comprises an openable outlet 15 advantageously located near the bottom of the container 14, for releasing water to the outside environment.

Before a lifting operation commences a floating unit 2 is deployed in a location near the load 3 to be lifted. Preferably two floating units 2 will be deployed on each side of the load 3, to cooperatively lift the load 3. In the case of several floating units 2 and lifting devices 1, the lifting operation described herein will be undertaken synchronously and in a coordinated manner. FIG. 3.2 schematically illustrates one floating unit 2 with a lifting device 1 in a pre-operational position. In one aspect of the invention the buoyancy 9, dump 8 and ballast 14 containers are empty in the pre-operational position, as they will also preferably be empty during transit of the floating unit to a lifting site. In another aspect of the invention the containers 8,9,14 are already ballasted to a predefined extent or filled with relatively minor amounts of water.

However, it shall be understood that it is possible to use more or less vessels than 2, for example 1, 3, 4, 5, 6, 7, 8, 9, 10 vessels etc., dependent on different parameters such as the weight of the load, size of the load, position and depth of the load, and complexity of the operation. Thus, it is not necessary using two vessels to perform a lifting operation. For example during:
a) subsea lifting, i.e. lifting up or lowering of tubular elements such as long cables, pipelines or hoses, one or more vessels may be arranged side-by-side such that the one or more vessels are able to handle for example spools of e.g. 350 meters length,
b) one may install parts of a quay plant from the vessels, which parts thus being elements in the quay plant on land if the water depth allows access,
c) removal of short or long gangways offshore (from offshore installations such as windmills, floating platforms etc).

Indicated by arrows in FIG. 3.3, the lifting operation commences by the inlet 10 of the buoyancy container 9 opening and letting in a first amount of water 16 which is transferred to the buoyancy container 9 via the pump room. This causes the buoyant force from the buoyancy container 9 to dump thereby lowering the lifting tower and the lifting end 4 of the pivotally mounted arm 6 by a desired degree θ.

FIG. 3.4 illustrates the next step of the operation, where the load 3 is also shown. Once the buoyancy container 9 has been filled with the first amount of water 16, the first transfer system transfers a second amount of water 17 from the buoyancy container 9 to the dump container 8 via the pump room and third transfer system, indicated by arrows running along the transfer systems. This does not significantly change the angle of the pivoting arm 6, as it redistributes the ballast water in height. When the dump container 8 has been filled with the second amount of water 17, the floating unit 2 is moved in towards the load 3 to a pre-lift position adjacent to the load 3. FIG. 3.4 shows an aspect of the invention where pre-lift position comprises using the pivoting arm to lift the load by engaging the lifting end of the arm with lifting points on a downward facing surface on the load. In a hoisting mode pre-lift position, the pivoting arm 6 may also be tilted down, but the lifting end 4 and sheave module 29 remains at a distance above the load 3 so that the hook 28 is engaged with a lifting point on the load 3 before the next step in the operation.

When the lifting end 4 of the arm 6 has been moved to a pre-lift position, a third amount of water 18 is released through the outlet 13 of the dump container 8, as indicated by the arrows in FIG. 3.5. The lifting end of the arm is thereby brought up into contact with the lifting point on the load, or in a hoisting mode the wire is tightened. The lifting device 1 is now in a lift-off position, where it exerts a force on the load due to the buoyant force from the buoyancy container 9. However, it is not desirable that the load 3 is lifted in this phase, the lifting devices 1 in cooperation may take up around 5-10% of the load's 3 weight, or another suitable amount such that the lifting end of the arms are in firm engagement with lifting points on the load.

Once the lifting end 4 of the arm 5 is in firm contact with the load 3, the second transfer system 11 commences transferring a fourth amount of water 20 from the buoyancy container 9 to the ballast container 14 and simultaneously the first transfer system 11 transfers a fifth amount of water 20 to the dump container 8, both via the third transfer system and pump room. Again, it is not desirable that the load 3 is lifted in this phase, the lifting devices 1 in cooperation may take up around 80-90% of the load's weight 3, or another suitable amount such that the final release of water from the Dump tanks 8 will lift the load to a desired height.

Finally the lifting devices are brought to a lifting position by releasing a sixth amount of water 21 from the dump container 8 through the outlet 10, giving enough buoyant force to lift the arm 6 to a predefined degree ϕ and correspondingly the load 3 to a desired height.

The floating units then cooperatively transport the load 3 to a desired set down position, e.g. a transport vessel or bottom structure. The set-down operation is accomplished by emptying the ballast container 14 through the outlet 15, as is known in the prior art.

It is now apparent that the lifting operation is achieved by ballasting and de-ballasting predefined amounts of water between the environment and the containers on the lifting device, respectively first 16, second 17, third 18, fourth 19, fifth 20 and sixth 21 amounts. The size of the containers 8,9,14 are therefore advantageously large enough to hold these amounts. The amounts of water that are described herein, will vary depending on the overall size of the lifting devices 1, and the size, weight, centre of gravity and shape of the load 3 to be lifted, and will be calculated and reconfigured as the lifting operation is ongoing. According to situations that may arise during a lifting operation, water may also be pumped from the buoyancy container back out to the sea, or water may be pumped directly from the sea to the dump and/or ballast container.

In one aspect of the invention, the pivoting arm 6 can pivot 8 degrees down and 8 degrees up from a horizontal position, during a lifting operation as shown in FIGS. 3.3 and 7. As an example the pivoting arm 6 is tilted 2 degrees down when in a pre-lift position, and 2 degrees up when in a lifting position.

The third amount 18 to be released from the dump container 8 is required to be large enough so that the resulting buoyant force from the buoyancy container 9 will bring the lifting end 4 of the arm 6 into firm contact with a lifting point on the load 3.

The sixth amount 21 to be released from the dump container 8 is required to be large enough so that the resulting buoyant force will tilt the lifting end 4 of the pivoting arm to the degree ϕ and lift the load 3 to a predefined height. This predefined height is defined by environmental conditions, the set-down location and elevation of the set-down above sea level.

### Fourth Embodiment

FIG. 4.1 shows an overview of a lifting device 1 in accordance with the present invention in a first mode of lifting and lowering operations mounted on the deck 2 of a vessel. The first mode is exemplified as a fork lift mode. The vessel floats in sea 4 or water, and extends above the sea level 3. The lifting device 1 comprises a lifting arm having a main lift arm 5 and a telescopic arm 6, wherein the telescopic arm 6 is telescopically arranged inside the main lift arm 5. The telescopic arm 6 and the main lift arm 5 may be operated by a rack and pinion assembly 35, or similar, for extending the telescopic arm 6 relative the main lift arm 5. The rack and pinion assembly 35 may comprise a damping device 36 for limiting or reducing horizontal impacts. The drive system may, as an alternative to the rack and pinion assembly, comprise mechanical, pneumatic or hydraulic means providing energy transfer and extrusion locking.

The lifting device 1 comprises a main lift structure or tower 8 having a rack and pinion rail system 30 and elevation system 31 acting as an elevation system for raising or lowering the lifting arm (i.e. connected to the main lifting arm 5). Similarly, the lifting device 1 further comprises a buoyancy lift structure or tower 9 with a rack and pinion rail system 29 and elevation system 28 for raising and lowering quick dump container 14 and buoyancy container 13 as one unit. The elevation systems 28, 31 may, as alternative to rack and pinion, be mechanical, pneumatic or hydraulic and may have locking means for securing the lifting arm or buoyancy container in position. The telescopic arm 6 has a load-engaging part 7 at its free end. The load-engaging part 7 further comprises a guiding part comprising guiding means for guiding and aligning the lifting device 1 into lifting position by cooperation with a guide member 51 on the load. The load-engaging part 7 further comprises a lifting part adapted to support a load, the lifting part comprising a lifting interface 10 having a recess for cooperation with a corresponding load interface 50 on the load (see details in FIGS. 4.4A-4.4C). The features of the load-engaging part 7 will be described in greater detail below with reference to FIG. 4.3A.

The quick dump container 14 may be arranged above the buoyancy container 13. At the other end of the lifting arm relative the quick dump container 14 and the buoyancy container 13, a ballast container 15 is arranged. Fluid may flow between these different containers 13, 14, 15 via a transfer system 18, 19, 26. The ballast container 15 has opening 27 for outlet of fluid, and quick dump container 14 has hatches 16 for quick dump of fluid. The buoyancy container 13 has inlet/outlet for fluid 17. Pumps 34 is provided for pumping medium between the different containers 13, 14, 15.

The lifting device 1 is operated by the transfer of water between the buoyancy container 13 and the quick dump container 14 connected to one end of the lifting arm and the ballast container 15 connected to the opposite end of the lifting arm, the ballasting principle behind the lever arm is known from U.S. Pat. No. 6,668,747 B2. However, as illustrated in FIG. 4.1, the buoyancy container 13 and the quick dump container 14 are arranged substantially vertically adjacent to each other connected to the load engaging part 7 of the lifting device. The quick dump container 14 can be rapidly emptied of water, thereby also rapidly increasing the buoyancy force acting on the load engaging part 7 of the lifting arm which provides the lifting force to the load. This reduces or eliminates the need for use of pressurized gas to rapidly transfer water to the ballasted end of the arm.

The main lift structure 8 comprises a base structure 33. The base structure 33 may have motorized rollers for movement on longitudinal rails 32 on the vessel deck 2.

FIG. 4.2 shows details of a second mode for lifting and lowering operations of the lifting device 1, exemplified as a hoisting mode, according to the present invention. The second mode comprises a detachable lifting element 44 mountable on the load-engaging part 7 of the telescopic arm 6 and is used when performing hoisting operation using e.g. a hook 43 mounted in an end of longitudinal flexible transferring element 42 (such as wire, chain or fiber rope) from the same lifting device 1 as in the first mode. This flexibility solves drawbacks of prior art where the ship and vessel has to return to dock to change the lifting mode. The hoisting mode, i.e. the second mode, may comprise a detachable hoisting arm tip JIB 44 for hoisting mode. The arm tip JIB 44, or any other suitable detachable lifting element, may be secured to the load engaging part 7 of the lifting arm by use of mechanical, pneumatic, hydraulic, magnetically system, or a combination thereof, and may be installed and removed from the load-engaging part using small a small crane or other suitable means on the vessel. The arm tip JIB 44 may comprise a sheave 46. The hoisting mode may comprise operating a wire, chain or fiber rope 42 connected to a hoisting element 40, such as a winch drum mounted on the opposite end of the lifting arm relative the load engaging part 7, and with a hook 43 or other type of lifting link in the other end of the wire, chain or fiber rope 42. The hoisting element 40 may be arranged in other positions on the lifting arm, and is connected to a power supply 41. A shark jaw (not shown) may be provided for locking and securing the wire, chain or fiber rope 42 during lifting or lowering operations.

The lifting device 1 may thus be operable between the first mode and the second mode by mounting or demounting the detachable lifting element 44.

FIG. 4.3A shows the guiding part 54 to be used in the first mode, i.e. the fork lift mode, comprising a coarse adjustment part 56 (outer end of the guiding part) terminating in a fine adjustment part 57 (inner end of the guiding part). The guiding part 54 is disclosed as a V-shaped fork, however the guiding part may have other suitable forms or shapes providing proper guiding. The guiding part 54 may have internal damping devices 58 for example by rubber fenders. These internal damping devices 58 serves to limit transversal shocks or impact due to translational movement between the load and the lifting arm and to prevent metal to metal impacts. The internal damping device 58 can be an elastomer damper system to avoid mechanical shocks during mating with the load. The guiding part 54 may comprise position securing devices 55 made by hydraulically or mechanically operated arms, claws or other elements which secures the load inside the guiding part 54.

The guiding part may further comprise at least one substantially vertical damping device 38 for damping shocks or impacts. The vertical damping device 38 may be elastomer or a hydraulic N2 Gas cylinder or similar.

FIGS. 4.4A-4.4C shows details of different load interfaces 50 for cooperation with the lifting interface 10 on the load-engaging part 7 of the lifting arm. The load interfaces 50 are detachable and can be mounted on the load which is to be lifted.

The upper figures are side views of the load interface and the lower figures are views from below

More specific, in FIG. 4.4A the load interface 50 has a guide member 51 in the form of a quadratic cylinder and protruding member 52 for cooperation with a recess or similar on the lifting interface 10, the protruding member 52 having a circular or ball shape.

In FIG. 4.4B the load interface 50 has a guide member 51 in the form of a circular cylinder and protruding member 52 for cooperation with a recess or similar on the lifting interface 10, the protruding member 52 having a triangular or conical shape.

In FIG. 4.4C the load interface 50 has a guide member 51 in the form of a triangular cylinder and protruding member 52 for cooperation with a recess or similar on the lifting interface 10, the protruding member 52 having an elliptic shape.

It is clear that all shapes discloses in FIGS. 4.4A-4.4C shall be considered as examples, and that other shapes rendering possible rotational movement between the lifting interface 10 and load interface 50 is possible.

FIG. 4.5 shows details of the buoyancy lift structure or tower 9. The buoyancy lift structure 9 is attached with a guide structure 101 to the vessel such that the buoyancy lift structure is movable relative to the vessel. In FIG. 4.5 there is shown a preferred way of attaching the buoyancy lift structure to the vessel, while in FIGS. 1 and 7 an alternative way of attaching the buoyancy lift structure 9 to the vessel is shown.

As shown in FIG. 4.5, the guide structure 101 comprises an L-shaped attachment member 103 which is movably connected to deck support rails 110 which are mounted to the deck 2 of the vessel, and to the side support rail 109 which is mounted on the side 63 of the hull of the vessel such that the attachment member 103 can be moved in the longitudinal direction of the vessel. The attachment member 103 may be slidingly connected to the side support rail 109 and/or the deck support rails 110, or may be provided with roller elements (not shown in the figure) such that the attachment member 103 is capable of rolling along the side support rail 109 and/or the deck support rails 110. A combination of the two is possible, for example the attachment member 103 may be slidingly connected to the side support rail 109 and provided with roller elements rolling on the deck support rails 110.

At least one first guiding member 104 is securely attached to the attachment member 103 at one end of the attachment member. In the opposite end, the first guiding member 104 is connected to at least one connecting member 107. The at least one connecting member 107 is further movably mounted to a second guiding member 105 on the buoyancy lift structure 9, preferably to the quick dump container 14 and/or buoyancy container 13 as indicated in FIG. 4.5. The second guiding member 105 extends in a substantially vertical direction such that the buoyancy lift structure 9 is guided in a relatively vertical movement relative to the guide structure 101 and the vessel when water movements in the body of water 100 cause relative movements between the buoyancy lift structure 9 and the vessel.

The second guiding member 105 is preferably a slit design, i.e. the second guiding member 105 comprises an element with a longitudinal cavity. The second guiding member 105 may be mounted to the quick dump container 14 and/or the buoyancy container 13 or may be formed as an integral part of the quick dump container 14 and/or the buoyancy container 13. The cavity may be of any desired shape that provides sufficient guiding of the buoyancy lift structure 9. For example, a slit-shaped element may be mounted to the quick dump container 14 and/or the buoyancy container 13 at the frontside and at the backside of the quick dump container 14 and/or the buoyancy container 13 as seen in the longitudinal direction of the vessel such that the slits of both elements extend in a substantially vertical direction. The slits may be provided with a substantially rectangularly shape. The connecting member 107 has a shape that correspond to the shape of the second guiding member 105, i.e. if the second guiding member 105 is a rectangularly shaped slit, the connecting member 107 will comprise a corresponding protruding element that fits in the rectangularly shaped slit such that the protruding element is capable of moving vertically in the slit. The buoyancy lift structure 9 is thereby connected to the vessel and guided in a substantially vertical motion relative to the vessel when wave motions in the body of water 100 causes relative motion between the buoyancy lift structure 9 and the vessel. In some instances, the size of the protruding element of the at least one connecting member 107 may be chosen to be a little smaller than the size of the slit of the guiding member 105 so that there is a little slack.

The slit-shaped cavity may also be T-shaped or have any other suitable shape. The connecting member 107 will then be provided with a protruding element that has a shape that corresponds to the T-shaped slit of the second guiding member 105. With the attachment member 103 being capable of moving in the longitudinal direction of the vessel and with the corresponding first guiding member 104, which is attached to the attachment member 103, being slidingly connected to the second guiding member 105 in a substantially vertical direction, the buoyancy lift structure 9 is movably attached to the vessel in the longitudinal direction of the vessel and in a substantially vertical direction.

The lifting device is further provided with a damper device 67 which comprises a cylinder 68 and a piston 70. As indicated on FIG. 4.5, the piston can be connected to the attachment member 103 while the cylinder 68 is attached to the buoyancy lift structure 9. Furthermore, as indicated in FIG. 4.5, the cylinder is rotatably connected to the buoyancy lift structure 9, for example with a universal joint 118, and the piston is rotatably connected to the attachment member 103, for example with a universal joint 119. The damper device 67 preferably further includes a spring device (not shown in the figure) creating stiffness enhancement. The damper device 67 provides damping of the motions of the buoyancy lift structure 9 relative to the vessel, additional stiffness from the vessel into the lift arm structure and in some instances may be used to lift the buoyancy lift structure 9 and the main lift arm 6 if that is desired or needed.

Thus, at least one of the objectives of the invention is achieved by invention as described in the drawings, i.e. a lifting device with improved characteristics compared to prior art solutions.

### Fifth Embodiment

Referring to FIGS. 5.1-5.13, a lifting device 14 is shown arranged on a lifting vessel 61 in a body of water 100. The lifting vessel comprises a deck 62 and a hull side 63 which is facing the lift object 86 (see FIG. 5.17) during a lifting operation.

In FIG. 5.4 there is shown a perspective view of the lifting device 14. The lifting device 14 comprises a lift arm 16 which is supported by a first support structure 31 and a second support structure 44. The first support structure 31 and the lift arm 16 are provided with a first elevation device 34 while the second support structure 44 and the lift arm 14 are provided with a second elevation device 47 where the first elevation device 34 and the second elevation device 47 are used to move the lift arm 16 vertically relative to the first support structure 31 and the second support structure 44. The first elevation device 34 preferably comprises a rack and pinion system as will be further explained below, but any other type of elevation device may be used as long as it is suitable for moving the lift arm 16 vertically. The second elevation device 34 preferably also comprises a rack and pinion system as will be further explained below, but any other type of elevation device may be used as long as it is suitable for moving the lift arm 16 vertically.

The first support structure 31 is supported on the deck 62 of the lifting vessel 61 while the second support structure 44 comprises a fluid tank assembly 134 which, as shown in FIGS. 5.1 and 5.14 includes at least a first fluid tank 51 and a second tank 53 of which at least one is arranged in the body of water 100, next to the hull side 63 of the lifting vessel 61. The fluid tank assembly 134 may be formed as a fluid tank with separate compartments forming the at least one fluid tank 51 and the at least one fluid tank The fluid tanks 51, 53 are buoyancy/ballast tanks which provide sufficient buoyancy to support the second support structure 44 and the lift arm 16 and to provide sufficient lifting power to lift the lift object 86 during a lifting operation. The fluid used for ballasting the fluid tanks 51, 53 is preferably water and the amount of fluid contained in each fluid tank 51, 53 can be independently varied as will be explained in further detail below.

The first support structure 31 comprises a first support frame 32 mounted on a base structure 41. The base structure 41 comprises a plurality of roller devices mounted in or to the underside of the base structure 41. Each roller device is provided with at least one roller element 42 which are capable of resting on a support rail 64 on the deck of the lifting vessel 61 and rolling along the support rails 64.

The roller elements 42 of the roller devices may be arranged in a fixed position where the roller elements 42 rest on their respective support rails 64 on the deck of the lifting vessel 61 such that the first support structure 31 can be moved on the rails 64 in a longitudinal direction of the lifting vessel 61. Alternatively, the roller elements 42 may be arranged movable between a lower position and an upper position by a suitable motor, typically an electric motor. When a roller elements are in their lower positions, the roller elements rest on their respective support rails 64 on the deck of the lifting vessel 61 and the first support structure 31 can be moved on the rails 64 in a longitudinal direction of the lifting vessel 61. When a roller element is in its upper position, the base structure 41 rests on the support rails 64 and the first support structure 31 is incapable of being moved.

To effect the movement of the first support structure 31 along the rails 64, a conventional gripper jack system may be used. Alternatively, the roller devices and/or the base structure 41 may be provided with a motor, typically an electric motor, for rotation of the roller elements in the desired direction. The base structure 41 and the support rails 64 and/or the deck 62 may further be provided with a locking device or one or more cooperating locking devices (not shown on the figures) to secure the first support structure 31 in its position on the support rails 64 when the lifting device 14 is located in its desired position in the longitudinal direction of the lifting vessel 61.

The number of roller devices that a support structure 31 is provided with will be determined in part by the weight of the lifting device 14 and to a larger extent by the desired lifting power of the lifting vessel 61 and the number of lifting devices 14 that the lifting vessel is provided with to which the weight of the lift object 86 is distributed, and by the weight each roller element and/or the support rails 64 are capable of supporting without getting damaged.

The first support structure 31 further comprises a first attachment unit 33 that connects the lift arm 16 to the first support frame 32 and allows the lift arm 16 to be moved vertically and to be rotated about a substantially horizontal axis relative to the support frame 32 as will be explained in more detail below.

The lift arm 16 comprises beam element 15 which is mounted to and supported by the first support structure 31 and the second support structure 44. The beam element has a first end portion 17 and a second end portion 18. The lift arm 16 preferably, but not necessarily, further comprises a telescopic arm 26 which is telescopically arranged in the in the beam element 15. A rack and pinion system including a rack member 28 mounted to the inside of the beam element 15 and a pinion member (not shown in the figures) mounted to the telescopic arm such that the pinion member engages the rack member 28, can be used to move the telescopic arm 26 in and out of the beam element 15.

The telescopic arm 26 has an outer end portion 27 which is located outside the beam element 15. As can be more clearly seen in FIG. 5.7, a guide element is mounted to the end portion 27 of the telescopic arm 26. The guide element comprises a V-shaped outer part and an inner part 115 which has a substantially rectangular or square shape seen in a horizontal cross section. The guide element 30 is used to help guide an interface device 12 (see FIGS. 5.15 and 5.16) which is securely mounted to the lift object 86 (see FIG. 5.17) to be lifted. The interface device 12 comprises a guide member 21 which fits into the inner part 115 of the guide element 30. The V-shaped outer part guide element 30 serves to guide the guide member 21 of the interface device 21 towards the inner part 115 during a lifting operation.

The V-shaped outer part and the inner part 115 of the guide element 30 can be provided with a desired number of the damper elements 114 to reduce the effect of impacts from the guide member 21 during a lifting operation. The damper elements 114 are preferably passive and may simply be elements made of rubber or any other suitable material that can absorb shocks from an impact.

The interface device 12 further comprises a connecting member 22 securely attached to a support base 20. The connecting member 22 is designed to mate with a load transfer device 19 which is mounted on the outer end portion 27 of the telescopic arm 26, or alternatively to the first end portion 17 of the beam element 15 if the lift arm 16 is not provided with a telescopic arm 26. The V-shaped guide element 30 is preferably provided with damper elements 23 which help to reduce the effect of the impact when the lift arm engages the interface device 12 and lifts the lift object 86.

When the lifting device 14 is carrying at least a part of the weight of the lift object 86 during a lifting operation, the loads are transferred through the connecting member 22 of the interface device 12 to the load transfer device 19 and further to the lifting device 14 and the lifting vessel 61.

At the second end portion 18 of the lift arm 16 there is provided at least one ballast tank 24 for a fluid, preferably water. The ballast tank is mounted to the lift arm 16 and is provided with an outlet 25 with a hatch that can be controllably opened and closed so that a desired amount of water can be emptied from the ballast tank 24 when that is necessary during a lifting operation. The ballast tank 24 is in fluid communication with a first fluid tank 51 and/or a second fluid tank 53 as will be explained in more detail below.

The lifting device is preferably provided with a control unit 81 which is arranged in the lift arm 16. The control unit 81 receives signals from various sensors and cameras arranged on the lifting device 14 and the lifting vessel 61, and controls various parts of the lifting device 16 and the lifting vessel 61, such as dampers, grippers, pumps, engines, sensors/cameras, flow instruments, in cooperation with the ship operational bridge, before, during and after a lifting operation.

The first attachment unit 33 mentioned above is shown in more detail in FIGS. 5.5 and 6. The first attachment unit 33 comprises a first attachment element 121, preferably in the form of a shaft with a longitudinal centre axis, at least two first support elements 113 which are slidably attached to the top of the first connecting element 43, and at least one, but preferably a plurality of second support elements 116 which are securely attached to the top of the lift arm 16.

The first connecting element 43 is preferably substantially U-shaped where the lift arm 16 is arranged within the U-shaped first connecting element 43 as indicated in FIGS. 5.5 and 5.6.

The first attachment element 121 is at each end of the shaft, rotatably or securely mounted to the two first support elements 113 which are slidably mounted on top of the cradle-like, U-shaped first connecting element 43 with slide bearings comprising a slide bearing element 117 (see FIG. 5.6).

The shaft is preferably mounted substantially vertically above the longitudinal centre axis 72 of the lifting vessel. The slidably mounted first support elements 113 are preferably capable of sliding up to about 300 mm in either direction away from centre-position vertically above the centre axis 72. The lift arm 16 is attached to the shaft, which is arranged within a shaft housing 112, either rotatably, if the shaft is securely mounted to the two first support elements 113, or securely or possibly rotatably if the shaft is rotatably mounted to the two first support elements 113. Thereby the lift arm 16 is rotatably attached to and supported on the first connecting element 43.

The shaft and the bearings supporting the first support elements 113 are all designed to be capable of supporting a portion of the weight of the lifting device 14 including the weight of a lift object 86 during a lifting operation. It should also be noted that the rotational axis of the shaft is preferably located vertically above the centre axis 72 of the lifting vessel 61 as mentioned above.

In order to restrain translational movements of the lift arm 16 and to restrain the rotation of the lift arm 16 to about ±3 degrees about a vertical axis, there is provided at least one, but preferably a plurality of first damper devices 37 as indicated in FIGS. 5.5 and 5.6. The first damper devices 37 comprises piston/cylinder assemblies where the pistons are mounted to a damper support 40 which is securely attached to the first connecting element 43 and the cylinders are mounted to the first support elements 113, or vice versa. The first damper devices 37 and/or the slide bearings may further be provided with spring devices for damping and/or restraining of the movements of the lift arm 16 relative to the first connecting element 43. The first damper devices 37 enhances the stiffness of the shaft support assemblies 113 and controls the movement of the lift arm 16 about the vessel's vertical z-axis.

The first attachment unit 33 further comprises at least two set of pinion members 36 where each set is mounted to the first connecting element 43 on either side of the first connecting element 43 facing the first support frame 32. There is preferably provided two rack members 35 mounted on the inside of the first support frame 32 on either side of the first support frame 32 relative to the lift arm 16. The pinion members 36 are in engagement with respective rack members 35. The first attachment unit 33 also comprises motors that are capable of driving the pinion members 36 which will cause the first connecting element 43 and the lift arm 16 to move upwards or downwards within the first support frame 32.

The second support structure 44 comprises at least one first fluid tank 51 and at least one second fluid tank 53, as indicated above, and a second support frame 45. The first fluid tank 51 is attached to the second support frame 45, preferably to the underside of the second support frame 45, but may also be attached to the side of second support frame 45. The at least one first fluid tank 51 is a ballast tank that is mostly or completely located above the surface of the body of water 100. At a lower portion of the first fluid tank 51 there is provided at least one, but preferably a plurality of dump hatches 52. When the dump hatches 52 are opened, fluid, i.e. normally water, will flow out of the fluid tank 51 and into the body of water 100, thereby providing lifting power during a lifting operation due to the reduced total weight of the second support structure 44 as water flows out of the first fluid tank 51. The first fluid tank 51 is, as mentioned, preferably provided with a plurality of dump hatches 52 so that water can be quickly removed from the first fluid tank and thereby quickly provide lifting power during a lifting operation, i.e. the at least one fluid tank 51 may be categorized as a quick dump tank. The dump hatches 52 can be partially or fully opened and each of the dump hatches 52 are preferably controlled independently of the others, whereby a desired rate of flow of fluid out the fluid tank 51 can be achieved and a desired rate of increase in lifting power and thereby lifting speed, is achieved.

The at least one second fluid tank 53 is arranged below the at least one first fluid tank 51 and preferably attached to the underside of the at least one second fluid tank 53. Optionally, the at least one first fluid tank 51 and at least one fluid tank 53 may be separate tanks 51, 53 or compartments 51, 53 in a tank structure as indicated in FIGS. 5.4 and 5.13.

The at least one second fluid tank 53 is fluidly connected to the at least one first fluid tank 51 so that fluid can be flowed from the at least one second fluid tank 53 to the at least one first fluid tank 51. As indicated in FIGS. 5.1 and 5.14, a fluid pipe 54 fluidly connects the at least one first fluid tank 51 and the at least one second fluid tank 53 and a fluid pump 56 pumps fluid from the second fluid tank 53 to the first fluid tank 51. A fluid inlet 55 is provided at a lower part of the second fluid tank 53 which allows water to flow into the fluid tank 53. The fluid inlet 55 is preferably provided with a hatch that is remotely controlled so that the fluid inlet can be opened and closed as desired.

The second fluid tank 53 and/or the first fluid tank 51 is further fluidly connected to the ballast tank 24 which is attached to the second end portion 18 of the lift arm 16. As indicated in FIGS. 5.1 and 5.14, at least one fluid pipe 57 is fluidly connected to the second fluid tank 53 and/or the first fluid tank 51 at one end of the fluid pipe 57 and the ballast tank 24 at the other end of the fluid pipe 57. A fluid pump 58 is provided for transfer, i.e. pumping, of fluid from the second fluid tank 53 and/or the first fluid tank 51 to the ballast tank 24. The fluid pump 58 may be arranged in the second fluid tank 53, as indicated for example in FIGS. 5.1 and 5.14, or in any other convenient position as long as the fluid pump 58 is capable of pumping fluid from the second and/or first fluid pump 53, 51 to the ballast tank 24.

The second support structure 44 further comprises a second attachment unit 46 that connects the lift arm 16 to the second support frame 45 and allows the lift arm 16 to be moved vertically and to be rotated at least a few degrees in all directions relative to the second support frame 45. The free rotation of the lift arm 16 relative to the second frame structure 45 allows the frame structure 45 and the at least one first fluid tank 51 and the at least one fluid tank 53 to follow the motion of the water in the body of water 100 while the lift arm 16 is kept in a relatively stable position.

The second attachment unit 46 is shown in more detail in FIGS. 5.7 and 5.8, and comprises a second connecting element 50 which preferably has a rectangular shape, encircling the lift arm 16. The lift arm 16 is supported in the second connecting element 50 with a second attachment connection 122 as indicated in FIG. 5.8. The second attachment connection 122 is arranged between the lift arm 16 and the second connecting element 50 such that the lift arm 16 is hanging in the second attachment connection 122 from the upper part of the second connecting element 50, rotatable relative to the second connecting element 50. To that end, the second attachment connection 122 shown in FIG. 5.8 comprises a lower support bracket 126 which is securely attached to the top of the lift arm 16, and two upper support brackets 125 which are securely attached to the second connecting element 50 spaced apart a distance that allows the lower support bracket 126 to fit in between the two upper support brackets 125 as indicated in FIG. 5.8. A second attachment element, preferably in the form of a shaft 123 as shown in FIG. 5.8, is mounted in suitable bearings in openings in the lower bracket 126 and upper brackets 125 such that the lift arm 16 can rotate relative to the second connecting element 50 about the rotational axis of the shaft 123, i.e. its longitudinal centre axis. The rotational axis of the shaft 123 is substantially parallel to the rotational axis of the first attachment element 121. The lift arm 16 is thereby allowed to rotate a few degrees, typically less than 5-10 degrees, relative to the second connecting element 50.

Alternatively, the second attachment connection 122 may comprise other types of designs than shown in FIG. 5.8 as long as the lift arm 16 is rotatable, at least about a rotational axis parallel to the longitudinal centre axis of the shaft 122 shown in FIG. 5.8, relative to the second connecting element 50. The second attachment connection may, for example, comprise a ball bearing, which is securely attached on top of the lift arm 16, between the lift arm 16 and the second connecting element 50 in a similar manner as described above, such that the lift arm is hanging in the second attachment element 123 from the upper part of the second connecting element 50, or alternatively below the lift arm 16, between the lift arm and the second connecting element 50, such that the lift arm 16 rests on the second attachment element 123.

The second attachment unit 46 further comprises a plurality of pinion members 49 which are mounted in the second connecting element 50 on either side facing the second support frame 45. The toothed part of the pinion members 49 are in engagement with rack members 48 which are mounted to the inside of the second support frame 45, on either side of the second support frame 45 relative to the lift arm 16 as indicated in FIGS. 5.7 and 5.8. The second attachment unit 46 also comprises motors that are capable of driving the pinion members which will cause the second connecting element 50 and the lift arm 16 to move upwards or downwards within the second support frame 45. The motors may be an integral part of the pinion members 49 or mounted in the second connecting element 50 such that motors are capable of driving the pinion members 49. The motors driving the pinion members can further be disconnected such that the lift arm can move freely up and down within the second support frame 45, for example during a lift arm elevation operation when the lift arm 16 is lifted, i.e. rotated about the rotational axis of the first attachment element 121 of the first attachment unit 33, by altering the buoyancy of the second support structure 44 to provide the desired lifting forces to the lift object 86 and thereby raising or lowering the lift object 86 relative to the surface of the body of water 100.

There is further provided at least one, but preferably two or more lock elements 128 which are movably mounted in the second connecting element 50. Preferably, an equal number of lock elements 128 are mounted on either side of the second connecting element 50 and they all comprise a toothed part as indicated in FIG. 5.8. The lock elements 128 are movably mounted such that they can be moved out of the second connecting element 50 to engage with the corresponding rack members 48 and thereby locking the second connecting element 50 for vertical motion relative to the second support frame 45, and such that they can be moved out of engagement with the rack members 48 and partly or completely into the second connecting element 50 when the lift arm 16 is to be moved up or down relative to the second support frame 45.

The second support structure 44 is attached with a guide structure 101 to the lifting vessel 61 such that the second support structure is movable relative to the lifting vessel 61. In FIG. 5.13 there is shown a preferred way of attaching the second support structure 44 to the lifting vessel 61, while in FIGS. 5.1 and 5.14 an alternative way of attaching the second support structure 44 to the lifting vessel 61 is shown.

As described above, the lift arm 14 is rotatably attached to the first support structure 31 and supported by the first support structure 31 with the first attachment element 121, which is preferably in the form of a shaft, and to the second support structure 44 at a pivot point in the form of the second attachment element 123. Furthermore, the load of the lift object 86 is transferred to the lifting vessel through the load transfer device 19 of the lifting device 14. During a lifting operation, the lifting arm 16 will be rotated about the rotational axis of the first attachment element 121 such that the first end portion 17 of the lift arm and the load transfer device 19 are moved vertically through a curved path which has a circular shape. In such a lifting operation, the lift arm will be rotated from about −2 degrees to about +2 degrees relative to a horizontal plane. The second attachment element 123 is, however, is attached to the second connecting element 50. The connecting element 50 moves in a substantially vertical direction due to the rack and pinion system described above, causing little room for horizontal movements of the second attachment element 123.

When the lift arm 16 rotates during a lifting operation, extra loads and dynamic tension is therefore created in the elements making up the connection between the lift arm 16 and the second support structure 44. It would clearly be desirable to reduce such extra loads as much as possible, and the lifting device 14 is therefore designed such that first attachment element 121, the second attachment element 123 and the load transfer device 19, the contact area or point between the transfer device 19 and the interface device 12, lie in the same plane or along the same straight line L as indicated in FIG. 5.2. This will reduce the horizontal movements of the lift arm 16, and hence the second attachment element 123, to a minimum. The impact of horizontal movements of the lift arm 16, caused by the rotational lifting movement of the lift arm 16, will therefore also be reduced to a minimum.

As shown in FIG. 5.13, the guide structure 101 comprises an L-shaped attachment member 103 which is movably connected to deck support rails 110 which are mounted to the deck 62 of the lifting vessel 61, and to the side support rail 109 which is mounted on the side 63 of the hull of the lifting vessel 61 such that the attachment member 103 can be moved in the longitudinal direction of the lifting vessel 61. The attachment member 103 may be slidingly connected to the side support rail 109 and/or the deck support rails 110, or may be provided with roller elements (not shown in the figure) such that the attachment member 103 is capable of rolling along the side support rail 109 and/or the deck support rails 110. A combination of the two is possible, for example the attachment member 103 may be slidingly connected to the side support rail 109 and provided with roller elements rolling on the deck support rails 110.

At least one first guiding member 104 is securely attached to the attachment member 103 at one end of the attachment member. In the opposite end, the first guiding member 104 is connected to at least one connecting member 107. The at least one connecting member 107 is further movably mounted to or in a second guiding member 105 on the second support structure 44, preferably to the first fluid tank and/or the second fluid tank 53 as indicated in FIG. 5.13. The second guiding member 105 extends in a substantially vertical direction such that the second support structure 44 is guided in a substantially vertical movement relative to the guide structure 101 and the lifting vessel 61 when water movements in the body of water 100 cause relative movements between the second support structure 44 and the lifting vessel 61.

The second guiding member 105 is preferably a slit design, i.e. the second guiding member 105 comprises an element with a cavity. The second guiding member 105 may be mounted to the first fluid tank 51 and/or the second fluid tank 53 or may be formed as an integral part of the first fluid tank 51 and/or the second fluid tank 53. The slit shaped cavity may be of any desired shape that provides sufficient guiding of the second support structure 44. For example, a slit-shaped element may be mounted to the first fluid tank 51 and/or the second fluid tank 53 at the frontside and at the backside of the first fluid tank 51 and/or the second fluid tank 53 in the longitudinal direction of the vessel such that the slits of both elements extend in a substantially vertical direction. The slits may be provided with a substantially rectangular shape. The connecting member 107 has a shape that correspond to the shape of the second guide member 105, i.e. if the second guiding member 105 is a rectangularly shaped slit, the connecting member 107 will comprise a corresponding protruding element that fits in the rectangularly shaped slit such that the protruding element is capable of moving vertically in the slit. The second support structure 44 is thereby connected to the lifting vessel 61 and guided in a substantially vertical motion relative to the lifting vessel when wave motions in the body of water 100 causes relative motion between the second support structure 44 and the lifting vessel 61. In some instances, the size of the protruding element of the at least one connecting member 107 may be chosen to be a little smaller than the size of the slit of the guiding member 105 so that there is a little slack.

The slit-shaped cavity may also be T-shaped or have any other suitable shape. The connecting member 107 will then be provided with a protruding element that has a shape that corresponds to the T-shape slit of the second guide member 105.

It should also be noted that the general “slackness” in the bearing system of the connecting members 107 allows the second support structure 44 to vertically move in or out—pivoting around the connecting members 107 and the second attachment element 123—and thus taking the maximum movement, typically ±300 mm, that the main bearing with the first damper devices 37 allows for.

With the attachment member 103 being capable of moving in the longitudinal direction of the lifting vessel 61 and with the corresponding first guiding member 104, which is attached to the attachment member 103, being slidingly connected to the second guiding member 105 in a substantially vertical direction, the second support structure 44 is movably attached to the lifting vessel 61 in the longitudinal direction of the lifting vessel and in a substantially vertical direction.

The lifting device is further provided with a damper device 67 which comprises a cylinder 68 and a piston 70. As indicated in FIG. 5.13, the piston can be connected to the attachment member 103 while the cylinder 68 is attached to the second support structure 44 as indicated in FIG. 5.13. Furthermore, as indicated in FIG. 5.13, the cylinder is rotatably connected to the second support structure 44, for example with a universal joint 118, and the piston is rotatably connected to the attachment member 103, for example with a universal joint 119. The damper device 67 preferably further includes a spring device (not shown in the figure) creating stiffness enhancement. The damper device 67 provides damping of the motions of the second support structure 44 relative to the lifting vessel 61, and in some instances may be used to lift the second support structure 44 and the lift arm 16 if that is desired or needed.

In FIGS. 5.1 and 5.14 there is shown an alternative system for guiding the vertical movements of the first fluid tank 51 and the second fluid tank 53 wherein at least one, but preferably a plurality of first guide rails are mounted to the side 63 of the hull of the lifting vessel 61 and at least one, but preferably a plurality of second guide rails 59 are mounted on the first fluid tank 51 and/or the second fluid tank 53.

Between the first guide rails 65 and the second guide rails 59 there is provided bearings 66 which are connected to the first guide rails 65 and the second guide rails 59 such that the first fluid tank 51 and the second fluid tank 53 can move slidably at least up and down relative to the lifting vessel 61.

A damper device 67 is shown comprising a piston 70 and cylinder 68 assembly. The piston 70 is mounted to the second guide rail, for example with a universal joint 71, and the cylinder is mounted, preferably slidably, to the deck 62 of the lifting vessel 61, for example with a universal joint 69. It should be noted that although two different damper devices 67 have been shown in the figures, the damper device 67 may be given many different designs and be of other types than shown in the figures.

In FIGS. 5.9 a pinion member 36 comprising a cogwheel 133 is shown mounted in a pinion member housing 132. In FIG. 5.10 pinion members 36 in their pinion member housings are shown mounted in the first connecting element 43. The rack member 35 is shown mounted to the first support frame 32 such that the teeth of the cogwheels 133 of the pinion members 36 engage the correspondingly shaped teeth of the rack member 35. The pinion members 36 are provided with motors that rotates the cogwheel 133 of the pinion members 36. Thereby the first connecting element 43 may be moved up and down within the first support structure 31.

In FIG. 5.11 there is shown a lock assembly 127 which can be used to lock the first connecting element 43 and/or the second connecting element 50, and thereby the lift arm 16, to a desired fixed position relative to the first support frame 32 and/or the second support frame 45.

The lock assembly 127 comprises a lock element housing 129 in which the lock element 128 is movably mounted between a position where the teeth of the lock element engage the correspondingly shaped teeth of a rack member 35 of the first support structure 31 or a rack member of the second support structure 44 and a position where the lock element 128 is retracted into the lock element housing 129 and the teeth of the lock element do not engage the teeth of any rack member 35, 48. On the opposite side of the lock element 128 relative to the side with the teeth, there is provided an actuator cavity 131 in the lock element housing 129. In the actuator cavity 131 there is provided a lock element actuator 130 which is movable in direction substantially perpendicular to direction of movement of the lock element 128. The lock element 128 and the lock element actuator are provided with correspondingly wedge shapes as indicated in FIG. 5.11. When the lock element actuator 130 is moved relative to the lock element 128, the lock element will also be moved relative to the lock element housing 129 between the position where teeth the lock element engages the teeth of the rack member 35, 48 and the position where the lock element 128 is retracted into the lock element housing 129. The lock element actuator 130 may be moved by a hydraulic or pneumatic device, an electric motor or any other suitable device that is capable of moving the lock element actuator 130.

In FIG. 5.12 it is shown a lock assembly 127 mounted in the first connecting element 43, but the lock assembly could also have been mounted in the second connecting element 50. The teeth of the lock element 128 can be seen to be out of engagement with the teeth of the rack member 35 and the first connecting element 43, and therefore the lift arm 16, is free to move up or down in a substantially vertical direction.

In FIG. 5.14 the lifting device 14 is further provided with hoisting equipment which can be mounted on the lifting device 14 as shown in FIG. 5.1. The hoisting equipment can later be removed when this equipment is not needed. The hoisting equipment comprises a winch 74 which is driven by a winch motor 75. The winch motor 75 may be a separate unit as indicated in FIG. 5.14, or may alternatively be part of the winch itself. The winch 74 is detachably mounted on the lift arm 16.

The hoisting equipment further comprises a pulley 78 and a support unit 79 detachably attached to the outer end portion 27 of the telescopic arm 26. If the case that the lift arm 16 does not include a telescopic arm 26, the support unit 79 including the support unit 79 with the pulley 78, may be detachably attached to the first end portion 17 of the lift arm 16. As can be seen in FIG. 5.14, a winch line 76 made of a suitable material, such as steel or a synthetic material, extends from the winch 74, over the pulley 78 and down to a hoisting element 77 which is attached to the end of the winch line 76. The hoisting element 77 may comprise a hook element as indicated in FIG. 5.14, or any other element which is suitable for connecting the hoisting element to a lift object 86 to be lifted.

As mentioned, the hoisting equipment, comprising the winch 74, the winch motor 75, the pulley 78 and the support unit 79 for the pulley and the winch line 76 with the hoisting element 77, is detachably attached to the lifting device 14, preferably on the lift arm 16, whereby the hoisting equipment can be attached to the lifting device 14 when there is need for the hoisting equipment, and later be removed when there is no more need for the hoisting equipment.

In FIG. 5.17 there is shown a lifting system 10 with a possible configuration of vessels during a lifting operation. There are two lifting vessels 83, 84 which are positioned on either side of a lift object 86, for example the top side of an offshore platform for drilling or production of hydrocarbons. Each lifting vessel 83, 84 is provided with a plurality of lifting devices 14 as described above. In FIG. 5.17 it is shown that the load transfer devices 19 are in engagement with interface device 12 which is mounted on the lift object 86. A third transport vessel 85 is positioned near the lifting vessel so that the transport vessel 85 can be maneuvered in under the lift object 86 when the lifting vessels 83, 84 has lifted the lift object 86 whereafter the lift object can be lowered down onto the deck of the transport vessel 85. The lifting vessels 83, 84 and the transport vessel 85 are provided with bridge control systems 92, 93, 94 respectively and communication devices 87, 88, 89 respectively. The lift object is also provided with a communication device 90. During the whole operation, the bridge control system of one of the vessels, for example the lifting vessel 83, is allocated as a master control system making the lifting vessel 83 the master vessel controlling the other vessels 84, 85 which will act as slave vessels. All communication therefore takes place between the master vessel 83 and the slave vessels 84, 85 and the lift object 86. It can also be mentioned that preferably all the lifting vessels 83, 84 are provided with a bridge control system 87, 88 that are capable of being allocated as the master control system. It would also be possible to provide the transport vessel 85 with a bridge control system 94 that could be allocated as the master control system.

It should be understood that it is obviously possible to use more or fewer lifting vessels during a lifting operation than the two lifting vessel shown in FIG. 5.17, for example one, three, four, five, six, seven, eight, nine, ten lifting vessels etc., depending on different parameters such as the weight of the lift object, size of the lift object, position and depth of the lift object, and complexity of the operation. Thus, the present invention is not restricted to and does not necessary use two vessels only to perform a lifting operation. For example during:
a) subsea lifting, i.e. lifting up or lowering of tubular elements such as long cables, pipelines or hoses, one or more vessels may be arranged side-by-side such that the one or more vessels are able to handle for example spools comprising a tubular element of e.g. 350 meters length,
b) one may install parts of a quay plant from the vessels, which parts thus being elements in the quay plant on land if the water depth allows access,
c) removal of short or long gangways offshore (from offshore installations such as windmills, floating platforms etc).

The invention has now been explained with reference to a non-limiting examples. A person skilled in the art will, however, appreciate that modifications and changes may be made to the embodiments which will be within the scope of the invention.

1. A lifting device comprising a lift arm and a first support structure which is adapted to be placed on a lifting vessel and comprises a first attachment unit that includes a first attachment element which connects the lift arm rotatably to the first support structure, the lift arm comprising a load transfer device that is secured to a first end portion of the lift arm, the lifting device further comprising a second support structure and a second attachment unit that includes a second attachment element which connects the lift arm rotatably to the second support structure, wherein the first attachment element, the second attachment element and the load transfer device all lie substantially in a straight line or substantially in the same plane.

2. Lifting vessel according to claim 1,
wherein the lifting device comprises a first elevation device for effecting a substantially vertical movement of the lift arm relative to the first support structure.

3. Lifting device according to claim 2,
wherein the first elevation device comprises at least one rack member and at least one corresponding pinion member.

4. Lifting vessel according to claim 1,
wherein the lifting device comprises a second elevation device for effecting a substantially vertical movement of the lift arm relative to the second support structure.

5. Lifting device according to claim 4,
wherein the second elevation device comprises at least one rack member and at least one corresponding pinion member.

6. Lifting device according to claim 1,
wherein the lift arm comprises a telescopic arm which is movable relative to the lift arm in a longitudinal direction of the lift arm, and that the load transfer device is secured to an outer end portion of the telescopic arm.

7. Lifting device according to claim 6,
wherein the lift arm comprises at least one rack member and at least one corresponding pinion member mounted to the lift arm and the telescopic arm respectively for effecting a movement of the telescopic arm relative to the lift arm.

8. Lifting device according to claim 1,
wherein the lifting device comprises a first damper device for damping and/or restraining of rotational movement of the lift arm at least about a horizontal axis relative to the first support structure.

9. A lifting vessel for lifting an offshore lift object, the lifting vessel comprising at least one lifting device according to claim 1.

10. Lifting vessel according to claim 9,
wherein the first attachment element is located substantially vertically above the longitudinal centerline of the lifting vessel.

11. Lifting vessel according to claim 10,
wherein the lifting vessel comprises support rails which are mounted on the deck of the vessel and extend in a longitudinal direction of the lifting vessel, and that the first support structure of the least one lifting device comprises a plurality of roller elements, and that the first support structure is supported on the support rails such that first support structure is capable of rolling or being rolled along the support rails.

12. Lifting vessel according to claim 9,
wherein the lifting vessel comprises a guide structure which is supported on guide rails mounted on the lifting vessel, movably along the guide rails, the guide structure further being attached to the lifting device movably relative to the lifting device.

13. Lifting vessel according to claim 12,
wherein the guide structure comprises a first guiding member which is movably attached to the second fluid tank and/or the first fluid tank of the lift device.

14. Lifting vessel according to claim 9,
wherein the lifting vessel comprises a second damper device for damping and/or restraining of relative vertical movement between the second support structure and the lifting vessel.

15. Lifting vessel according to claim 14,
wherein the second damper device comprises a piston and cylinder assembly where the piston and the cylinder are rotatably connected to the guide structure and the lifting device respectively or vice versa.

16-17. (canceled)
